(19) United States
(12) Patent Application Publication
(10) Pub. No.: US 2013/0066501 A1
(43) Pub. Date: Mar. 14, 2013

(54) Vehicle

(71) Applicants: Kazuto Oyama, Hitachinaka (JP); Hideki Miyazaki, Hitachi (JP); Kimihisa Furukawa, Hitachi (JP); Toshisada Mitsui, Hitachinaka (JP); Shingo Nishiguchi, Hitachinaka (JP); Akinori Kamiya, Hitachinaka (JP)

(72) Inventors: Kazuto Oyama, Hitachinaka (JP); Hideki Miyazaki, Hitachi (JP); Kimihisa Furukawa, Hitachi (JP); Toshisada Mitsui, Hitachinaka (JP); Shingo Nishiguchi, Hitachinaka (JP); Akinori Kamiya, Hitachinaka (JP)

(73) Assignee: Hitachi, Ltd., Chiyoda, Ku (JP)

(21) Appl. No.: 13/643,414

(22) PCT Filed: Apr. 28, 2010
(86) PCT No.: PCT/JP2010/003033

§ 371 Date: Nov. 27, 2012

(51) Int. Cl. B60L 15/20; B62D 6/08; B62D 5/04

(52) U.S. Cl. CPC B60L 15/20; B62D 5/0463; B62D 6/08
USPC 701/22

(57) ABSTRACT

It is desirable to enhance efficiency of a power conversion device in both of a case where a motor generator which is an electric rotating machine is operated as a motor and a case where the motor generator is operated as a generator by performing regeneration braking. At the time of performing regeneration braking, strength of regeneration braking can be controlled by making an inverter circuit conductive in response to a predetermined phase of an AC output which the inverter circuit generates and by controlling a conduction width. Due to such a control, the number of times of switching a semiconductor element which constitutes the inverter circuit can be reduced thus suppressing heat generation of the semiconductor element and also the efficiency of the power conversion device can be enhanced. Further, the enhancement of efficiency of the power conversion device can be realized also in a motor operation and hence, it is also possible to enhance efficiency with respect to the traveling of a vehicle.

### TECHNICAL FIELD

The present invention relates to a vehicle provided with a motor generator for a moving vehicle and an inverter circuit which generates a 3-phase alternating current for driving the motor generator.

### BACKGROUND ART

With respect to a vehicle provided with a vehicle-traveling-use motor generator for traveling and an inverter circuit which generates a 3-phase alternating current for driving the motor generator, the vehicle includes an inverter circuit which receives the supply of DC power and converts the DC power to AC power. The inverter circuit includes a plurality of semiconductor elements for performing a conduction operation and an interruption operation. As the above-mentioned semiconductor elements repeat a switching operation, supplied DC power is converted into AC power or supplied AC power is converted into DC power.

The inverter circuit is controlled based on a pulse width modulation method which uses a carrier wave changing at a fixed frequency (hereinafter referred to as PWM method). By increasing the frequency of the carrier wave, there is the tendency that control accuracy is enhanced and a generation torque of an electric rotating machine become smooth. However, in such a semiconductor element, at the time of switching an operation state from an interruption state to a conduction state or at the time of switching the operation state from a conduction state to an interruption state, power loss is increased and an amount of heat generation is increased. Accordingly, when the number of times of switching operations is increased, power consumption is increased.

One example of a power conversion device is disclosed in JP-A-63-234878 (see patent literature 1).

### CITATION LIST

### Patent Literature

PTL 1: JP-A-63-234878

### SUMMARY OF INVENTION

### Technical Problem

There has been a demand for the reduction in the power loss of semiconductor elements of the vehicle described above thus enhancing efficiency of the inverter circuit or reducing the power consumption of the vehicle. The power consumption can be reduced by decreasing the number of times of switching the semiconductor element. However, when the power conversion between DC power and AC power is performed using a PWM method, the number of times of switching is decided based on a frequency of a carrier wave so that the reduction of the number of times of switching is difficult.

Accordingly, it is an object of the present invention to provide a control method of an inverter circuit with small switching loss or a vehicle which can reduce power consumption.

Embodiments described hereinafter reflect preferred results of studies as products, and have achieved various specific tasks which are desirable for products. The specific tasks which can be achieved by the specific constitutions and the manners of operation of the embodiments described hereinafter are explained in the following columns where the embodiments are explained.

### Task to Be Solved by the Invention

One of technical features of the present invention to achieve the above-mentioned tasks is to provide a vehicle which mounts: a motor generator for moving the vehicle; an acceleration pedal for accelerating the vehicle; and a first control circuit and a first inverter circuit for controlling the motor generator based on a manipulation variable of the acceleration pedal thereon, wherein the first inverter circuit includes a plurality of semiconductor elements, the first inverter circuit performs the conduction and the interruption of the semiconductor element thus generating AC power based on DC power or generating DC power based on AC power, and the first control circuit controls timing at which the first inverter circuit performs the conduction or the interruption of the semiconductor element based on a phase of AC output for driving the motor generator, and controls a conduction width of the semiconductor element based on a manipulation variable of the acceleration pedal.

### Advantageous Effects of Invention

According to the present invention, the power loss of the inverter circuit can be reduced, and the power consumption of a vehicle can be also reduced.

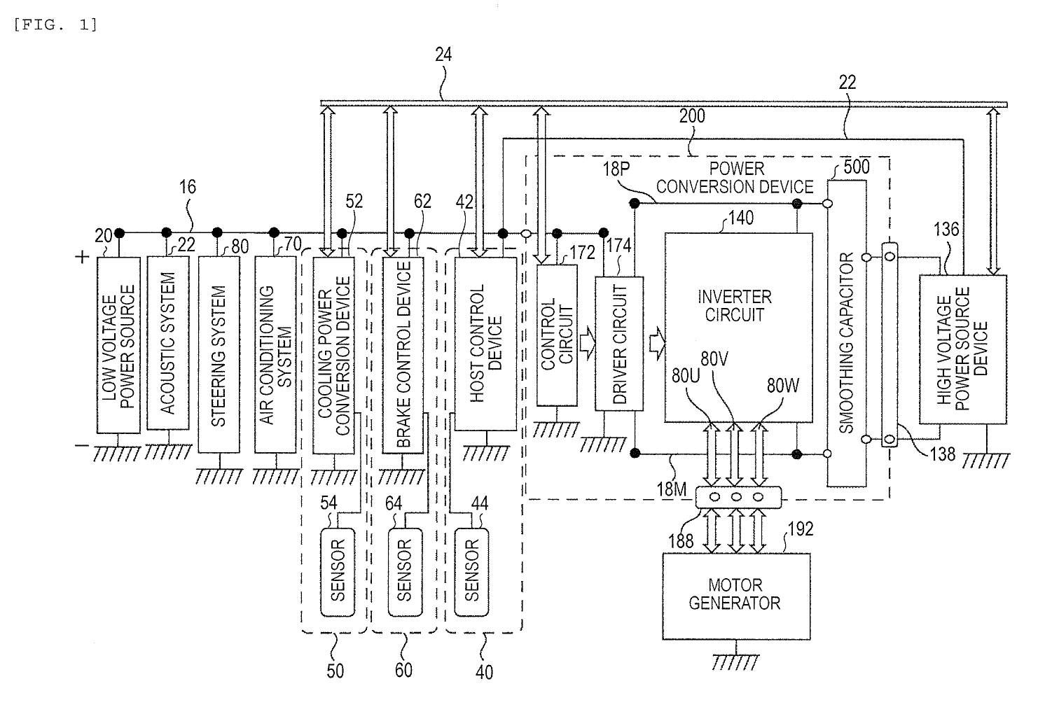

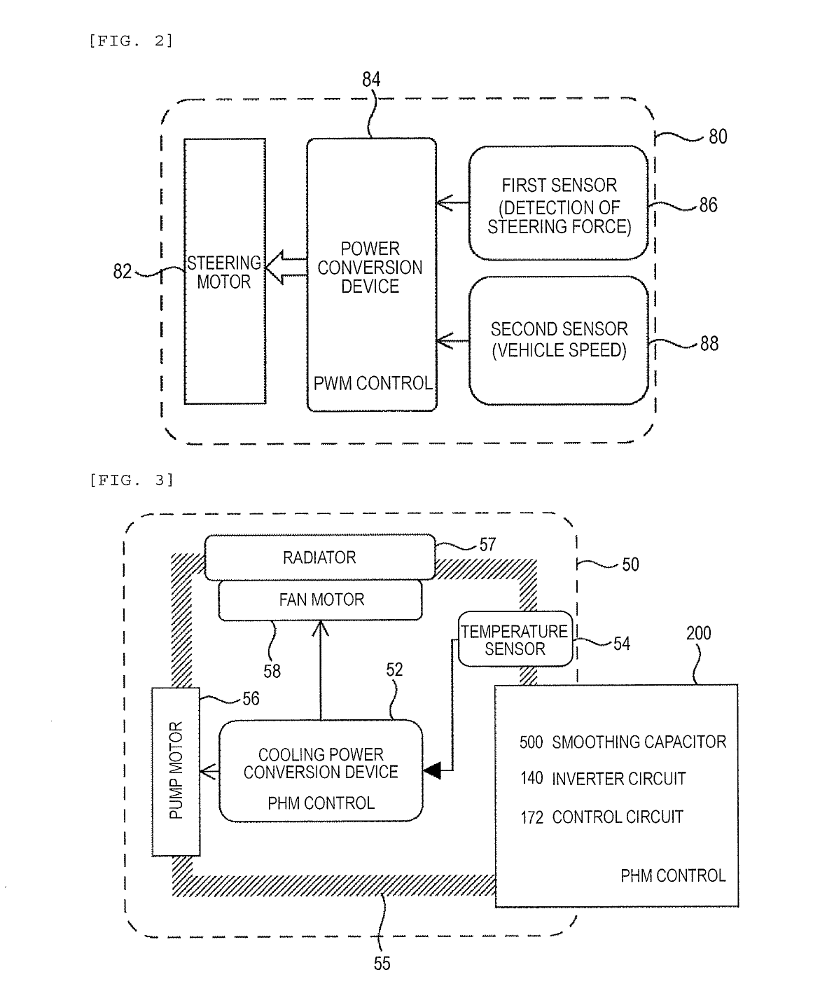

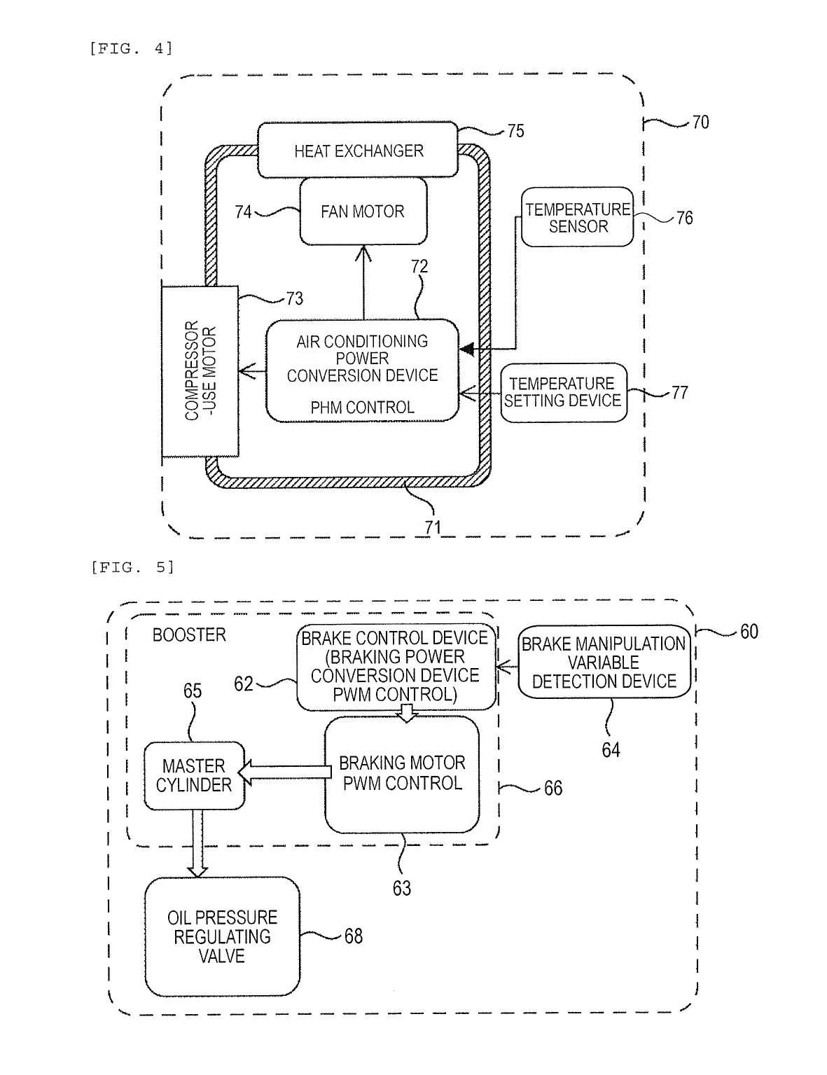

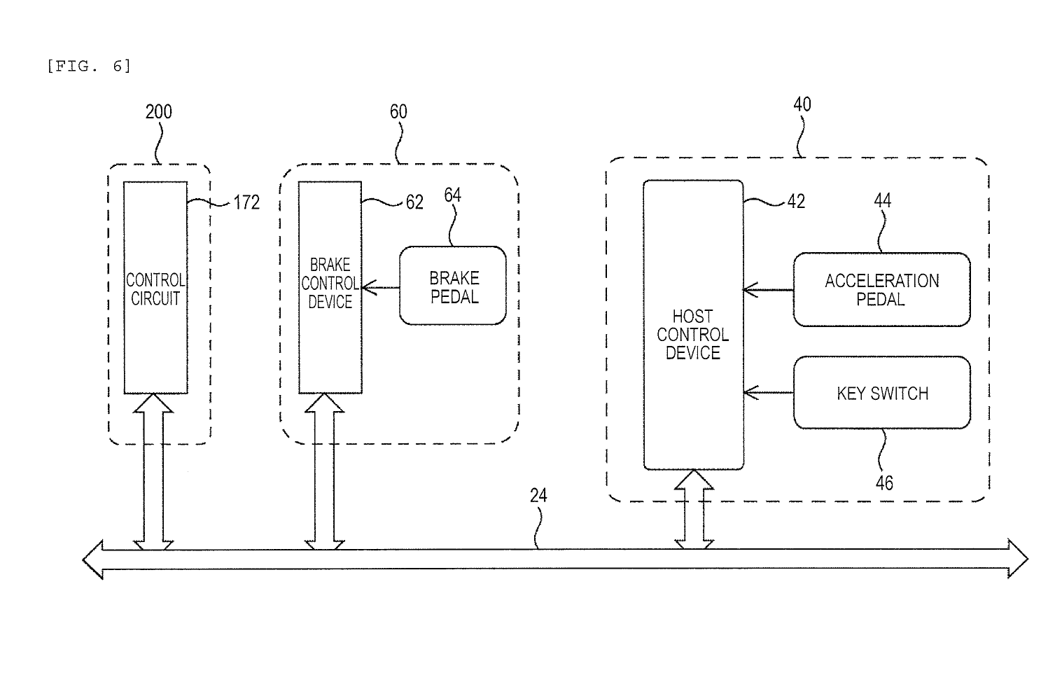

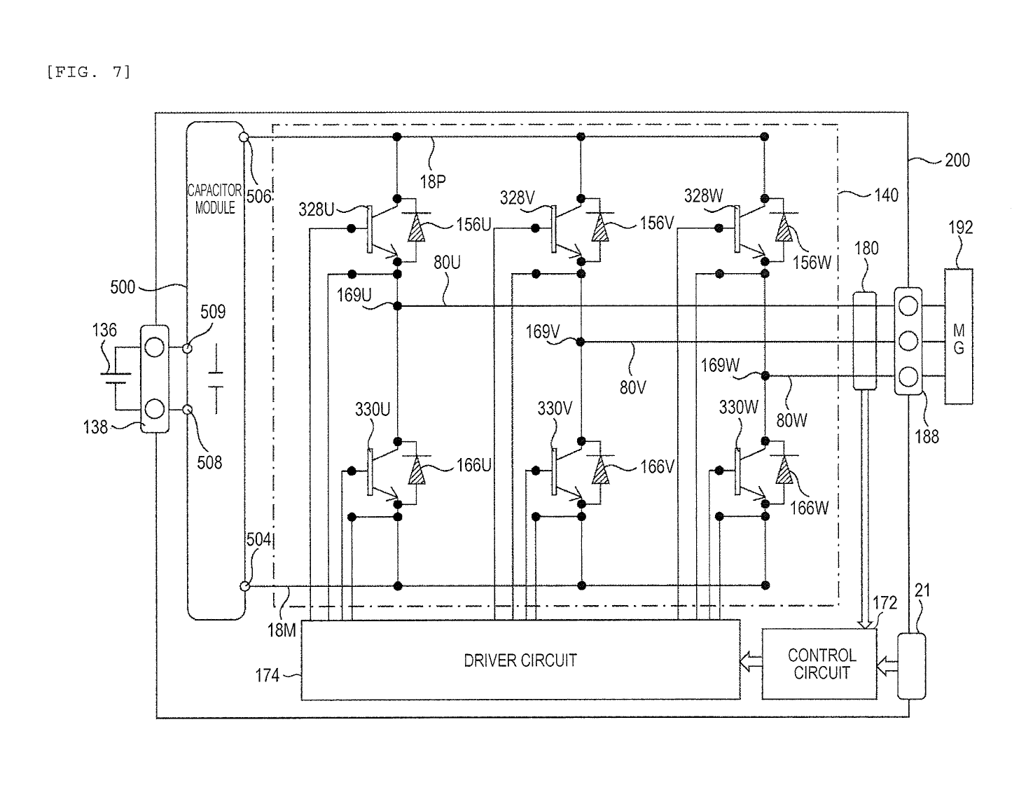

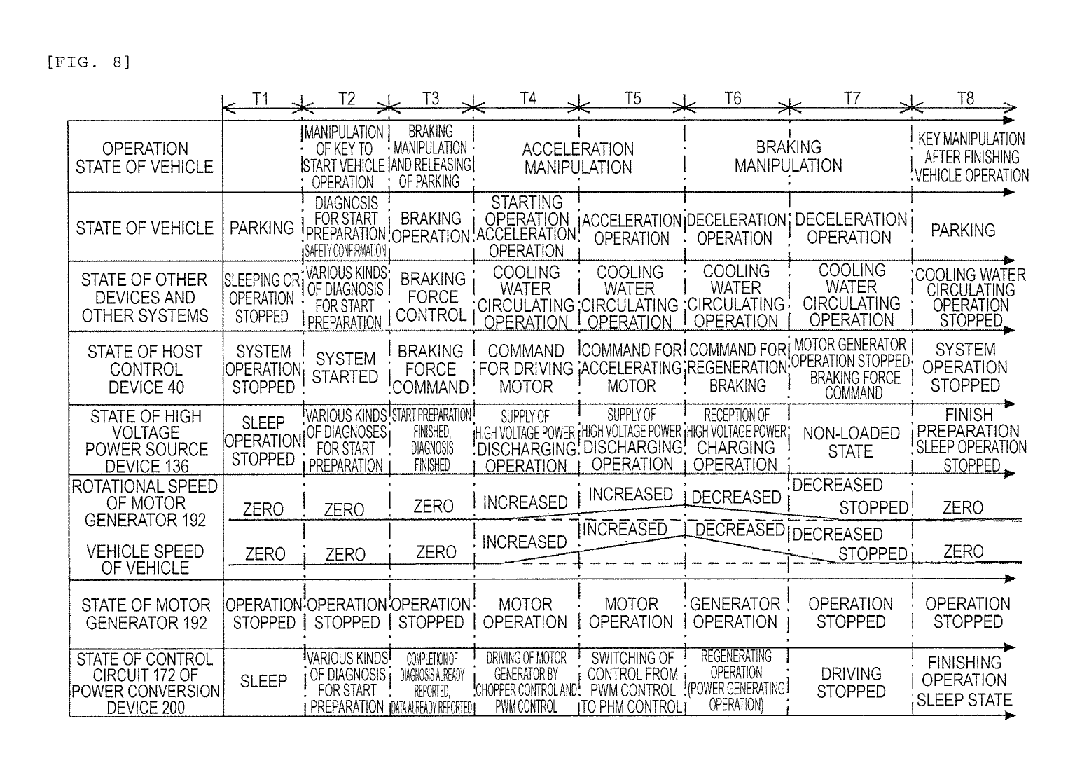

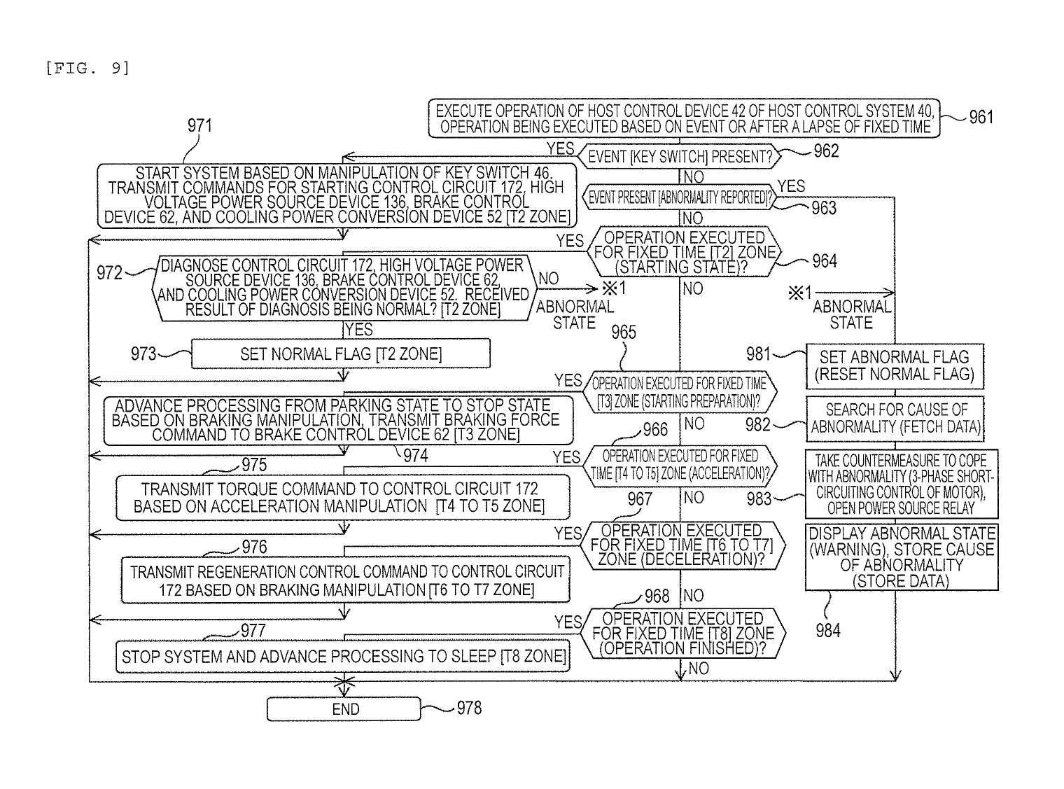

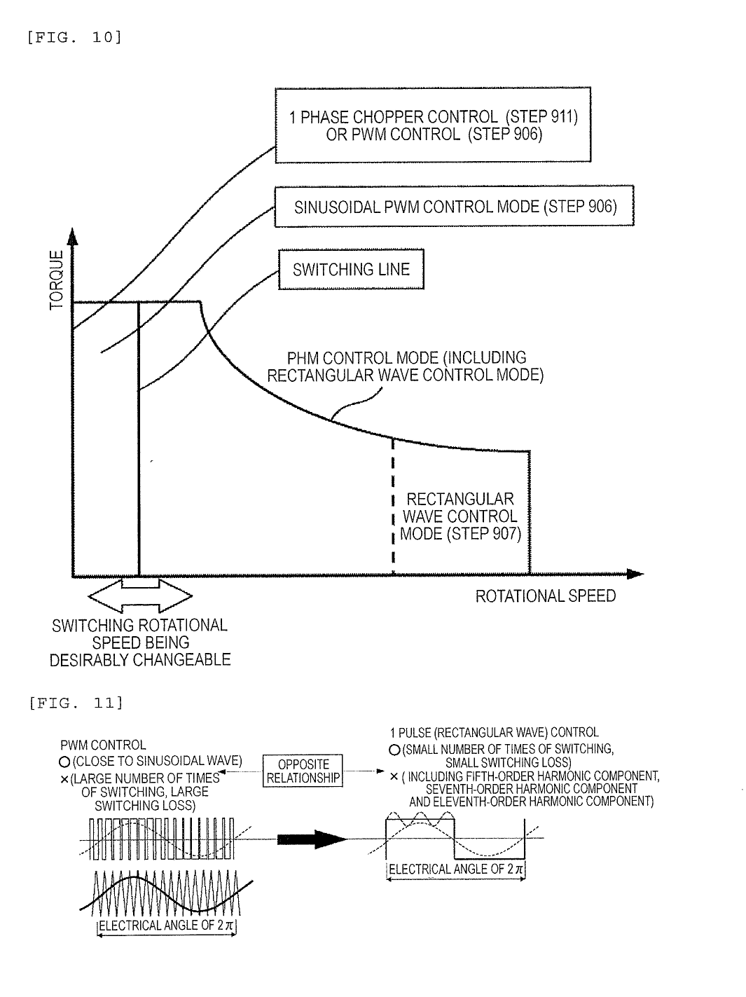

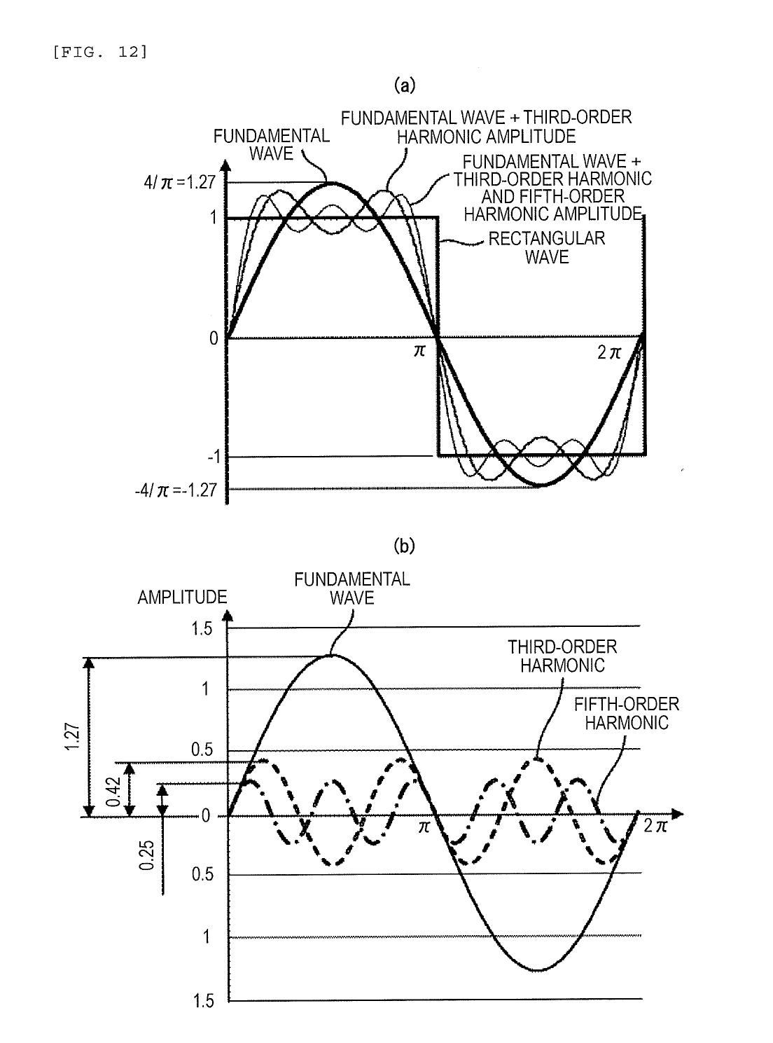

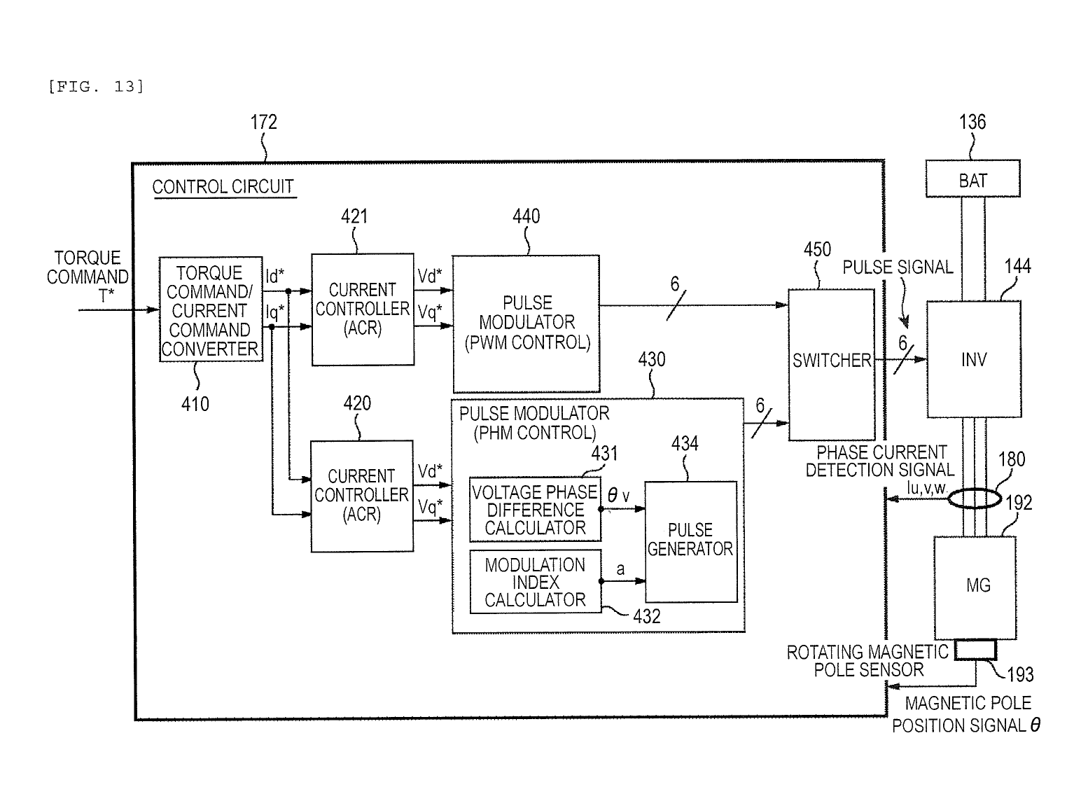

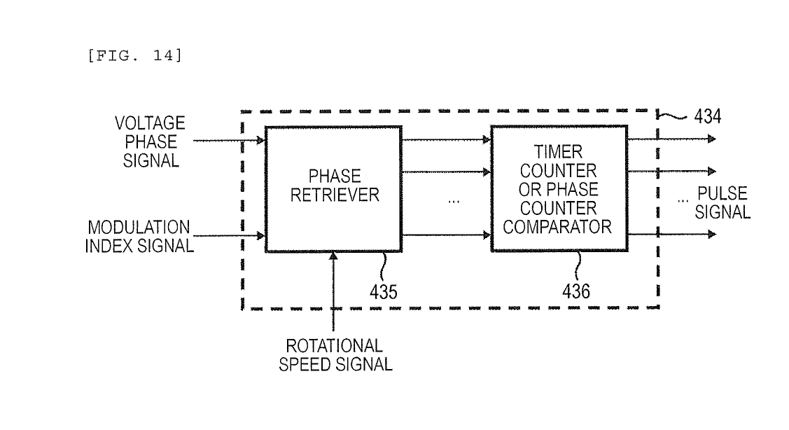

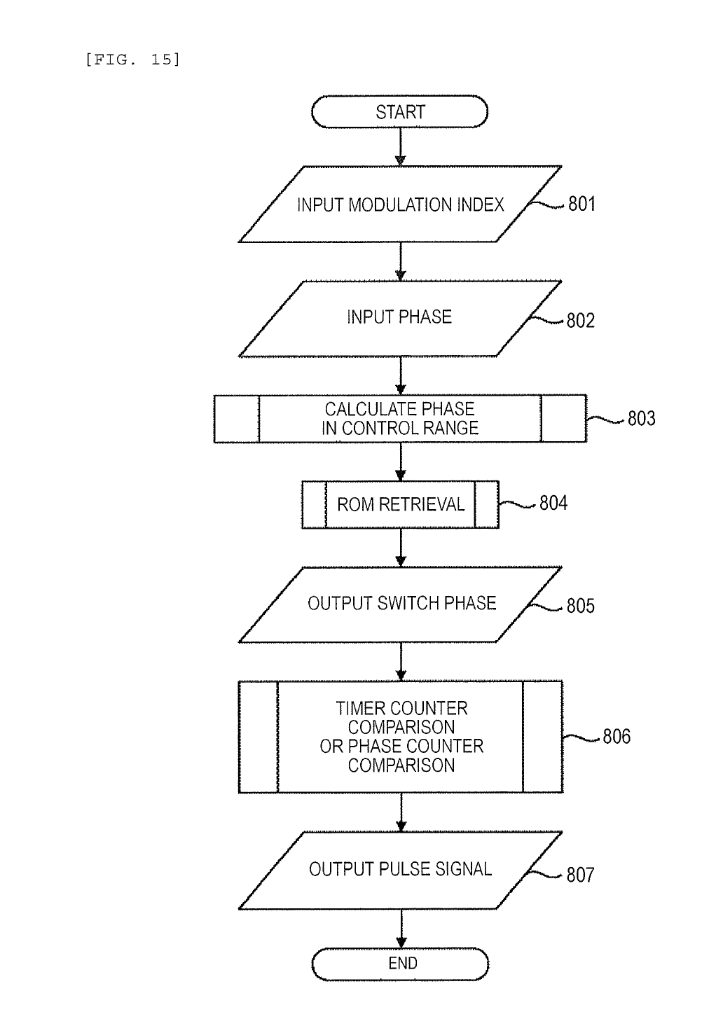

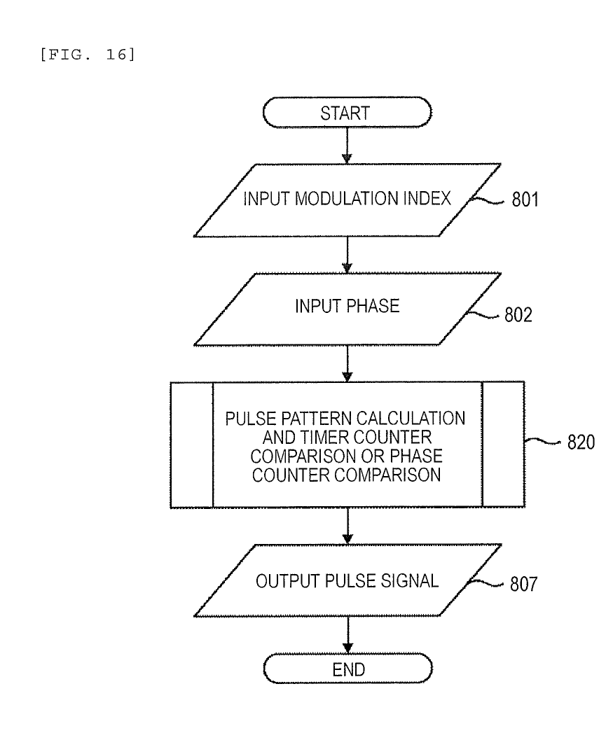

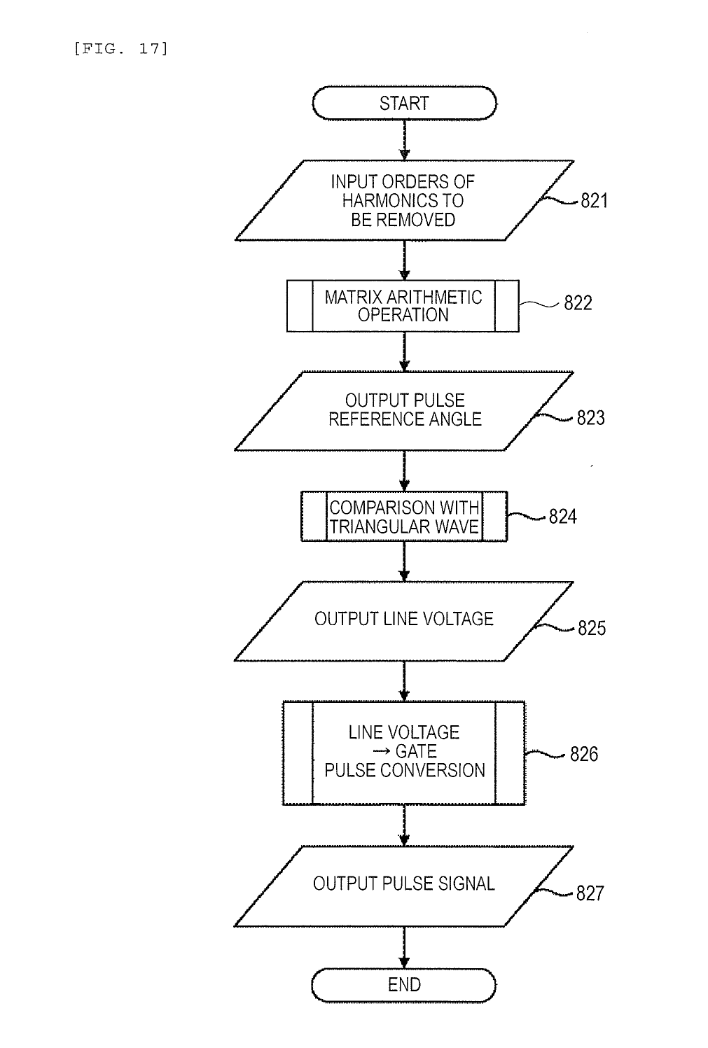

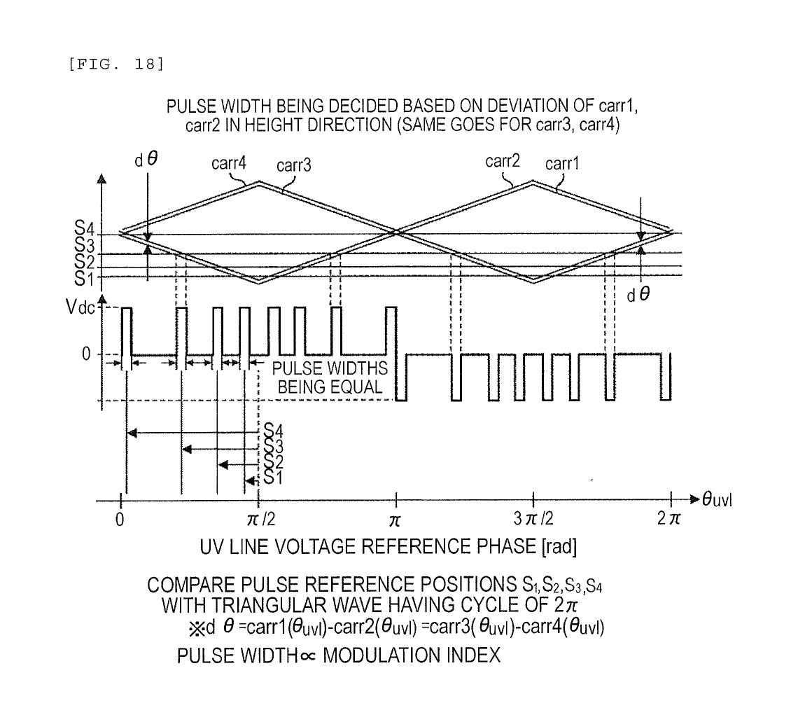

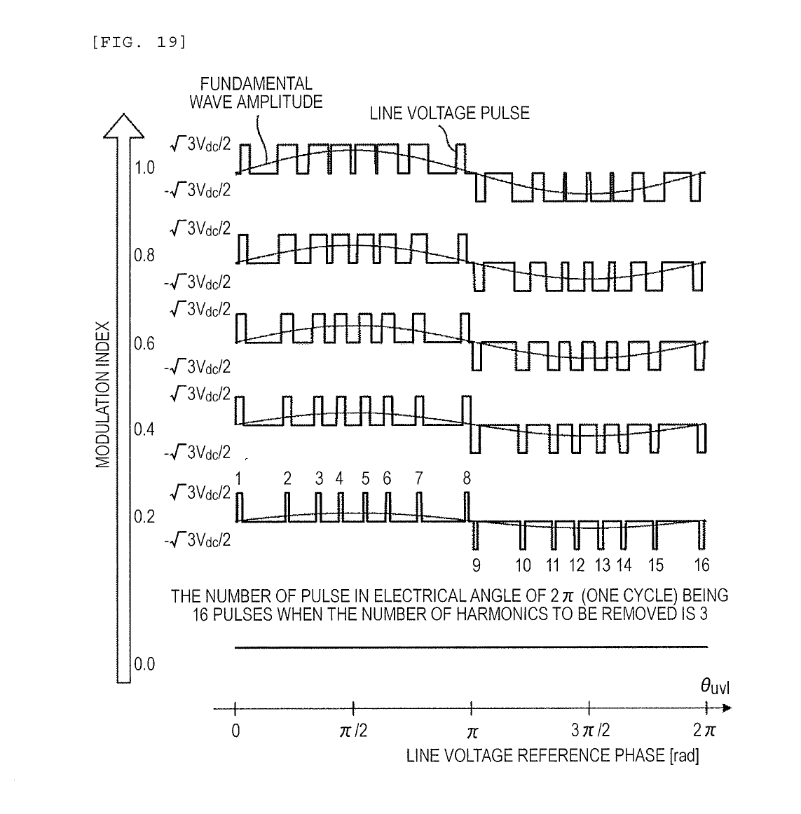

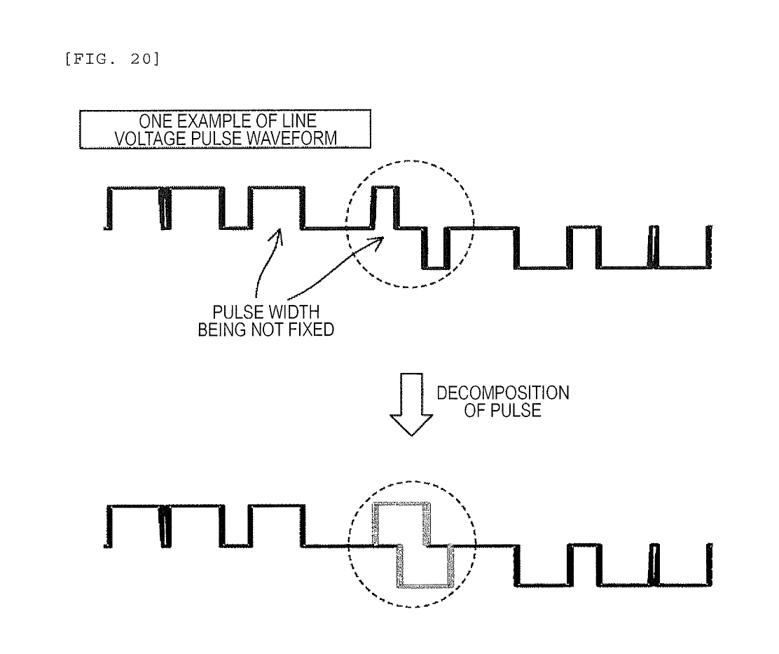

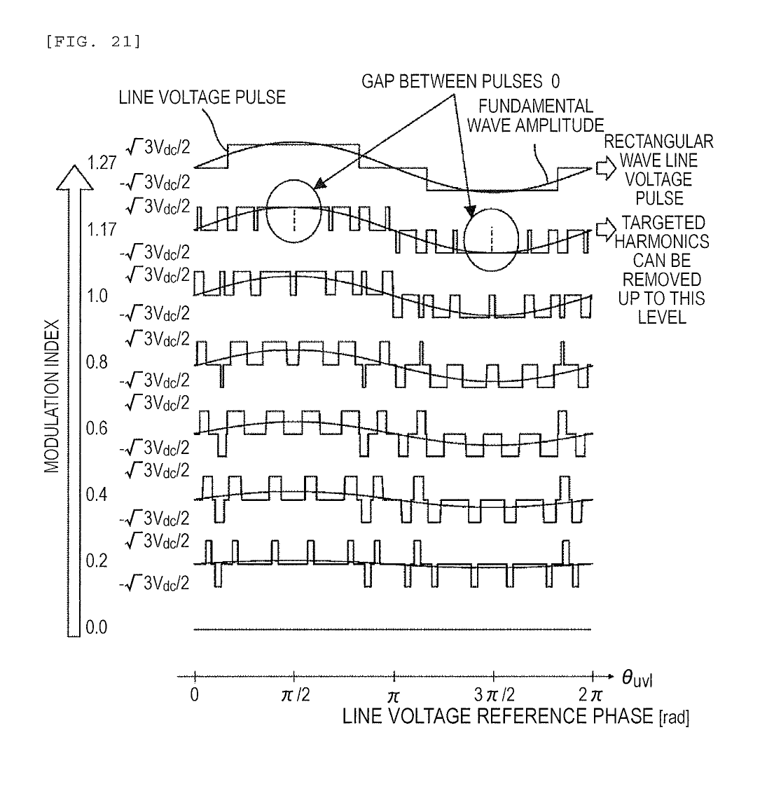

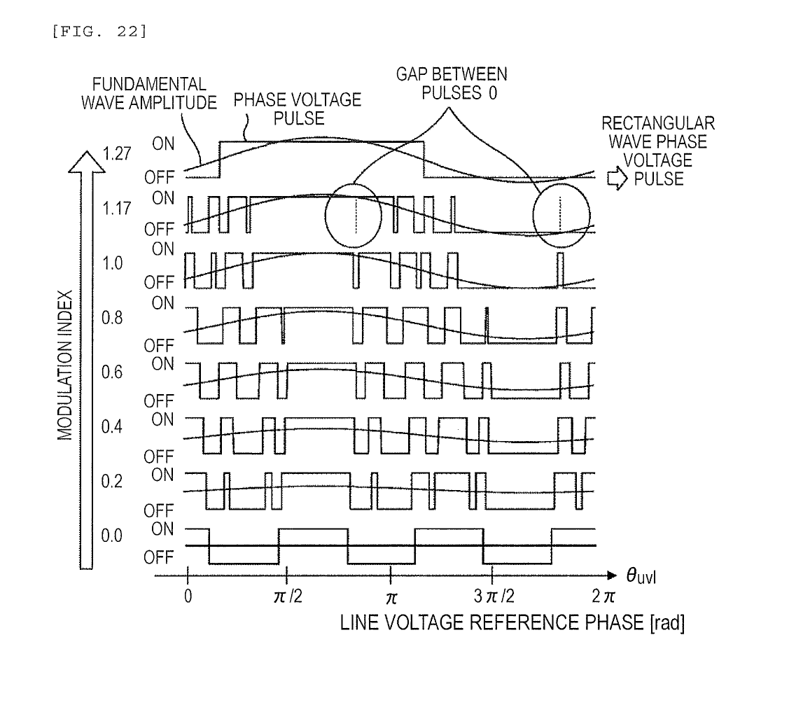

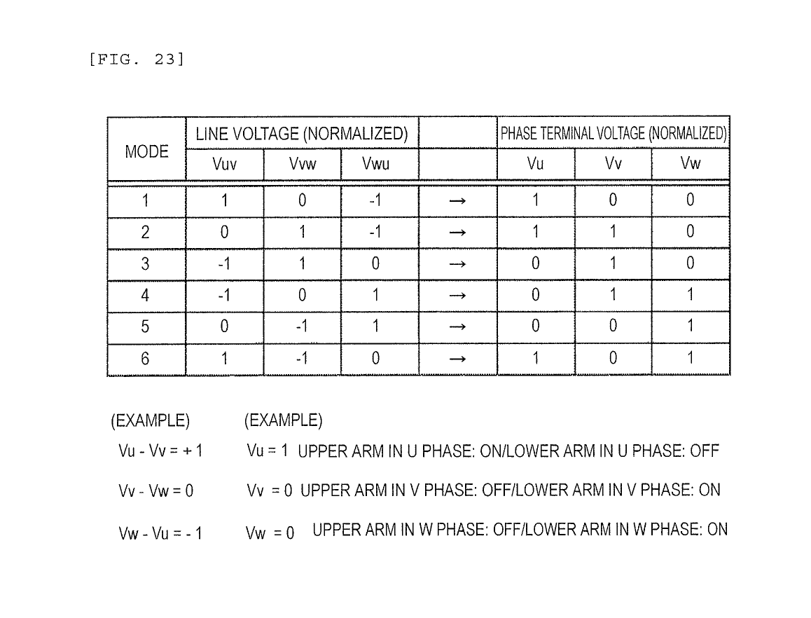

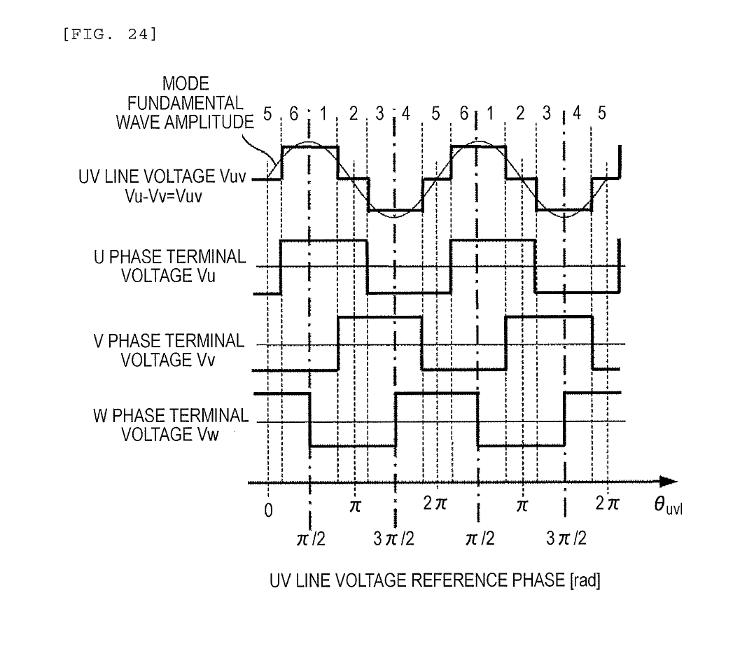

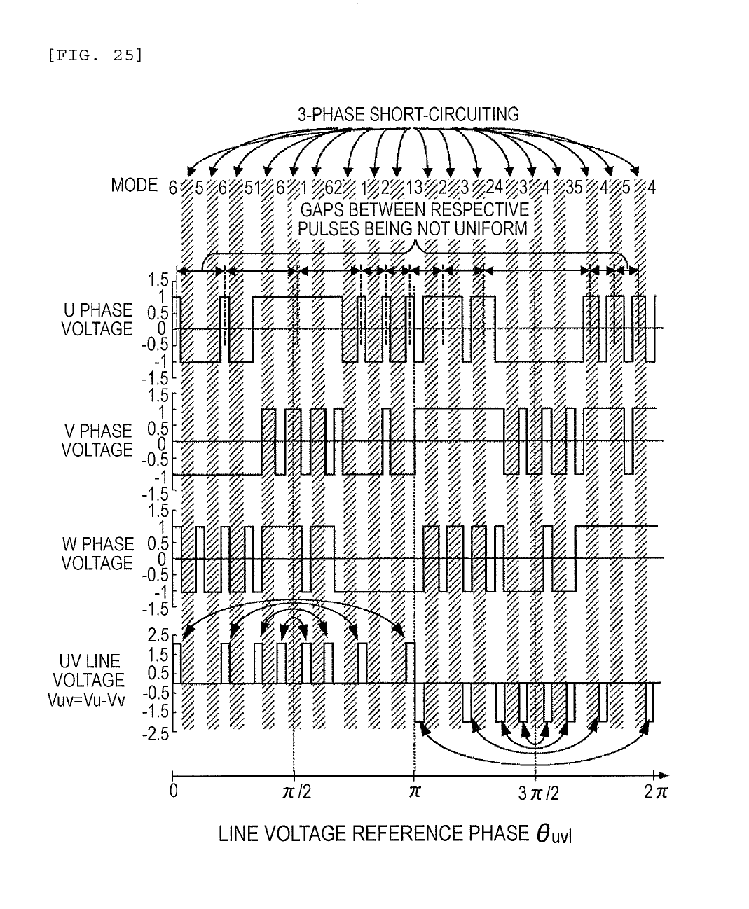

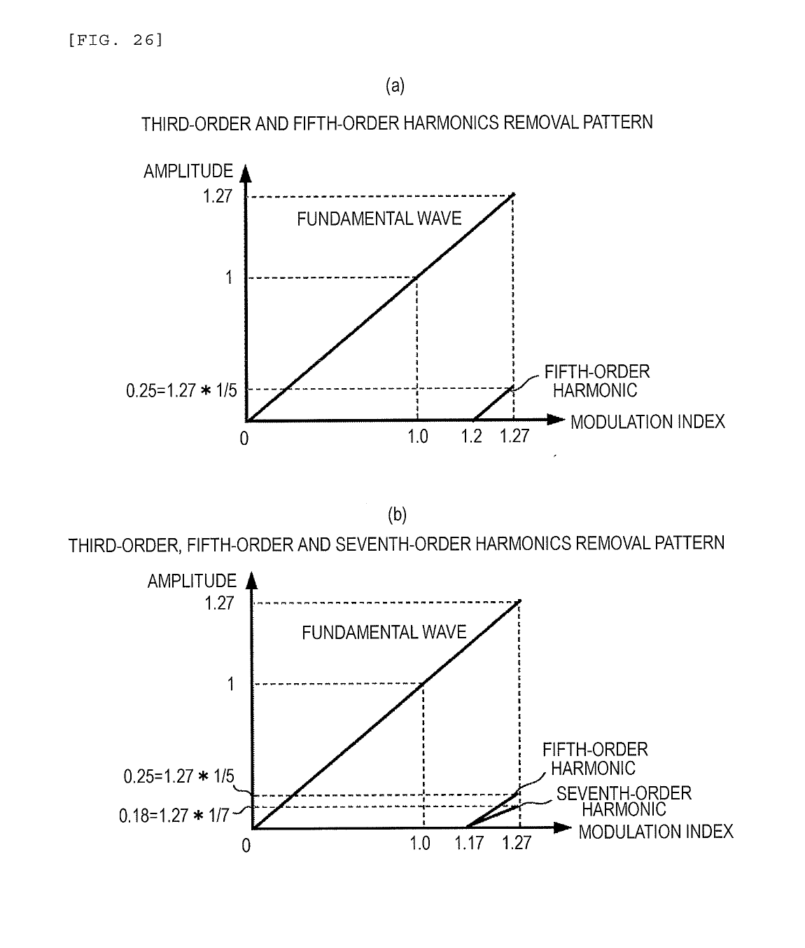

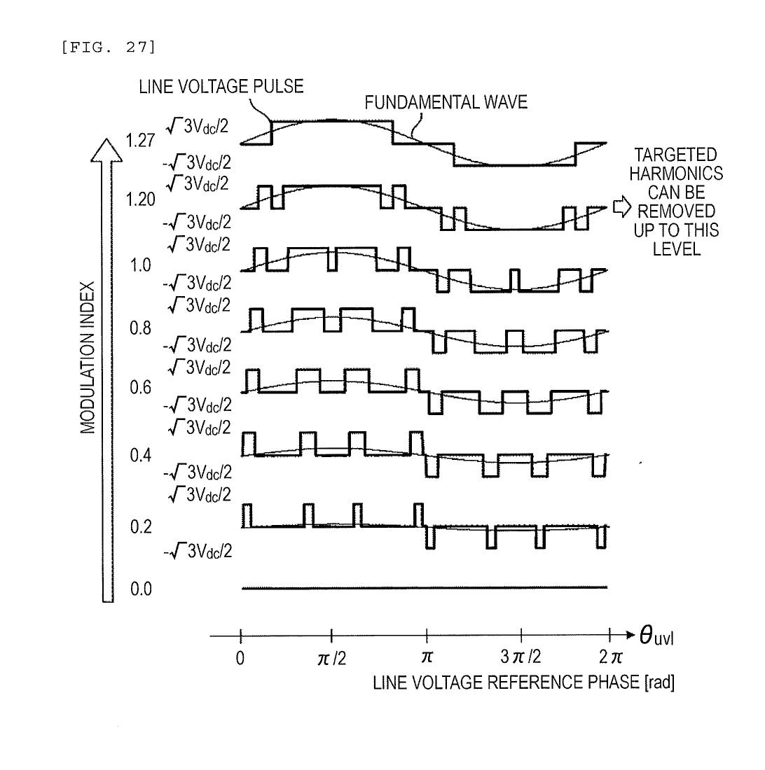

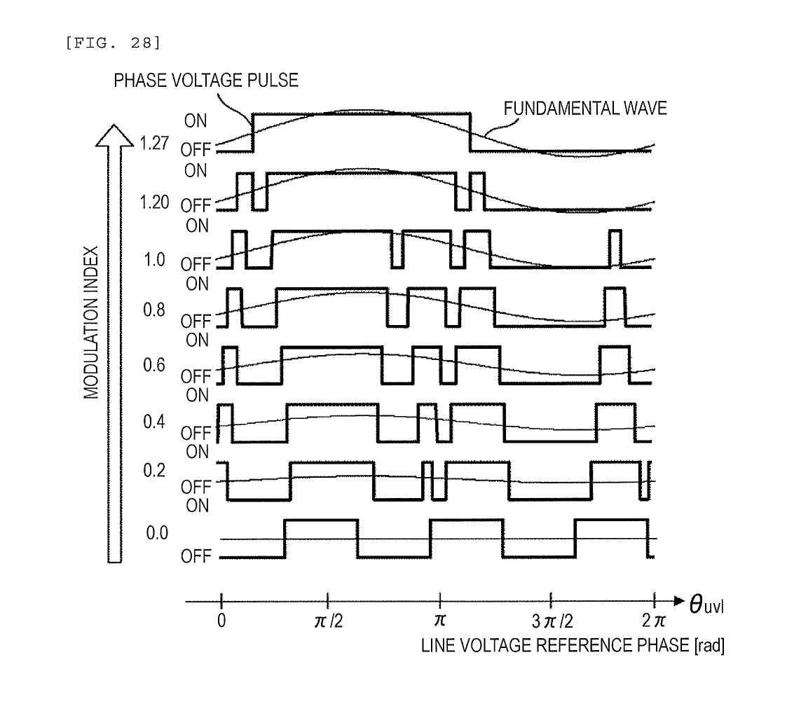

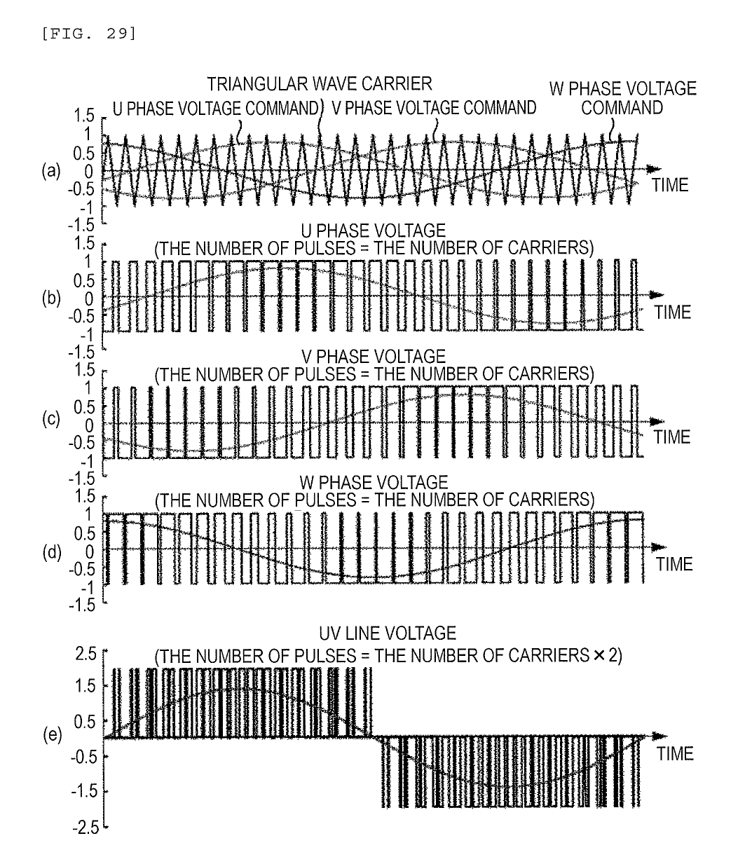

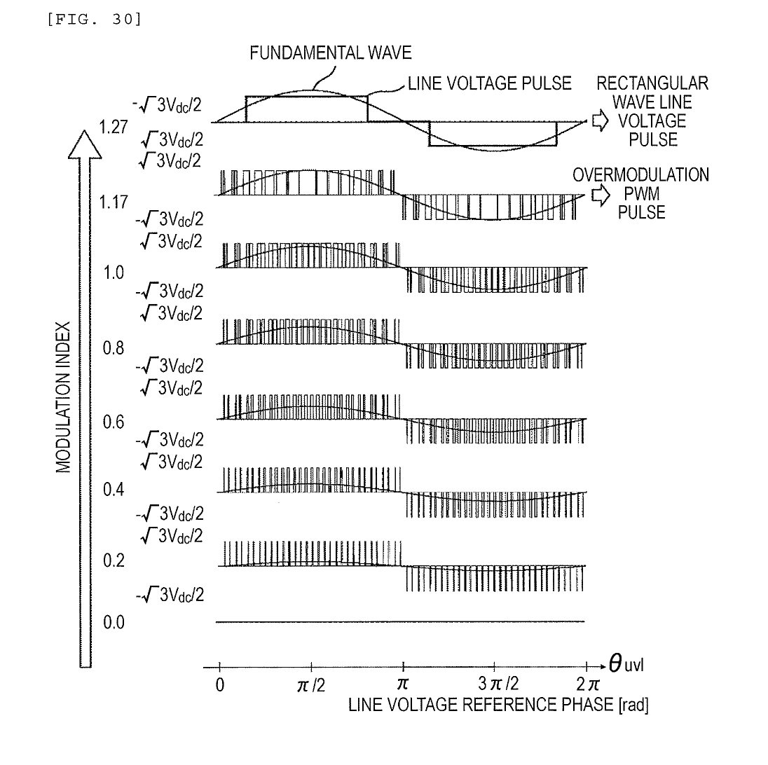

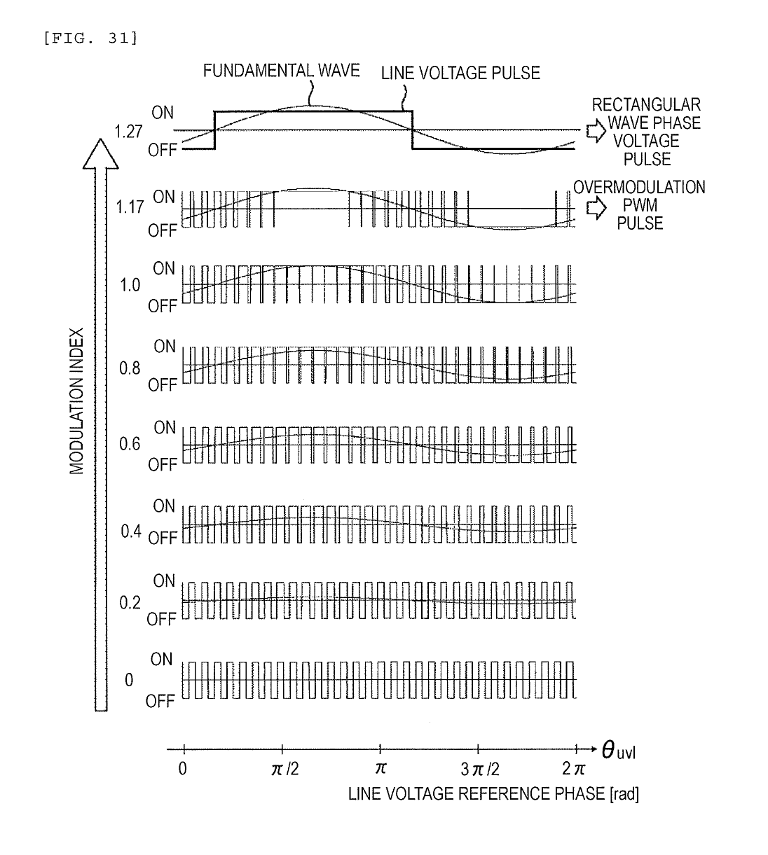

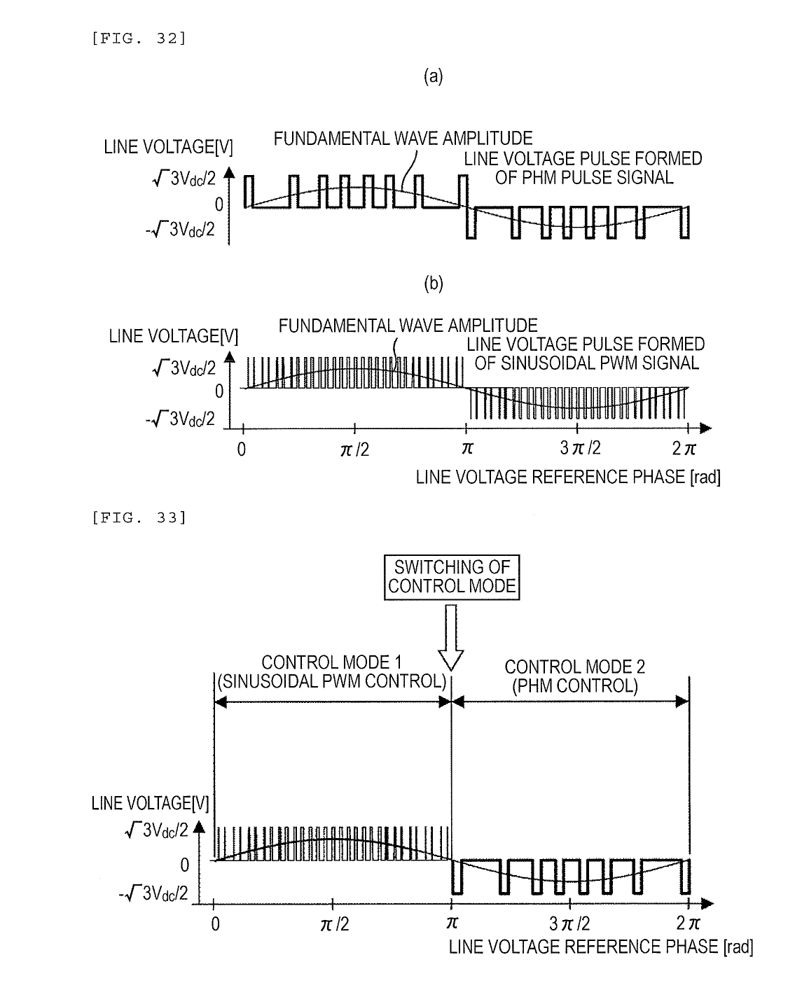

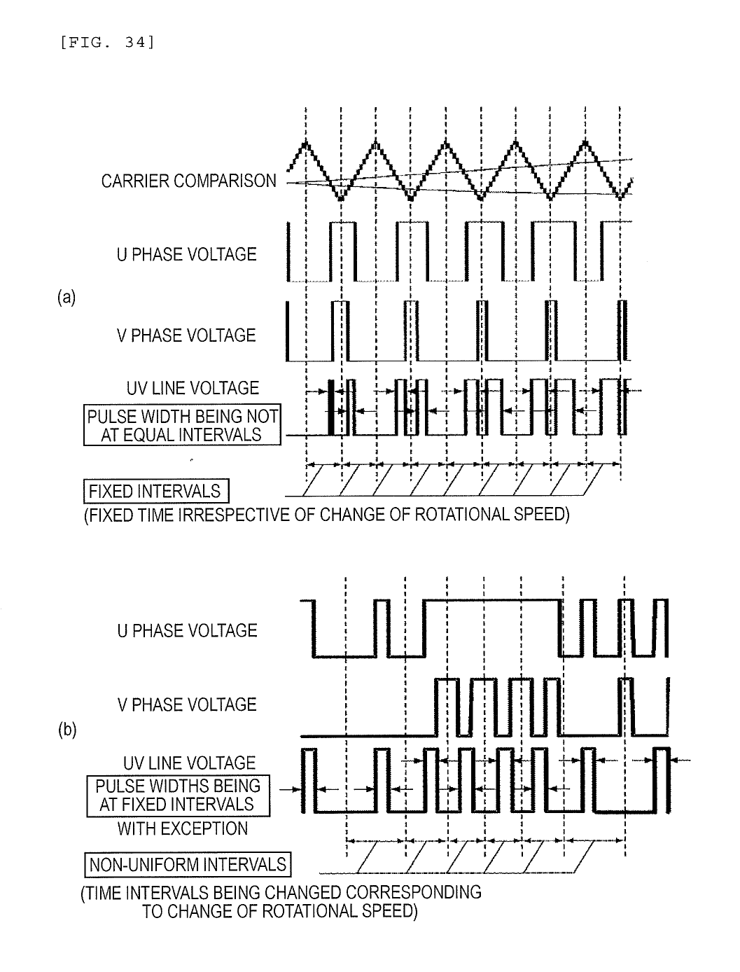

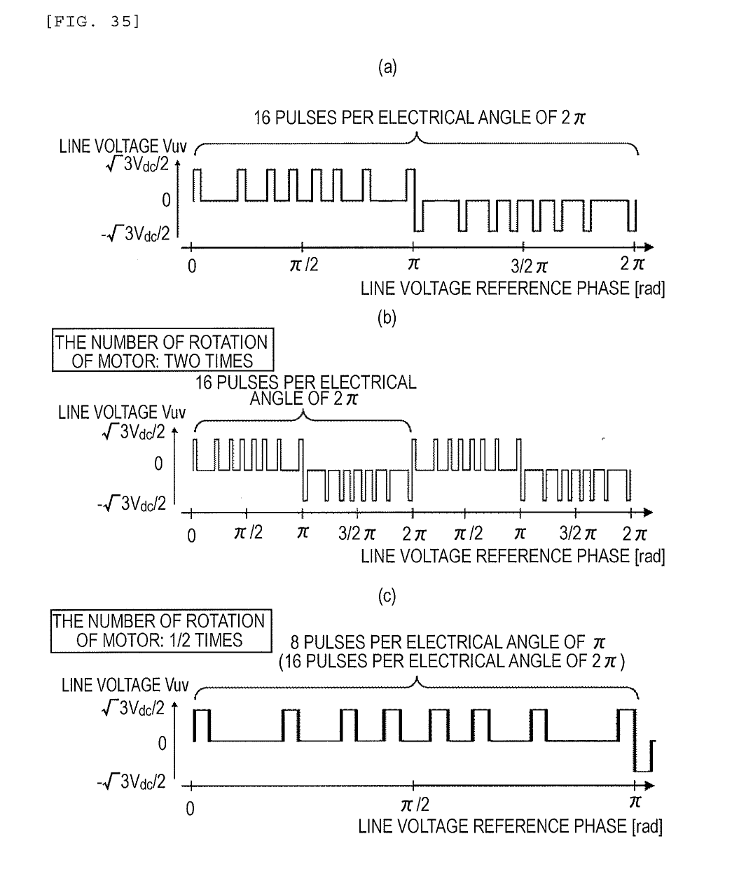

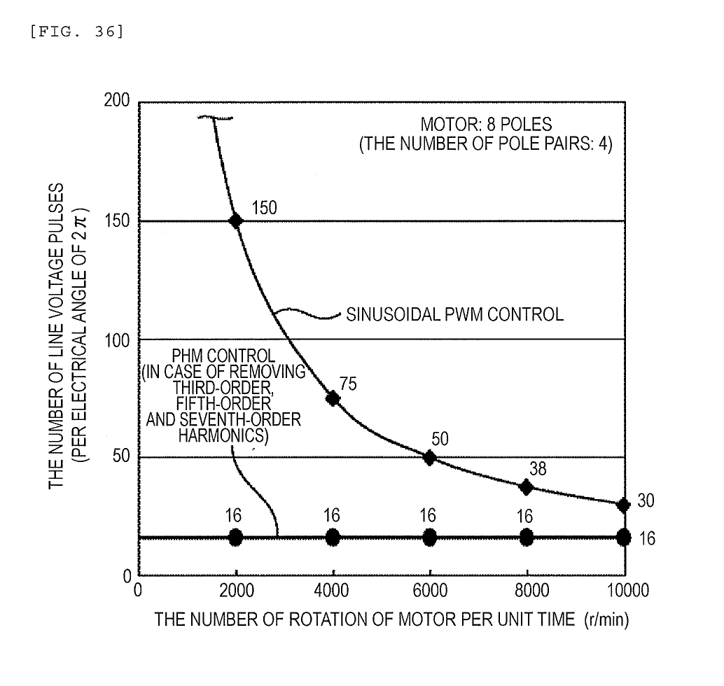

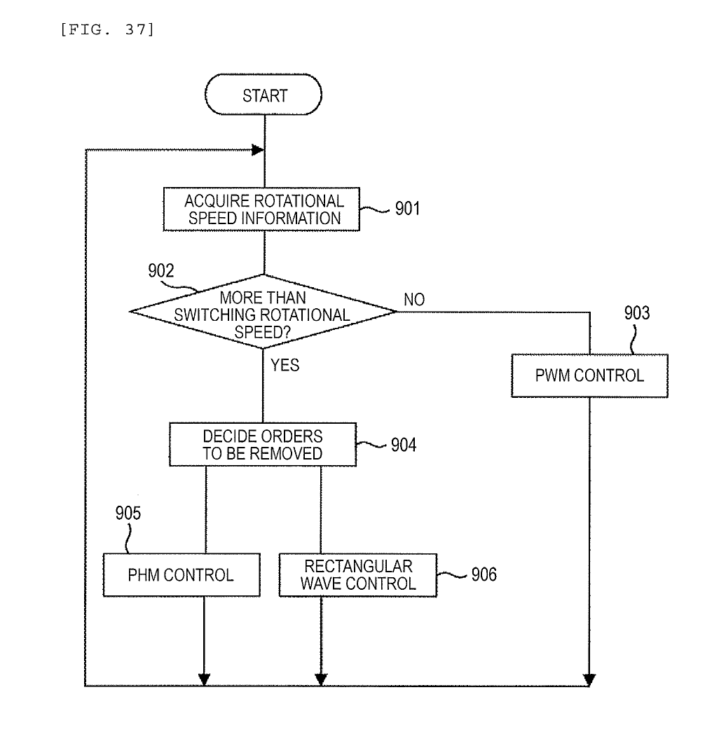

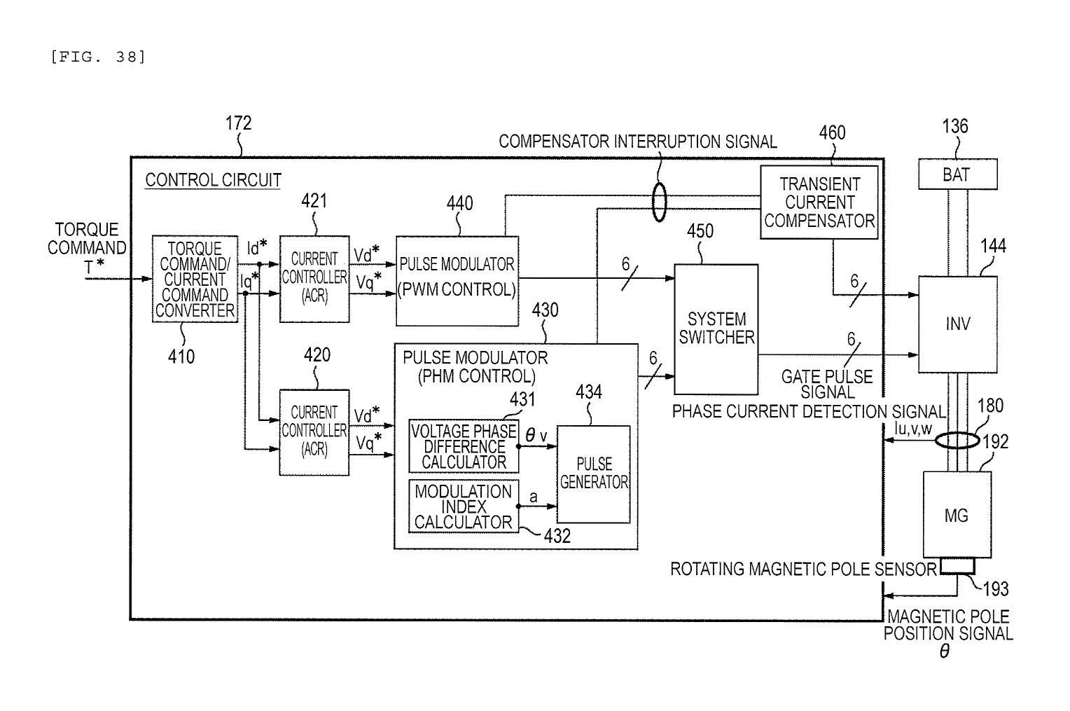

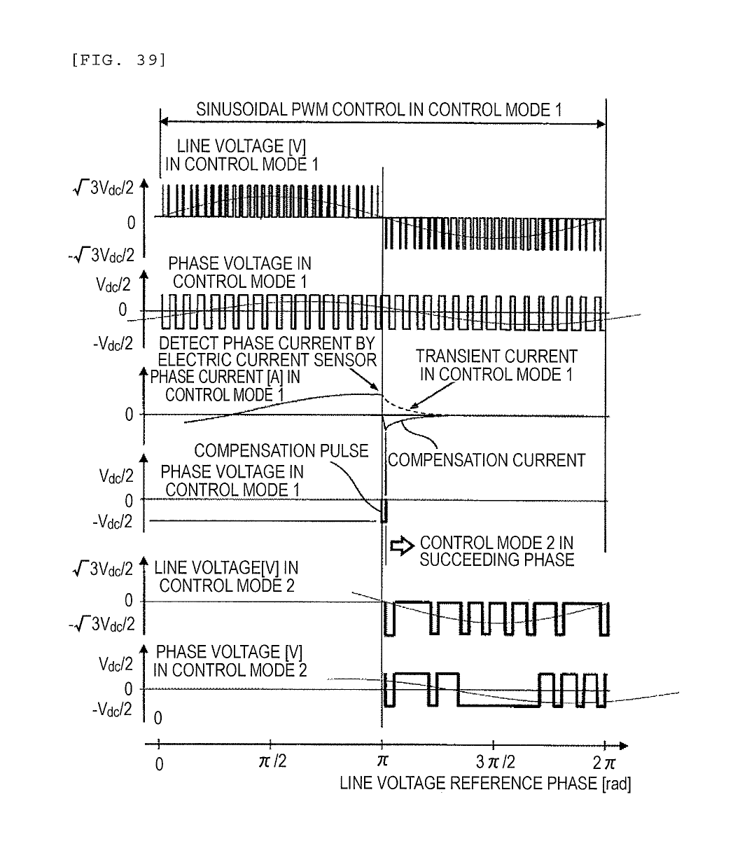

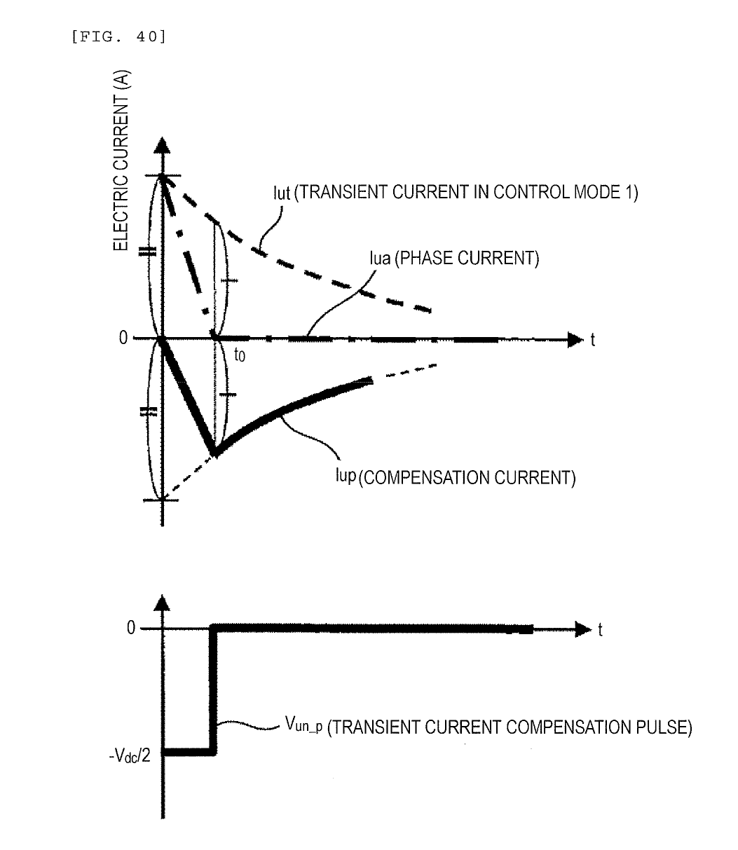

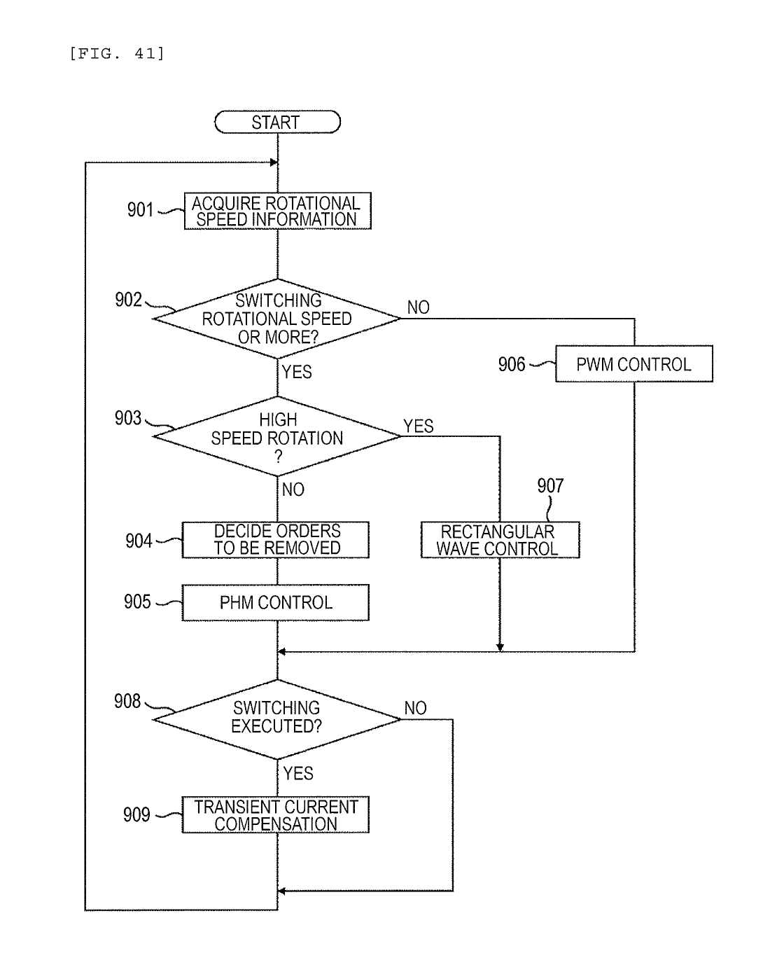

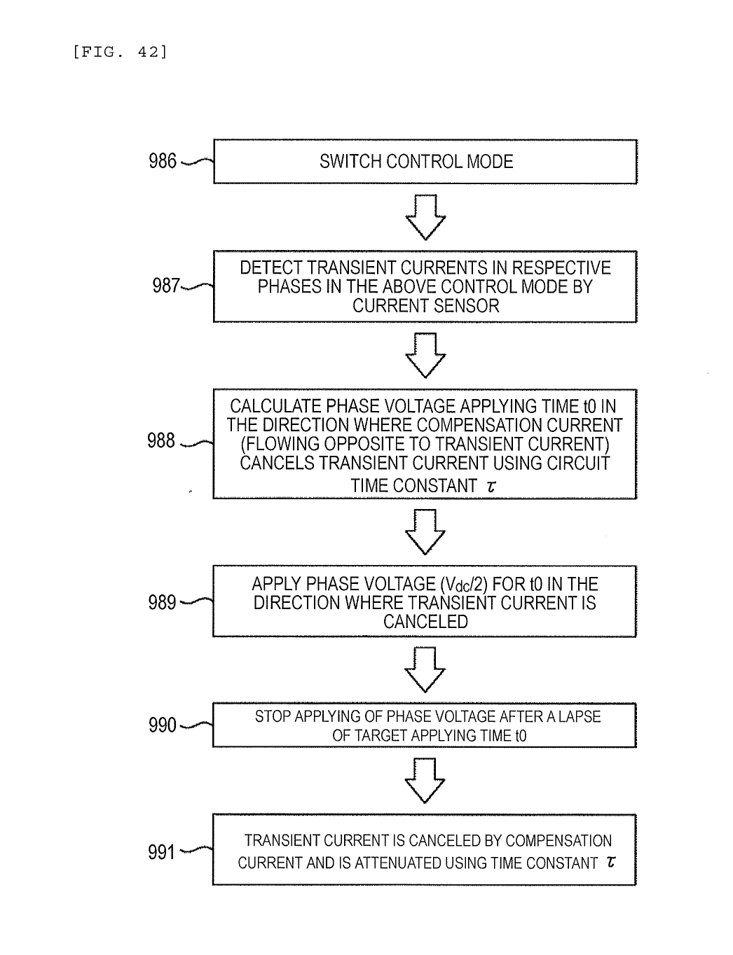

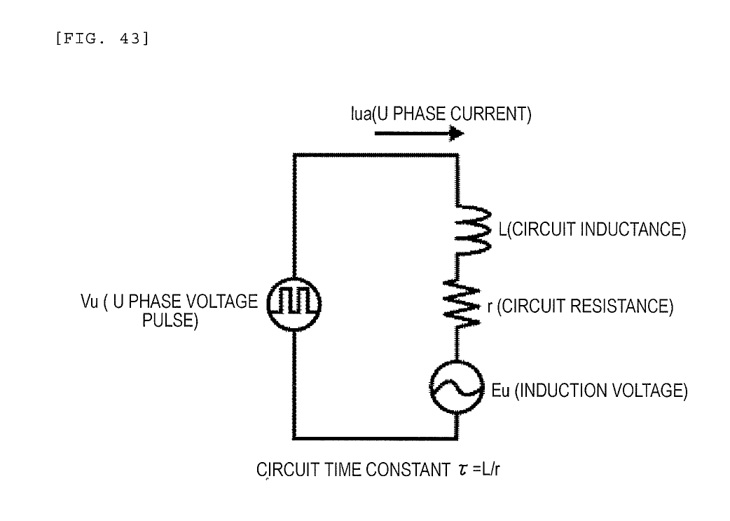

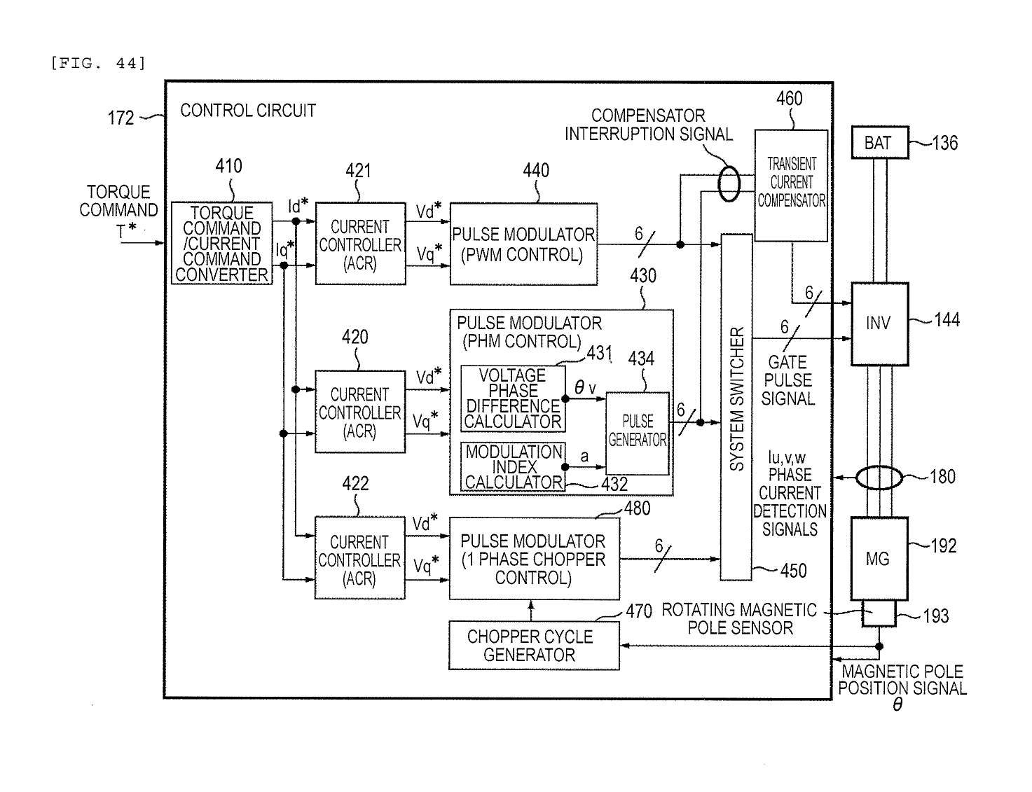

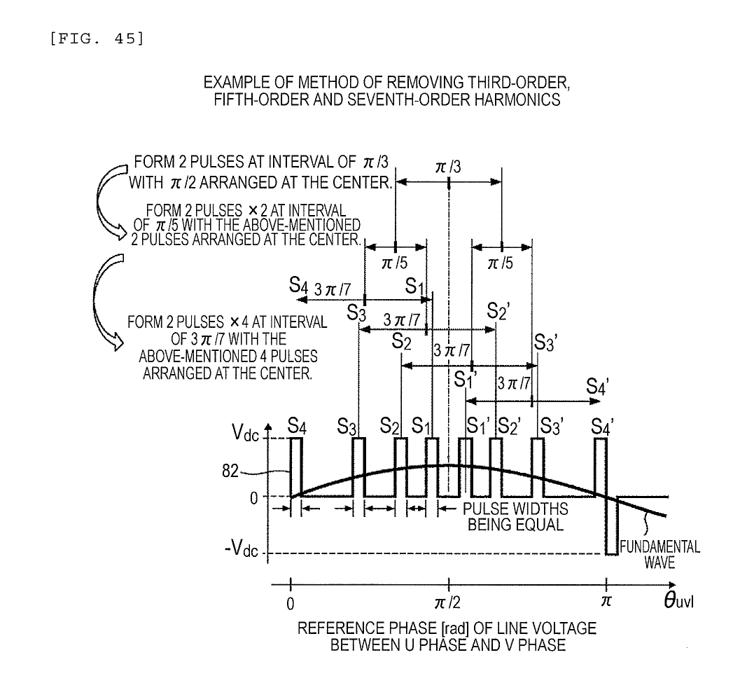

### BRIEF DESCRIPTION OF DRAWINGS

[FIG. 1] A block diagram showing a control system and a control device of a vehicle.

[FIG. 2] A block diagram showing the constitution of a steering system.

[FIG. 3] A block diagram showing the constitution of a cooling system.

[FIG. 4] A block diagram showing the constitution of an air conditioning system.

[FIG. 5] A block diagram showing the constitution of a brake control system.

[FIG. 6] A block diagram showing the relationship between respective operations of a host control system, the brake control system and a power conversion device.

[FIG. 7] A block diagram showing the constitution of the power conversion device.

[FIG. 8] A view showing an operation mode of the vehicle and states of main systems and control devices.

[FIG. 9] An operational flowchart for explaining respective operation modes and operation contents of the main systems.

[FIG. 10] An explanatory view for explaining switching of a control method based on a rotational speed of a motor generator.

[FIG. 11] An explanatory view for explaining a PWM control method and a rectangular wave control method.

[FIG. 12] A view showing an example of a harmonic component generated in the rectangular wave control.

[FIG. 13] A view showing a control system of a motor generator by a control circuit according to a first embodiment.

[FIG. 14] A view showing the constitution of a pulse generator.

[FIG. 15] A flowchart showing steps of generating pulses in accordance with table retrieval.

[FIG. 16] A flowchart showing steps of generating pulses in accordance with real time calculation.

[FIG. 17] A flowchart showing steps of pulse pattern calculation.

[FIG. 18] A view showing a method of generating a pulse using a phase counter.

[FIG. 19] A view showing one example of a waveform of a line voltage in a PHM control mode.

[FIG. 20] An explanatory view when a pulse width of a line voltage is not equal to a pulse width in other pulse rows.

[FIG. 21] A view showing one example of a waveform of a line voltage in a PHM control mode.

[FIG. 22] A view showing one example of a waveform of a phase voltage in a PHM control mode.

[FIG. 23] A view showing a conversion table between a line voltage and a phase terminal voltage.

[FIG. 24] A view showing an example where a line voltage pulse is converted into a phase voltage pulse in a rectangular wave control mode.

[FIG. 25] A view showing an example where a line voltage pulse is converted into a phase voltage pulse in a PHM control mode.

[FIG. 26] A view showing magnitudes of amplitudes of a fundamental wave and a harmonic component to be removed in a line voltage pulse when a modulation index is changed.

[FIG. 27] A view showing one example of a waveform of a line voltage in a PHM control mode.

[FIG. 28] A view showing one example of a waveform of a phase voltage in a PHM control mode.

[FIG. 29] A view for explaining a generation method of a PWM pulse signal.

[FIG. 30] A view showing one example of a waveform of a line voltage in a PWM control mode.

[FIG. 31] A view showing one example of a waveform of a phase voltage in a PWM control mode.

[FIG. 32] A view where a waveform of a line voltage pulse based on a PHM pulse signal and a waveform of a line voltage pulse based on a PWM pulse signal are compared to each other.

[FIG. 33] A view showing the manner that a PWM control mode and a PHM control mode are switched from each other.

[FIG. 34] A view for explaining the difference in pulse shape between a PWM control and a PHM control.

[FIG. 35] A view showing the relationship between a rotational speed of the motor generator and a waveform of a line voltage pulse based on a PHM pulse signal.

[FIG. 36] A view showing the relationship between the number of line voltage pulses and a rotational speed of a motor generator in a PHM control and a PWM control.

[FIG. 37] A view showing a flowchart of a motor control performed by a control circuit according to the first embodiment.

[FIG. 38] A view showing a control system of a motor generator by a control circuit according to a second embodiment.

[FIG. 39] A view for explaining the generation of a compensation current.

[FIG. 40] A view showing a part of a waveform of a phase current and a part of a waveform of a compensation pulse in an enlarged manner.

[FIG. 41] A view showing a flowchart of a motor control performed by the control circuit according to the second embodiment.

[FIG. 42] A flowchart showing steps of compensating a transient current.

[FIG. 43] A view showing a circuit model used for calculating a phase voltage applying time.

[FIG. 44] A view showing a control system of a motor generator by a control circuit according to a third embodiment.

[FIG. 45] An explanatory view for explaining patterns of line voltages of a U phase and a V phase when third-order, fifth-order and seventh-order harmonics are removed.

### DESCRIPTION OF EMBODIMENTS

Embodiments described hereinafter can achieve desired tasks in the manufacture of products and can acquire desired advantageous effects in the manufacture of products in addition to the above-mentioned tasks and advantageous effects described in the column “Technical Problem” and the column “Advantageous Effects of Invention”. Some of these tasks and advantageous effects are described hereinafter, and also in these embodiments, specific solutions to achieve the tasks and the specific advantageous effects are explained.

### [Reduction of Frequency of Switching Semiconductor Element Which Constitutes Inverter Circuit]

1. In a drive device for a motor generator explained in the embodiment hereinafter, the switching timing of a semiconductor element of an inverter is controlled based on a phase of an AC output converted from DC power, for example, an AC voltage, and a conduction operation or an interruption operation of the semiconductor element is performed corresponding to the phase of the AC output, for example, the AC voltage. Due to such a constitution or such an operation, the number of times of switching operation of the semiconductor element per unit time or the number of times of switching per 1 cycle of AC output, for example, an AC voltage can be reduced compared to a general PWM method (hereinafter referred to as a PHM method).

Further, in the above-mentioned constitution, in spite of a fact that the switching frequency of the semiconductor element of the inverter circuit is reduced, the degree of distortion of a waveform of an alternating current to be outputted can be selected based on a use purpose thus acquiring an advantageous effect that the increase of loss caused by the unnecessarily large number of times of switching operation of the semiconductor element can be suppressed. This brings about the reduction of heat generation of the semiconductor element of the inverter circuit.

2. Further, in the embodiment explained hereinafter, the order of a harmonic to be removed is selected. In this manner, in the embodiment described hereinafter, the order of harmonics to be removed can be selected corresponding to an object to which the control is applied and hence, the number of times of switching the semiconductor element of the inverter circuit can be properly reduced.

3. Further, in the embodiment described hereinafter, harmonics of the orders to be reduced are made to superpose each other for every unit phase, and switching timing of the semiconductor element of the inverter circuit is controlled based on a superposed waveform and hence, the number of times of switching the semiconductor element can be reduced so that power consumption can be reduced.

As the semiconductor element, it is desirable to use an element which has a fast operation speed, and can control both a conduction operation and an interruption operation based on a control signal. As such an element, for example, an Insulated Gate Bipolar Transistor (hereinafter referred to as IGBT) or a field effect transistor (MOS transistor) can be named. The use of these elements is desirable from a viewpoint of responsiveness and controllability.

4. In the embodiment described hereinafter, in a first operation range where a rotational speed of an electric rotating machine is fast, a switching operation of a semiconductor element is generated based on a phase of a waveform of an alternating current to be outputted, that is, the semiconductor element is controlled by a PHM method. On the other hand, in a second operation region where the rotational speed of an electric rotating machine is slower than the rotational speed of the electric rotating machine in the first operation range, the semiconductor element is controlled using a PWM method where the operation of the semiconductor element is controlled based on a carrier wave having a fixed frequency. A state where a rotor of the electric rotating machine is stopped may be included in the second operation region. In the embodiment described hereinafter, the explanation is made with respect to an example where a motor is used as the electric rotating machine and a motor generator is used as a generator.

### [Reduction of Power Consumption of Vehicle]

1. In a drive device for driving a traveling-use motor generator of a vehicle, switching timing of a semiconductor element of an inverter is controlled based on a phase of an AC output converted from DC power, for example, an AC voltage, and a conduction operation or an interruption operation of the semiconductor element is performed corresponding to a phase of AC output, for example, an AC voltage. That is, the semiconductor element is controlled using a PHM method. Accordingly, the number of times of switching operation of the semiconductor element per unit time or the number of times of switching per 1 cycle of AC output, for example, an AC voltage can be reduced compared to a PWM method used in general. Since the traveling-use motor generator can be driven using the control method which can reduce power consumption in such a manner, power consumption necessary for moving the vehicle can be reduced.

2. In the embodiment described hereinafter, a motor which assists a steering force of steering which requires the reduction of torque pulsation is controlled using a PWM method where the torque pulsation is small, while driving of the traveling-use motor generator which is less influenced by torque pulsation compared to the motor for steering is performed using a control method where a conduction operation or an interruption operation is performed corresponding to a phase angle of an AC output, for example, an AC voltage, that is, using a PHM method so that power consumption of the vehicle can be reduced.

3. In the embodiment described hereinafter, by controlling a motor which circulates a cooling medium for cooling an inverter circuit or a drive device of a motor generator which includes the inverter circuit using a PHM method, power consumption of the motor can be reduced so that power consumption of a vehicle can be reduced. The motor for circulating the cooling medium has no direct relationship with riding comfortability and hence, there arises no serious problem even when pulsation exists. Accordingly, there arises no serious problem even when kinds of harmonics to be removed are not increased. Accordingly, the number of times of switching a semiconductor element of the inverter circuit can be reduced so that power consumption can be reduced.

4. In the embodiment described hereinafter, by controlling a motor for driving a compressor which compresses a refrigerant for adjusting a temperature or moisture in a vehicle cabin using a PHM, method, power consumption of an inverter circuit of a motor for driving the compressor can be reduced so that power consumption of a vehicle can be reduced.

### [Improvement of Riding Comfortability of Vehicle]

1. The above-mentioned PHM method is a method where the conduction or the interruption of the semiconductor element is performed based on a phase angle of a waveform of an AC output, for example, a waveform of an AC voltage. In a first operation region where a rotational speed of the traveling-use motor generator is low, that is, in the region where the vehicle starts traveling from a parking state, torque pulsation is increased. On the other hand, this first operation region is an operation region where the torque pulsation more influences riding comfortability than other operation regions. Accordingly, by controlling the traveling-use motor generator using a PWM method in the first region, and by controlling the traveling-use motor generator using a PHM method in a region where a vehicle traveling speed is higher than that in the first region, it is possible to acquire both the improvement of riding comfortability of the vehicle and the reduction of power consumption.

### [Basic Control of PHM Relating to Vehicle Operation]

1. In the embodiment explained hereinafter, in a first operation region where a motor generator which is an electric rotating machine which supplies AC power is in a low speed operation state, the motor generator is controlled using a PWM method, while in a second operation region where a rotational speed of the electric rotating machine becomes higher than a rotational speed of the electric rotating machine in the first operation region, the control of the motor generator is shifted to a control using a PHM method. Accordingly, the influence exerted by distortion of an AC waveform can be suppressed as much as possible thus realizing the enhancement of efficiency of an operation of the electric rotating machine.

2. In the embodiment explained hereinafter, when a vehicle starts based on a manipulation of an acceleration pedal from a parking state, an inverter circuit which controls a motor generator which is an electric rotating machine for vehicle traveling firstly generates AC power using a chopper control method, outputs AC power using a PWM control method when the motor generator starts rotation thereof so that the vehicle starts moving, and the operation of the motor generator is shifted to the generation of AC output using a PHM method when a rotational speed of the motor generator becomes larger than a predetermined rotational speed. By changing the control method of the inverter circuit based on the operation of the vehicle in this manner, power consumption can be reduced.

3. In a PHM method of an inverter circuit described in the embodiment explained hereinafter, a conduction width of a semiconductor element which constitutes an inverter circuit is controlled based on a manipulation of an acceleration pedal, and provided that condition on a vehicle speed is substantially equal among vehicles, the conduction width of the semiconductor element is controlled in the direction that the conduction width is increased in a state where a manipulation variable of an acceleration pedal is increased, while the conduction width of the semiconductor element is controlled in the direction that the control width of the semiconductor element is decreased when the manipulation variable of the acceleration pedal is decreased.

4. In a PHM method of an inverter circuit described in the embodiment explained hereinafter, a conduction width of the semiconductor element which constitutes the inverter circuit is controlled based on a manipulation variable of a brake pedal, and provided that conditions on a vehicle speed are substantially equal and step-in speeds of a brake pedal are substantially equal among vehicles, a conduction width of the semiconductor element is increased when a step-in amount of the brake pedal is large, while the conduction width of the semiconductor element becomes small when the step-in amount of the brake pedal is small.

5. A drive device of a motor generator according to the embodiment of the present invention is applicable to an electric rotating machine used for a hybrid vehicle which travels using both an engine and a motor as a drive source (hereinafter referred to as HEV), an electric rotating machine used for a pure electric vehicle which travels by a motor (hereinafter referred to as EV) and, further, an electric rotating machine used for a vehicle which travels on a railroad referred to as an electric train. Among these vehicles, a large advantageous effect can be expected by applying a PHM method to the HEV and the EV which have a strong demand in markets in view of an environmental problem or the like. However, among respective controls of traveling-use electric rotating machines of the HEV, EV and railway vehicle, contents of an operation using a PHM method are basically equal, and also with respect to solutions to overcome tasks and advantageous effects, basic portions are equal.

6. With respect to a PHM method for an electric rotating machine for driving a compressor or a fan in an air conditioning system of a vehicle explained hereinafter, a basic control of an inverter circuit basically has the substantially same control contents as an inverter circuit for driving a traveling-use motor generator of an HEV or an EV.

### [Specific Control of PHM According to Vehicle Operation]

1. From a viewpoint different from the viewpoint adopted by the above-mentioned basic control, as explained in the embodiment described hereinafter, a control of a motor generator which is an electric rotating machine is shifted to a rectangular wave control of a PHM control in an operation where the motor generator is rotated at a high speed, that is, in a high-speed operation state. In the PHM control explained hereinafter, switching timing is controlled corresponding to a phase of a waveform of an alternating current to be outputted. The number of times of switching in a half cycle (0 to π or π to 2π in an electrical angle) of AC power is gradually decreased along with the increase of a modulation index and, finally, the control of the motor generator is shifted to a rectangular waveform control where a semiconductor element becomes conductive one time in the half cycle. In this manner, the embodiment described hereinafter has an advantageous effect that the control of the motor generator is smoothly shifted to the rectangular waveform control so that the control of the motor generator ensures excellent controllability of vehicle traveling.

2. In the embodiment described hereinafter, a conduction start timing of a semiconductor element is synchronized with a phase of AC output, for example, an AC voltage to be converted. An angle at which a conduction state of the semiconductor element at a first modulation index which is a small modulation index continues (hereinafter referred to as a conduction holding angle) is controlled to be increased at a second modulation index having a larger modulation index than the first modulation index. Further, when a succeeding angle at which an interruption state of the semiconductor element continues (hereinafter referred to as an interruption holding angle) is decreased, and the interruption holding angle is decreased to a predetermined angle larger than an angle at which the semiconductor element can be operated at a third modulation index having a larger modulation index than the second modulation index, a control is made so as to connect the interruption holding angle to a next conduction holding angle while eliminating an interruption period. By performing such a control, reliability can be enhanced in addition to the reduction of the number of times of switching the semiconductor element.

3. In the embodiment described hereinafter, an electric rotating machine such as a permanent-magnet-type synchronous electric rotating machine or an induction electric rotating machine includes: a plurality of semiconductor elements which receive the supply of DC power and convert the DC power into AC power to be supplied into an inductance load; and a driver circuit which outputs a drive signal for controlling the conduction and the interruption of the semiconductor elements, wherein the conduction or the interruption of the semiconductor elements is controlled in response to the drive signal based on a phase of an AC output, for example, AC power to be converted, so that the semiconductor element is operated as an inductance load, for example, in a state of an approximately equal modulation index. In such an electric rotating machine, a control is performed so as to slightly increase a conduction width of the semiconductor element based on the rise of an internal induction voltage when a rotational speed becomes slightly high. Along with such a control, the semiconductor element is controlled so as to slightly shorten an interruption width of the semiconductor element. For example, in a state where a required rotational torque of an electric rotating machine is substantially equal, the semiconductor element is controlled such that even when a frequency of an AC output to be supplied to an induction load is changed within a range from a first frequency to a frequency 1.5 times as high as the first frequency, the number of times of switching per 1 cycle for generating the above-mentioned AC output is not changed as much as possible. Due to such a control, the reduction of switching loss can be realized while suppressing the distortion of an AC output, for example, an AC current to be converted.

4. Further, when a rotational speed is largely increased in an electric rotating machine, the rise of an internal induction voltage becomes large. A control is performed such that the number of times of conduction of an inverter circuit per basic cycle becomes equal as much as possible so that the control is performed in the direction that each conduction width is increased. Accordingly, an interruption width of the inverter circuit is decreased. When an interruption width of the inverter circuit becomes narrower than a predetermined width, there is a possibility that a semiconductor element cannot surely perform an interruption operation. A time width where it is difficult for a semiconductor element to surely perform an interruption operation is set, and when the interruption width of the semiconductor element to be controlled and the set width are compared to each other, and the interruption width of the semiconductor element to be controlled is short so that it is determined that the securing of the interruption width equal to or more than the above-mentioned setting width is difficult, the interruption of the semiconductor is stopped and a conduction operation is continued. In this case, the number of times of conduction per basic cycle is reduced. In the embodiment described hereinafter, when a modulation index is increased, an interruption width of the semiconductor element becomes short, and the number of times of conduction per basic cycle is decreased due to the above-mentioned reason. Finally, a rectangular wave control where the conduction of the semiconductor element is made one time per half cycle is performed.

That is, when an interruption width of the semiconductor element is ensured, a control is performed such that the number of times of conduction becomes substantially equal as much as possible between respective lines of a U phase, a V phase and a W phase. When an interruption width of the semiconductor element becomes narrow due to a demand for increase of an AC wave peak value, the number of times of conduction of an inverter circuit between the respective lines of a U phase, a V phase and a W phase per basic cycle is decreased. By controlling the inverter circuit in such a manner, the number of times of switching per unit time of the semiconductor element can be made smaller than the corresponding number of times of switching in accordance with a PWM method so that the efficiency is enhanced.

5. In the embodiment described hereinafter, an electric rotating machine includes, for converting supplied DC power into 3 phase AC power for driving the electric rotating machine, a bridge circuit having a plurality of semiconductor elements which constitute upper arms and lower arms, a control circuit for controlling the conduction and the interruption of the semiconductor elements, and a driver circuit which generates a drive signal for performing the conduction and the interruption of the semiconductor elements, wherein a drive signal is supplied to the semiconductor elements from the driver circuit based on a phase of an AC output, for example, an AC voltage to be outputted, and the semiconductor elements are made conductive based on the drive signal so that an alternating current is supplied to the electric rotating machine. In this case, a series circuit which is constituted of an upper arm, a lower arm and a stator winding which is a load between the upper arm and the lower arm is brought into a state where the series circuit is connected between terminals of a smoothing capacitor. Even when the semiconductor element of either one of the upper arm and the lower arm continues a conductive state, the interruption of the other semiconductor element brings the whole circuit into an interruption state. In such a manner, by performing a control such that one semiconductor element continues a conduction state and the other semiconductor element is interrupted, the number of times of switching the whole inverter circuit can be reduced so that the loss can be reduced. In an operation state, there exists a state where the upper arms of plural phases are in a parallel connection state or lower arms of plural phases are in a parallel connection state. Also in such a case, in the same manner, by maintaining one of the upper arm and the lower arm in a conduction state and by performing a conduction operation or an interruption operation with respect to the other of the upper arm and the lower arm, the number of times of switching the whole inverter circuit can be reduced so that the loss can be reduced. Particularly, by maintaining either one arm of the upper arm and the lower arm in parallel connection in a conduction state and by performing the conduction operation or the interruption operation by the other arm, the number of times of switching the whole inverter circuit can be reduced so that the loss can be reduced. Further, a control also becomes simple depending on a case. Still further, by wholly bringing either one of an upper arm and a lower arm into a conductive state, a stator winding of a motor generator which constitutes an electric rotating machine can be 3-phase short-circuited.

Next, the embodiments according to the present invention are explained in conjunction with drawings. FIG. 1 shows main control systems and main control devices of the vehicle, and these control system or the control devices are operated using power of a low voltage power source 20 and power of a high voltage power source device 136 constituted of a battery such as a lithium ion secondary battery. DC power of the low voltage power source 20 is supplied to the respective control systems and the respective control devices via a low voltage supply line 16 and a vehicle body. On the other hand, a DC high voltage of the high voltage power source device 136 is supplied to a power conversion device 200. To be more specific, the high voltage power source device 136 is connected to input terminals 508, 509 of a smoothing capacitor 500 via a DC terminal 138 (see FIG. 7), and output terminals 504, 506 of the smoothing capacitor 500 are connected to an inverter circuit 140 and a driver circuit 174 via DC buses 18P and 18M respectively. Although the input terminals 508, 509 of the smoothing capacitor 500 are connected to the output terminals 504, 506 respectively, a capacitor cell constituted of a large number of films not shown in the drawing is connected between these terminals. Noise components which enter the smoothing capacitor 500 through the input terminals 508, 509 are gradually attenuated by the capacitor cell so that the noise components from the input terminals 508, 509 are suppressed and reduced whereby adverse influence of noises exerted on the high voltage power source device 136 can be reduced.

An acoustic system 22 which is operated by DC power from the low voltage power source 20 is a radio or music equipment, and is operated by the vehicle occupant manipulation. The basic constitution of a steering system 80 of the vehicle which is operated by DC power from the low voltage power source 20 is shown in FIG. 2. As shown in FIG. 2, a manipulation force on the handle is detected by a first sensor 86, a vehicle speed is detected by a second sensor 88, and a generation torque of a steering motor 82 which assists a steering force is controlled by a power conversion device 84 such that a manipulation force necessary for manipulating the handle is suppressed to a low value. The steering motor 82 is used in a state where the steering motor 82 is frequently stopped and, further, feeling that a hand of a driver manipulating a handle perceives is extremely sensitive so that even the small torque pulsation gives a user discomfort. Accordingly, the power conversion device 84 generates AC power using a PWM method which generates small torque pulsation, and controls the steering motor 82.

A cooling system 50 which is operated by DC power from the low voltage power source 20 is a system for cooling the power conversion device 200 explained hereinafter, and the main constitution of the cooling system 50 is shown in FIG. 3. As shown in FIG. 3, the cooling system 50 is a system for cooling particularly the inverter circuit 140 and the smoothing capacitor 500 of the power conversion device 200. A refrigerant which flows through a refrigerant flow passage 55 is cooled by a radiator 57, the cooled refrigerant is circulated through the refrigerant flow passage 55 by a pump, cools the inverter circuit 140 and the smoothing capacitor 500, and returns to the radiator 57 again. A pump motor 56 which drives the above-mentioned pump generates a rotational torque using AC power which a cooling power conversion device 52 generates. Further, a fan which is used for cooling the refrigerant in the radiator 57 is rotated by a rotational torque which a fan motor 58 generates. AC power which the fan motor 58 requires for generating the rotational torque is also generated by the cooling power conversion device 52. The above-mentioned pump motor 56 and the fan motor 58 are not motors of a type where stopping and starting of the rotation of the motor are frequently repeated. Further, these motors are not motors which are used under circumstances where torque pulsation has a large effect on other equipment. Due to these reasons, the cooling power conversion device 52 is suitable for generating AC output by a PHM method explained hereinafter, and a power loss can be reduced by operating the cooling power conversion device 52 by the PHM method. The cooling system 50 can use water as a refrigerant, and the refrigerant made from water is suitable for cooling the inverter circuit 140 and the smoothing capacitor 500.

The basic constitution of an air conditioning system 70 which is operated by DC power of the low voltage power source 20 is shown in FIG. 4. A refrigerant which flows through a cooling passage 71 is compressed by a compressor driven by a compressor-use motor 73, the high-pressure compressed refrigerant is cooled by a condenser not shown in the drawing, and the refrigerant is expanded using an expansion valve not shown in the drawing so that a temperature of the refrigerant is further lowered. The low-temperature refrigerant is fed to a heat exchanger 75 constituted of an evaporator or the like so that air is cooled, and the refrigerant returns to the compressor again. Cooled air is mixed with warm air such that mixed air attains a temperature set by a temperature setting device 77, and the mixed air is supplied to the inside of a cabin. A blower such as a blower fan is arranged in the heat exchanger 75, for example, and the blower is rotated by a rotational torque of a fan motor 74. A temperature sensor 76 detects a blowout temperature of the blower, and the feedback control is performed such that a blowout temperature attains the temperature set by the temperature setting device 77. AC power which an air conditioning power conversion device 72 generates is supplied to the pump motor 56 and the fan motor 58, and the pump motor 56 and the fan motor 58 generate a rotational torque powered by the AC power. With respect to the compressor-use motor 73 and the fan motor 74, an operation where a rotational torque is continuously generated is not performed in a stop state, and the pump is not required to be used in a state where a rotational torque with extremely small torque pulsation is necessary. Accordingly, the compressor-use motor 73 and the fan motor 74 are suitable for an operation which can suppress power consumption as much as possible by making use of a PHM control explained hereinafter.

FIG. 6 is a view showing the operational relationship between a host control system 40, a brake control system 60 and the power conversion device 200, and the main constitution of the brake control system 60 is shown in FIG. 5. The main constitution of the power conversion device 200 is shown in FIG. 1 and FIG. 7. As shown in FIG. 6, when a user manipulates a key switch 46 for starting an operation of the vehicle in a parking state, a host control device 42 performs a control for starting the operation of the brake control system 60 and the power conversion device 200 corresponding to the manipulation. When a user steps on an acceleration pedal 44 while driving the vehicle, the host control device 42 transmits a torque command to a control circuit 172 of the power conversion device 200 for starting the vehicle or for increasing a traveling speed of the vehicle. When a brake pedal 61 is stepped in, the host control device 42 calculates a required braking force and determines whether a motor generator 192 is to be operated for performing the regenerating operation for generating a braking force, whether the brake control system 60 is to be operated for generating a friction brake to generate a braking force or whether both of the above-mentioned operations are to be performed to generate a braking force. Then, the host control device 42 transmits commands to a brake control device 62 of the brake control system 60 and the control circuit 172 of the power conversion device 200 to apply the braking forces which are generated by the motor generator 192 and the brake control system 60 respectively. The brake control system 60 or the power conversion device 200 is operated in order to generate the braking force corresponding to the command transmitted by the brake control system 60 or the power conversion device 200 based on the command.

In a block diagram shown in FIG. 5, a manipulation variable or a manipulation speed of the brake pedal 61 is detected by a brake manipulation variable detection device 64, and a detection value of the brake manipulation variable detection device 64 is transmitted to the host control device 42 of the host control system 40 via a signal transmission path 24 shown in FIG. 6. As described above, based on the detection value of the brake manipulation variable detection device 64, a braking force generated by the power conversion device 200 and a braking force generated by the brake control system 60 are decided by the host control device 42, and the braking force generated by the brake control system 60 is transmitted to the brake control device 62 of a booster 66 via the signal transmission path 24. The brake control device 62 generates AC power to make a braking motor 63 generate a rotational torque based on a braking command from the host control device 42, and the braking motor 63 moves an input piston of a master cylinder 65 using the generated AC power. The master cylinder 65 generates a liquid pressure of working oil based on an amount of movement of the input piston, and the liquid pressure of the working oil is transmitted to a caliper (not shown in the drawing) of respective wheels of the vehicle by an oil pressure regulating valve 68 so that the respective wheels generate a braking force. The braking motor 63 is controlled such that a predetermined rotational torque is generated in a rotation stop state so that the brake control device 62 generates AC power by a PWM method.

FIG. 7 shows the specific circuit constitutions of the power conversion device 200 shown in FIG. 1, the power conversion device 84 of the steering system 80 shown in FIG. 2, the air conditioning power conversion device 72 of the air conditioning system 70 shown in FIG. 4, the cooling power conversion device 52 of the cooling system 50 shown in FIG. 3, and the brake control device 62 of the brake control system 60 shown in FIG. 5. The purposes of operations of the power conversion device 84, the air conditioning power conversion device 72, the cooling power conversion device 52, and the brake control device 62 are substantially same with respect to a point that these devices receive DC power and generate AC power for allowing an electric rotating machine to generate a rotational torque. Further, although these devices differ from each other with respect to magnitude of generated AC voltage or AC power, these devices have the similar basic circuit constitutions and the similar manners of operation and hence, the explanation is made by taking the power conversion device 200 shown in FIG. 1 and FIG. 7 as a representative example.

As described above, the basic constitution and the manner of operation of the motor generator 192 which is one example of the motor and the power conversion device 200 for generating AC power are substantially equal to the basic constitution and the manner of operation of motors and power conversion devices of other systems and other devices. However, in the motor generator 192 and the power conversion device 200 which are used for moving the vehicle, the motor generator 192 is operated as a motor for making the vehicle travel corresponding to a driving state, while the motor generator 192 generates a braking force when the brake pedal 61 is manipulated so that the motor generator 192 is operated as a generator which converts mechanical energy from the wheel into AC power. AC power generated by the motor generator 192 is converted into DC power by the inverter circuit 140, and DC power is used for charging the high voltage power source device 136. An AC connector 188 is used for connecting an AC terminal of the inverter circuit 140 and the motor generator 192 with each other. The exterior of the motor generator 192 is covered with a metal-made housing, and the metal-made housing is directly or indirectly fixed to the vehicle body and hence, the motor generator 192 is electrically connected with the vehicle body.

Next, the explanation of the power conversion device 200 is made in conjunction with FIG. 7. The power conversion device 200 according to this embodiment includes the inverter circuit 140, a capacitor module 500, the control circuit 172, the driver circuit 174, the current sensor 180, the DC terminal 138, and the AC connector 188. The inverter circuit 140 includes semiconductor elements which operate as upper arms and semiconductor elements which operate as lower arms. In this embodiment, an IGBT (Insulated Gate Bipolar Transistor) is used as the semiconductor element. The IGBTs 328U, 328V, 328W which are operated as the upper arms are connected with the diodes 156U, 156V, 156W in parallel to each other respectively. The IGBTs 330U, 330V, 330W which are operated as the lower arms are connected with the diodes 166U, 166V, 166W in parallel to each other respectively. The power conversion device 200 includes a plurality of series circuit formed of the upper and lower arms. In the example shown in FIG. 7, the power conversion device 200 includes 3 series circuits formed of the upper and lower arms of a U phase, a V phase and a W phase, AC power is supplied to the motor generator 192 through an AC bus bar which is an AC power line via an AC connector 188 from nodes 169U, 169V, 169W of the respective series circuits between the upper and lower arms. Further, the power conversion device 200 includes a driver circuit 174 which performs a drive control of the inverter circuit 140 and the control circuit 172 which supplies a control signal to the driver circuit 174.

The IGBT 328 of the upper arm and the IGBT 330 of the lower arm are constituted of a semiconductor element, a control signal from the control circuit 172 is supplied to the driver circuit 174, the IGBT 328 of the upper arm and the IGBT 330 of the lower arm are brought into a conduction state or an interruption state based on a signal from the driver circuit 174, and DC power supplied from the high voltage power source device 136 is converted into three-phase AC power. This converted three-phase AC power is supplied to a stator winding of the motor generator 192. As described previously, the power conversion device 200 also performs an operation of converting three-phase AC power which the motor generator 192 generates into DC power, and the converted DC power is used for charging the high voltage power source device 136. As described previously, a MOSFET (metal oxide semiconductor field effect transistor) may be used as the semiconductor element. In this case, the diode 156 and the diode 166 become unnecessary.

The smoothing capacitor 500 performs a function of suppressing the fluctuation of a voltage generated by switching operations of the IGBT 328 which is operated as the upper arm and the IGBT 330 which is operated as the lower arm. Input terminals 508 and 509 of the smoothing capacitor 500 are connected to the high voltage power source device 136 via a DC terminal 138. Further, output terminals 504 and 506 of the smoothing capacitor 500 are connected to a negative-pole DC bus 18M and a positive-pole DC bus 18P respectively, and the series circuits each of which is formed of the upper arm and the lower arm are connected between the positive-pole DC bus 18P and the negative-pole DC bus 18M in parallel respectively.

The control circuit 172 includes a microcomputer for performing arithmetic processing of switching timing of the IGBT 328 which constitutes the upper arm and the IGBT 330 which constitutes the lower arm. A target torque value requested to the motor generator 192 which is a command value from the host control device 42 is transmitted to the microcomputer. Further, a value of an electric current supplied to a stator winding of the motor generator 192 from a series circuit 150 formed of upper and lower arms, and a position of a magnetic pole of a rotor of the motor generator 192 are inputted to the control circuit 172. The current value is based on a detection signal outputted from the current sensor 180. The magnetic pole position is based on a detection signal outputted from a rotating magnetic pole sensor (not shown in the drawing) mounted on the motor generator 192. In this embodiment, although the explanation is made with respect to an example where the current sensor 180 detects respective current values of three phases, current values of two phases may be detected and a current value of a remaining phase may be obtained by an arithmetic operation.

The microcomputer in the control circuit 172 calculates current command values on d and q axes of the motor generator 192 based on inputted target torque values, and calculates voltage command values on the d and q axes based on a differential between the calculated d-and-q-axes current commands and the detected current values on the d and q axes, and generates a pulse-like drive signal from the voltage command value on the d and q axes. The control circuit 172 has a function of generating drive signals of two kinds of methods as described later. The drive signals of two kinds of methods are selected based on a state of the motor generator 192 which is an inductance load, a frequency of an AC output to be converted or the like.

One of two kinds of methods is a modulation method which controls a switching operation of the IGBTs 328, 330 which are semiconductor elements based on a phase of an AC waveform to be outputted (described later as a PHM method), and the modulation method is explained hereinafter. Out of the above-mentioned two kinds of methods, the other method is a modulation method which is generally referred to as PWM (Pulse Width Modulation) method.

The driver circuit 174, in driving the lower arm, amplifies a pulse-like modulated wave signal, and outputs the signal to a gate electrode of the IGBT 330 of the corresponding lower arm as a drive signal. In driving the upper arm, the driver circuit 174 shifts a level of a reference potential of a pulse-like modulated wave signal to a level of a reference potential of the upper arm and, thereafter, amplifies the pulse-like modulated wave signal, and outputs the signal to a gate electrode of the IGBT 328 of the corresponding upper arm as a drive signal. Accordingly, each IGBT 328, 330 performs a switching operation based on the inputted drive signal. In response to a signal control signal from the control circuit 172, the driver circuit 174 applies a drive signal to the respective IGBTs 328 and the respective IGBTs 330, and the respective IGBTs 328, 330 perform a switching operation. Accordingly, the power conversion device 200 converts DC power supplied from the high voltage power source device 136 which is a DC power source into respective output voltages of a U phase, a V phase and a W phase which are shifted from each other for every 2π/3rad in an electrical angle, and supplies the respective output voltages to the motor generator 192 which is a three-phase AC motor. Here, the electrical angle corresponds to a rotational state of the motor generator 192, to be more specific, the position of the rotor, and is cyclically changed between 0 and 2π. Using this electrical angle as a parameter, switching states of the respective IGBTs 328, 330, that is, the respective output voltages of a U phase, a V phase and a W phase can be determined corresponding to a rotational state of the motor generator 192.

Further, the control circuit 172 performs detection of abnormality (overcurrent, overvoltage, overtemperature or the like) thus protecting the series circuit formed of the upper and lower arms. For this end, sensing information is inputted to the control circuit 172. Further, information on voltages on a DC positive pole side of the series circuit formed of the upper and lower arms is inputted in the microcomputer. The microcomputer performs the detection of overtemperature and the detection of overvoltage based on these information. When the overtemperature or the overvoltage is detected, switching operations of all IGBTs 328, 330 are stopped so that it is possible to protect the series circuit formed of the upper and lower arms and the semiconductor module from overtemperature or overvoltage.

Next, using FIG. 8 and FIG. 9, the operational relationship among the host control system 40, the brake control system 60 and the power conversion device 200 described in FIG. 1 is explained assuming one example of a basic state where a vehicle is brought into a traveling state from a parking state which is an operation mode T1 and, again, is brought into an operation mode T8 which is a parking state. When the vehicle is in a parking state in FIG. 8, for reducing power consumption, the high voltage power source device 136, the power conversion device 200, the host control system 40, the cooling system 50 and the brake control system 60 are in a sleep state. Next, when a user manipulates a key switch of the vehicle so that the vehicle is shifted to an operation mode T2, in an operation example of the host control device 42 of the host control system 40 shown in FIG. 9, an operation state is shifted from step 961 to step 962 so that a flag of the operation mode T2 is held, and an operation state is shifted to step 971. Based on a manipulation of the key switch or in response to an instruction from the host control device 42, the high voltage power source device 136, the control circuit 172, the braking control device 62, the air conditioning power conversion device 72 and the cooling power conversion device 52 start their operations respectively. In step 978 which follows step 971, the operation is temporarily finished in a state where the flag of the operation mode T2 is held.

In addition to the execution based on an event which is a change of a state such as a manipulation of the above-mentioned key switch, the flow shown in FIG. 9 is executed after a lapse of every fixed time and, after the lapse of next fixed time, step 961 is executed again. Based on a state flag of the operation mode T2, the execution mode is determined in step 964, and the processing advances to step 972. In step 972, the diagnoses of the respective systems and devices before starting traveling are performed. These diagnoses are respectively started when the operations of the respective systems and devices are started, and when an abnormality is detected, the abnormality is immediately reported. When the abnormality is reported, the processing advances to step 981 from step 972, and abnormality processing is performed from step 981 to step 984. When there is no report on abnormality, the processing advances to step 973, and a normal state flag expressing a normal state is set, and abnormality processing is finished in step 978. In step 978, all flags in next operation modes T3 to T7 are set, and the processing expressing that a vehicle is capable of traveling or the vehicle is traveling is performed and step 978 is finished. At this point of time, flags showing the operation modes T1 to T2 and the operation mode T8 are in a reset state.

After a lapse of fixed time, step 961 is executed again, and an operation start (starting preparation) state in the operation mode T3 is determined based on flags expressing the operation modes T3 to T7 and a traveling state of a vehicle, and the processing advances to step 974 from step 965. The brake control system 60 is brought into an operation state where a braking force is generated in accordance with a step-in amount of the brake pedal 61 which is a detection value of the brake manipulation variable detection device 64 from a parking brake state. In step 974, as shown in FIG. 6, the host control device 42 transmits an instruction of generating a braking force to the braking control device 62 described in FIG. 5 in accordance with a manipulation variable of the brake pedal 61 detected by the brake manipulation variable detection device 64, and the braking control device 62, in accordance with such an instruction, generates AC power to be added to the braking motor 63 which is a magnet-type rotary synchronous motor by a PWM method or a chopper control method based on a detection result of the brake manipulation variable detection device 64. The braking motor 63 generates a rotational torque by the supplied AC power, and pushes a piston of the master cylinder 65 thus generating an oil pressure.

The oil pressure which the master cylinder 65 generates is an oil pressure used for generating a braking force, and is supplied to calipers mounted on respective wheels of a vehicle from an oil pressure regulating valve 68 so that a braking force corresponding to the oil pressure is generated in the respective wheels. When the regeneration braking is performed, a remaining braking force which is obtained by subtracting a braking force generated by regeneration braking from a braking force based on a manipulation variable of the brake pedal 61 which is detected by the brake manipulation variable detection device 64 is instructed to the braking control device 62 from the host control device 42. The state of the operation mode T3 is a state where the regeneration braking is not performed and hence, the whole braking force based on a manipulation variable of the brake pedal 61 which is detected by the brake manipulation variable detection device 64 is generated based on a rotational torque of the braking motor 63. The oil pressure regulating valve 68 not only distributes an oil pressure which the master cylinder 65 generates to the caliper of each wheel but also finely adjusts the oil pressure supplied to the caliper of each wheel. Accordingly, the oil pressure regulating valve 68 performs a skid control, the adjustment of a braking force in a traveling state at a curve or the like. After step 974, step 978 is executed and the processing is finished. In step 978, the operation modes T3 to T7 are held in a set state, and unless there is no change in an operation manipulation in when the processing in step 961 is executed after a lapse of a fixed time, a mode where the processing advances from step 961 to step 965, advances to step 974, and subsequently advances to step 978 is repeated.

In the operation of the braking motor 63 of the brake control system 60, it is necessary to apply a force to the piston of the master cylinder 65 in a state where a rotational speed is extremely low or a rotation stop state and hence, it is preferable to generate an AC output by a PWM method than to generate an AC output by a PHM method explained hereinafter.

When the acceleration pedal is stepped-in in a vehicle stop state, the processing advances to step 966 in the operation mode T4 corresponding to an acceleration state mode at the time of starting from step 961, and the processing in step 975 is executed. At this point of time, the brake pedal 61 is not stepped-in and hence, the brake manipulation variable detection device 64 outputs a non manipulation state so that the braking control device 62 applies AC power for generating the reverse rotation to the braking motor 63 whereby the piston of the master cylinder 65 is moved reversely thus setting an oil pressure which the master cylinder 65 outputs to 0. AC power for reversely rotating the braking motor 63 is generated by the braking control device 62 using a PWM method.

Simultaneously, in the operation mode T4, in step 975, a torque command is sent to the control circuit 172 from the host control device 42. Since the vehicle starts an operation from a vehicle stop state, as explained in conjunction with FIG. 10 hereinafter, the control circuit 172 generates a control signal for generating AC power by a chopper control or a PWM control, and supplies the control signal to the driver circuit 174. The driver circuit 174 controls a switching operation of the upper arm and the lower arm of the inverter circuit 140. In this embodiment, the driver circuit 174 controls a switching operation of the IGBT 328 and the IGBT 330, generates AC power and supplies the AC power to the motor generator 192 thus generating a rotational torque of the motor generator 192. A vehicle starts or is accelerated based on the rotational torque.

When a rotational speed of the motor generator 192 is increased, in step 975, a control based on an operation mode T5 is performed in place of the operation mode T4. The control circuit 172 transmits a control signal for performing a control using a PHM method explained hereinafter to the driver circuit 174, and the inverter circuit 140 generates an AC output by the PHM method, and supplies the AC output to the motor generator 192. In the operation mode T4 and the operation mode T5, the motor generator 192 is controlled as a motor. For example, the control circuit 172 generates a control signal such that AC power having a lead phase with respect to a magnetic pole position of the rotor of the motor generator 192 is generated, and AC power having a lead phase with respect to a magnetic pole position of the rotor of the motor generator 192 is supplied from the inverter circuit 140. Due to such a control, the vehicle is further accelerated. After the processing in step 975 is executed, the processing in step 978 is executed, and a flag expressing an operation state is held as it is or in a state where the flag indicates an operation mode T5. Since the inverter circuit 140 generates AC output by a PHM method, the number of times of switching per unit time is largely decreased compared to a PWM method so that a heat value is reduced. That is, wasteful power consumption can be reduced.

Next, to consider a case where a manipulation of the acceleration pedal 44 is finished so that a state where neither an acceleration operation nor a brake operation is performed takes place, when a vehicle is traveling in a state where a vehicle speed is high, the deceleration operation takes place. In this case, the processing advances to step 975 from a state of step 961, and the acceleration pedal 44 is not stepped in and hence, a torque command of the motor generator 192 to the control circuit 172 from the host control device 42 takes a value which is gradually decreased. That is, when the vehicle travels in a state where a vehicle speed is larger than a low speed reference region, the motor generator 192 is operated such that a rotational torque is gradually decreased. When the vehicle travels in a state where a vehicle speed is in the low speed reference region, the generation torque of the motor generator 192 is held so that the vehicle continues the slow traveling. Due to such a control, the motor generator 192 can cope with slow driving at the time of traffic jam or the like.

When the brake pedal 61 is stepped-in with the motor generator 192 in a high speed operation state, the processing advances from step 961 to step 967 where when it is determined that the processing is in an operation mode T6, and the processing advances to step 976. In step 976, the host control device 42 transmits a braking force of regeneration braking to the control circuit 172 as an instruction value, and a command “braking force zero” is sent to the braking control device 62. This means that all braking force based on the brake pedal 61 is generated by the regeneration braking. Although the generation of all braking force based on the brake pedal 61 by the regeneration braking exhibits the highest energy efficiency, depending on an operation state of the motor generator 192, there arises a state where it is difficult to generate all braking force based on the brake pedal 61 by regeneration braking. In such a case, a required braking force is generated by the combination of a braking force generated by the regenerating operation of the motor generator 192 and a frictional braking force generated by a caliper. As described above, a braking force obtained by subtracting a braking force generated by the regeneration braking from the required braking force based on the brake pedal 61 is instructed to the braking control device 62 by the host control device 42, and the braking force generated by the regeneration braking is instructed to the control circuit 172 by the host control device 42.

The control circuit 172 performs the regeneration operation for charging the high voltage power source device 136 in such a manner that the control circuit 172 transmits a control signal for generating a braking force generated by the regeneration braking to the driver circuit 174 thus controlling the inverter circuit 140 such that the inverter circuit 140 converts AC power generated by the motor generator 192 into a direct current. When the control circuit 172 controls the inverter circuit 140 such that, for example, AC power which generates a rotary magnetic field having an inverted phase with respect to a magnetic pole position of the rotor of the motor generator 192 is generated, a three-phase induction voltage which the motor generator 192 generates is converted into DC power by the inverter circuit 140 and the high voltage power source device 136 is charged with the DC power. In this case, the mechanical energy which rotates the motor generator 192 is supplied to the inverter circuit 140 as the three-phase induction voltage, the three-phase induction voltage is converted into DC electric energy, and the high voltage power source device 136 is charged with the DC electric energy. Accordingly, a rotational torque which is applied to the motor generator 192 from the outside as mechanical energy is consumed for charging the high voltage power source device 136 so that a braking force is generated. By controlling a power conversion quantity of the three-phase induction voltage which the motor generator 192 generates, a braking force generated by the regenerating operation is controlled. By controlling the inverter circuit 140 such that AC power which generates a rotary magnetic field having an inverted phase is generated, the motor generator 192 is operated as a generator. By performing a control of regeneration braking by the PHM method explained hereinafter, the number of times of switching the inverter circuit 140 per unit time can be decreased thus realizing regeneration braking with excellent energy efficiency. In a switching operation of arms of the inverter circuit 140 by the PHM method explained hereinafter, a braking force is increased when a conduction width is widened, while a braking force is decreased when the conduction width is narrowed to the contrary. In other words, a braking force is increased when a modulation index is increased, and a braking force is decreased when the modulation index is decreased to the contrary. After the processing in step 976 is executed, the processing in step 978 is finished.

When a traveling speed of a vehicle is lowered by the regeneration braking, an induction voltage of the motor generator 192 is decreased so that a braking force generated by the regeneration braking is decreased whereby it becomes difficult to generate a braking force required by a braking force generated by a regenerating operation of the motor generator 192. In such a case, a frictional braking force generated by the brake control system 60 or both the frictional braking force and a braking force generated by the regeneration braking are used. When a vehicle speed is further decreased, the generation of a braking force by the regeneration braking becomes difficult so that all required braking force is acquired by making use of a frictional braking force. This state is an operation mode T7 where a command value of a braking force generated by the motor generator 192 becomes zero so that the operation of the motor generator 192 is stopped. When the brake pedal 61 is manipulated so that the motor generator 192 assumes an operation mode T3 where a vehicle takes a stop state, the processing in step 974 is executed again, while when the acceleration pedal 44 is stepped in, the motor generator 192 assumes an operation mode T4 and the processing in step 975 is executed again.

On the other hand, when a vehicle assumes a parking state from a stop state due to the manipulation of the key switch 46 or the manipulation of a parking brake not shown in the drawing, the brake control system 60 takes an operation in a parking brake state, and the host control system 40 executes the processing in step 977 from the processing in step 961 via the processing in step 968. In step 977, the host control device 42 transmits an operation finish command to the respective systems and devices so that these systems and devices assume a sleep state by finishing operations thereof. The cooling system 50, the steering system 80, the brake control system 60 and the air conditioning system 70 stop operations thereof respectively, and assume a sleep state after such finishing processing. By executing the processing in step 978 after step 977, the host control system 40 also assumes a sleep state.

In the case where an abnormal state is detected during an operation, for example, when an abnormality signal is transmitted from a diagnosis circuit which the high voltage power source device 136 has, in step 963, the host control system 40 is operated so as to take processing for abnormality with priority, a normality flag is reset in step 981, a search command for a cause of abnormality is transmitted in step 982, and to reduce a load of the high voltage power source device 136 for the time being, in step 983, a control for widening a three-phase short-circuiting width of the motor generator 192 is performed in the control of the PHM method explained hereinafter. Further, in step 983, when it is determined that the abnormality is the abnormality which leads to a serious accident from a result of search for a cause of abnormality instructed in step 982, a control for further extending a three-phase short-circuiting period of the motor generator 192 by the PHM method explained hereinafter is performed so that a relay not shown in the drawing which connects the high voltage power source device 136 and the smoothing capacitor 500 of the power conversion device 200 is opened during this 3-phase short-circuiting period whereby the high voltage power source device 136 is cut off. In this case, an alarm which informs the occurrence of an abnormal state is outputted in step 984 thus informing a user of the abnormality. In this manner, by reducing the load of the high voltage power source device 136 by widening the width of the three-phase short-circuiting of the motor generator 192, the abnormality disappears within an extremely short period in many cases. Accordingly, the stability of the control system is maintained.

Switching of a control method performed by the power conversion device 200 is explained in conjunction with FIG. 10. The power conversion device 200 uses the PWM control method and the PHM control method described later in a switching manner corresponding to a rotational speed of the motor, that is, the motor generator 192. FIG. 10 shows the manner of switching a control mode in the power conversion device 200. A rotational speed at which a control mode is switched can be desirably changed. It is necessary for the motor generator 192 to generate a large torque in a stop state when the vehicle starts traveling from the stop state. Further, to impart gorgeous feeling to a vehicle, it is desirable that the vehicle exhibits smooth starting and acceleration. On the other hand, in a rotation stop time state, a PWM control or a chopper control is performed corresponding to a required torque thus controlling an alternating current to be supplied to a stator of a rotor. The control is shifted to a PWM control as a rotational speed of the motor generator 192 is increased.

To realize smooth acceleration at the time of starting a vehicle and at the time of accelerating the vehicle, it is desirable to decrease the distortion of AC output, for example, AC power to be supplied to the motor generator 192 so that a switching operation of the semiconductor element which the inverter circuit 140 includes is controlled by a PWM control method. A PHM control explained hereinafter has a drawback in controllability when a rotational speed of the motor generator 192 is in an extremely low speed state including a stop state and, further, has a tendency that the distortion of an AC output waveform, for example, an AC current waveform is increased. Accordingly, by combining the control by the PHM control method with a control by a PWM control method, or by further adding a chopper control to these controls, such a defect can be compensated.

In a low-speed operation state of the motor generator 192, a quantity of AC current which can be supplied is limited and hence, a control which suppresses a maximum generation torque is performed. There is a tendency that an internal induction voltage is increased along with the increase of a rotational speed of the motor generator 192 so that a supply quantity of electric current is decreased. Accordingly, there is a tendency that an output torque of the motor generator 192 is lowered along with the increase of a rotational speed. Recently, there is a tendency that a maximum rotational speed which a motor generator is required to satisfy is increased, and there may be a case where a speed exceeding 15,000 rpm per minute is required. The PHM control is effective in a high speed operation.

Although a rotational speed of the motor generator at which a control by a PWM method and a PHM control is switched is not particularly limited, it is considered preferable to perform a control by the PWM method in a state where the rotational speed is equal to or less than 700 rpm, for example, and a control is performed by the PHM control at a rotational speed higher than 700 rpm. A range from 1500 rpm to 5000 rpm is an operation range most suitable for a control by the PHM method. In this region, the control by the PHM method exhibits a large switching loss reduction effect of a semiconductor element compared to the control by the PWM method. This operation region is an operation region which is often used in town traveling and hence, the control by the PHM method exhibits a large effect in the operation region closely connected with our daily life.

In this embodiment, a mode where a control is performed by a PWM control method (hereinafter referred to as a PWM control mode) is used in a region where a rotational speed of the motor generator 192 is relatively low, while the PHM control mode described later is used in a region where the rotational speed is relatively high. In the PWM control mode, the power conversion device 200 performs a control using a PWM signal such as the signal described previously. That is, using the microcomputer in the control circuit 172, voltage command values on d, q axes of the motor generator 192 are calculated based on an inputted target torque value, and these voltage command values are converted into voltage command values of a U phase, a V phase and a W phase. Then, a sinusoidal waves corresponding to voltage command values of respective phases are set as fundamental waves, and these fundamental waves are compared with a triangular wave having a predetermined cycle which is a carrier wave, and pulse-like modulated waves having pulse widths decided based on a comparison result are outputted to the driver circuit 174. By outputting drive signals corresponding to these modulated waves to the IGBTs 328, 330 which respectively correspond to upper and lower arms of respective phases from the driver circuit 174, a DC voltage outputted from the high voltage power source device 136 is converted into a three-phase AC voltage and the three-phase AC voltage is supplied to the motor generator 192.

The content of the PHM is explained in detail later. The modulated waves generated by the control circuit 172 in the PHM control mode are outputted to the driver circuit 174. Accordingly, drive signals corresponding to the modulated waves are outputted to the IGBTs 328, 330 corresponding to the respective phases from the driver circuit 174. As a result, a DC voltage outputted from the high voltage power source device 136 is converted into a three-phase AC voltage, and the three-phase AC voltage is supplied to the motor generator 192. In converting DC power into AC power using a semiconductor element as in the case of the power conversion device 200, by decreasing the number of times of switching per unit time or per a predetermined phase of an AC output, a switching loss can be reduced. On the other hand, there is a tendency that AC power to be converted includes large amount of harmonic components and hence, the torque pulsation is increased thus giving rise to a possibility that the responsiveness of a motor control is deteriorated. According to the present invention, by switching the PWM control mode and the PHM control mode as described above corresponding to a frequency of an AC output to be converted or a rotational speed of the motor related to the frequency, a PHM control method is adopted in a motor rotation region where the operation is hardly influenced by low-order harmonics, that is, in a high speed rotation region, while the PWM control method is adopted in a low-speed rotation region where the torque pulsation is liable to occur. By performing such switching, the increase of the torque pulsation can be suppressed at a relatively low level thus reducing a switching loss. As a control state of the motor which minimizes the number of times of switching, a control state using a rectangular wave where a semiconductor element of each phase is turned on or off one time for every 1 rotation of the motor can be named. In the above-mentioned PHM control method, this control state using the rectangular wave can be grasped as one control mode of the PHM control method which is a final mode that the number of times of switching per a half cycle which is reduced along with the increase of a modulation index in an AC output waveform to be converted takes. This point is further explained in detail later.

Next, for explaining the PHM control method, firstly, the PWM control and the rectangular wave control are explained in conjunction with FIG. 11. The PWM control is a method where based on the comparison of magnitude between a carrier wave of a fixed frequency and an AC waveform to be outputted, timing of conduction or interruption of a semiconductor element is determined thus controlling the semiconductor element. With the use of the PWM control, AC power with small pulsation can be supplied to a motor thus realizing a motor control with small torque pulsation. On the other hand, the PWM control has a drawback that the number of times of switching per unit time or per a cycle of an AC waveform is large and hence, a switching loss is large. To cope with such a drawback, as an extreme example, in the case of a control of a semiconductor element using a rectangular wave of 1 pulse, the number of times of switching is small and hence, a switching loss can be made small. On the other hand, an AC waveform to be converted becomes a rectangular wave shape when the influence of an inductance load is ignored so that the AC waveform is considered to be in a state where a fifth-order harmonic component, a seventh-order harmonic component, an eleventh-order harmonic component, . . . are included in a sinusoidal wave. To analyze a rectangular wave by Fourier expansion, harmonic components such as a fifth-order harmonic component, a seventh-order harmonic component, an eleventh-order harmonic component, . . . appear in addition to the basic sinusoidal wave. These harmonic components generate the current distortion which becomes a cause of torque pulsation. In this manner, the PWM control and the rectangular wave control have the relation where these controls take two opposite extremes.

Assuming that the conduction and the interruption of a semiconductor element is controlled in a rectangular wave shape, an example of harmonic components generated in an AC output is shown in FIG. 12. FIG. 12(a) shows an example where an AC waveform which changes in a rectangular wave shape is decomposed into a sinusoidal wave which is a fundamental wave and harmonic components such as a fifth-order harmonic component, a seventh-order harmonic component, an eleventh-order harmonic component, . . . . The Fourier series expansion of the rectangular wave shown in FIG. 12(a) is expressed by a formula (1).

f(ωt)=4/π×{sin ωt+(sin 3ωt)/3+(sin 5ωt)/5+(sin 7ωt)/7+ . . . } (1)

The formula (1) expresses that the rectangular wave shown in FIG. 12(a) is formed of the sinusoidal wave which is the fundamental wave expressed by 4/π·(sin ωt) and the respective components consisting of a third-order harmonic component, a fifth-order harmonic component, a seventh-order harmonic component and the like which are harmonic components of the sinusoidal wave. In this manner, it is understood that by synthesizing harmonics of higher orders to the fundamental wave, the synthesized wave approximates the rectangular wave.

FIG. 12(b) shows the manner where respective amplitudes of the fundamental wave, the third-order harmonic and the fifth-order harmonic are compared to each other. Assuming the amplitude of the rectangular wave shown in FIG. 12(a) as 1, the amplitude of the fundamental wave is expressed as 1.27, the amplitude of the third-order harmonic is expressed as 0.42, and the amplitude of the fifth-order harmonic is expressed as 0.25. In this manner, the higher the order of the harmonic, the smaller the amplitude of the harmonic becomes and hence, it is understood that the higher the order of the harmonic, the smaller the influence that the harmonic exerts on the rectangular wave control becomes.

From a viewpoint of a possibility that the torque pulsation is generated when the conduction or the interruption of a semiconductor element is performed in a rectangular waveform, while removing high-order harmonic components which largely influence the rectangular wave control, the high-order harmonic components which exert small influence on the rectangular wave control are included by ignoring the influence, it is possible to realize a power converter which has a little switching loss, and also can suppress the increase of the torque pulsation at a low level. In the PHM control used in this embodiment, an AC output where harmonic components which a rectangular wave AC current has are reduced to some extent corresponding to a state of the control is outputted. Accordingly, the influence of torque pulsation on the motor control can be made small, and the rectangular wave includes harmonic components within a range where there is no problem in use so that a switching loss is reduced. Such a control method is, as described above, referred to as the PHM method or the PHM control method in this specification.

Further, in the embodiment described hereinafter, a PWM control method is used in a state where the influence of harmonics is large or AC output of low frequency which deteriorates controllability is outputted in a PHM control method. To be more specific, the PWM control and the PHM control are switched corresponding to a rotational speed of a motor such that the motor control is performed using the PWM method in a region where a rotational speed is low whereby a desired motor control is performed in the low speed rotation region and the high speed rotation region respectively.

Subsequently, the constitution of the control circuit 172 for realizing the above-mentioned control is explained. As a control method of the control circuit 172 mounted on the power conversion device 200, three kinds of motor control methods are explained and, hereinafter, these three kinds of motor control methods are described as first, second and third embodiments.

### First Embodiment

A control system of the motor generator using the control circuit 172 according to the first embodiment of the present invention is shown in FIG. 13. A torque command T* is inputted to the control circuit 172 from the host control device 42 of an upper order as a target torque value. A torque command/current command converter 410 obtains a d axis current command signal Id* and a q axis current command signal Iq* based on the inputted torque command T* and rotational speed information based on a magnetic pole position signal θ detected by the rotating magnetic pole sensor 193 using prestored data on a torque-rotational speed map. The d axis current command signal Id* and the q axis current command signal Iq* obtained by the torque command/current command converter 410 are outputted to current controllers (ACR) 420, 421 respectively. The current controllers (ACR) 420, 421 calculate a d axis voltage command signal Vd* and a q axis voltage command signal Vq* respectively such that currents which flow in the motor generator 192 follow the d axis current command signal Id* and the q axis current command signal Iq* based on the d axis current command signal Id* and the q axis current command signal Iq* outputted from the torque command/current command converter 410, and Id, Iq current signals which are obtained by converting phase current detection signals Iu, Iv, Iw of the motor generator 192 detected by the current sensor 180 on the d, q axes based on magnetic pole position signals from a rotation sensor in a three-phase two-phase converter not shown in the drawing in the control circuit 172. The d axis voltage command signal Vd* and the q axis voltage command signal Vq* obtained by the current controller (ACR) 420 are outputted to a pulse modulator 430 for PHM control. On the other hand, the d axis voltage command signal Vd* and the q axis voltage command signal Vq* obtained by the current controller (ACR) 421 are outputted to a pulse modulator 440 for PWM control.

The pulse modulator 430 for PHM control is constituted of a voltage phase difference calculator 431, a modulation index calculator 432 and a pulse generator 434. The d axis voltage command signal Vd* and the q axis voltage command signal Vq* outputted from the current controller 420 are inputted, to the voltage phase difference calculator 431 and the modulation index calculator 432 in the pulse modulator 430.

The voltage phase difference calculator 431 calculates the phase difference between a magnetic pole position of the motor generator 192 and a voltage phase which is expressed by the d axis voltage command signal Vd* and the q axis voltage command signal Vq*, that is, the voltage phase difference. Assuming the voltage phase difference as 8, the voltage phase difference δ is expressed by a following formula (2).

δ=arctan(−Vd*/Vq*) (2)

The voltage phase difference calculator 431 calculates a voltage phase by further adding a magnetic pole position expressed by a magnetic pole position signal θ from the rotating magnetic pole sensor 193 to the above-mentioned voltage phase difference δ. Then, the voltage phase difference calculator 431 outputs a voltage phase signal θv which corresponds to the calculated voltage phase to the pulse generator 434. Assuming a magnetic pole position expressed by the magnetic pole position signal θ as θe, the voltage phase signal θv is expressed by a following formula (3).

θv=δ+θe+π (3)

The modulation index calculator 432 calculates a modulation index by normalizing magnitudes of vectors expressed by the d axis voltage command signal Vd* and the q axis voltage command signal Vq* with a voltage of the high voltage power source device 136, and outputs a modulation index signal a which corresponds to the modulation index to the pulse generator 434. In this embodiment, the above-mentioned modulation index signal a is determined based on a voltage of the high voltage power source device 136 which is a DC voltage supplied to the inverter circuit 140 shown in FIG. 7, and there is a tendency that the higher the voltage, the smaller the modulation index a becomes. Further, there is a tendency that the larger an amplitude value of a command value, the larger the modulation index a becomes. To be more specific, assuming a battery voltage as V_{dc}, the modulation index a is expressed by a formula (4). In the formula (4), Vd indicates an amplitude value of the d axis voltage command signal Vd*, and Vq indicates an amplitude value of the q axis voltage command signal Vq* respectively.

a=(√(Vd²+Vq²))/V_{dc} (4)

The pulse generator 434 generates six kinds of pulse signals based on a PHM control which respectively correspond to the respective upper and lower arms of a U phase, a V phase and a W phase based on a voltage phase signal θv from the voltage phase difference calculator 431 and a modulation index signal a from the modulation index calculator 432. Then, the generated pulse signals are outputted to a switcher 450, and the pulse signals are outputted to the driver circuit 174 from the switcher 450, and drive signals are outputted to the respective semiconductor elements. A method of generating pulse signals based on a PHM control (hereinafter referred to as PHM pulse signals) is explained in detail later. On the other hand, the pulse modulator 440 for a PWM control, based on a d axis voltage command signal Vd* and a q axis voltage command signal Vq* outputted from the current controller 421 and a magnetic pole position signal θ outputted from the rotating magnetic pole sensor 193, generates six kinds of pulse signals based on a PWM control (hereinafter referred to as PWM pulse signals) which respectively correspond to the respective upper and lower arms of a U phase, a V phase and a W phase by a well-known PWM method. Then, the generated PWM pulse signals are outputted to the switcher 450, the PWM pulse signals are supplied to the driver circuit 174 from the switcher 450, and drive signals are supplied to the respective semiconductor elements from the driver circuit 174.

The switcher 450 selects either one of PHM pulse signals outputted from the pulse modulator 430 for a PHM control or PWM pulse signals outputted from the pulse modulator 440 for a PWM control. The selection of the pulse signals by the switcher 450 is performed in response to a rotational speed of the motor generator 192 as described previously. That is, when the rotational speed of the motor generator 192 is lower than a predetermined threshold value set as a switching line, a PWM control method is adopted by the power conversion device 200 by selecting the PWM pulse signals. On the other hand, when the rotational speed of the motor generator 192 is higher than the threshold value, the PHM control method is adopted in the power conversion device 200 by selecting the PHM pulse signals. The PHM pulse signals or the PWM pulse signals selected by the switcher 450 in this manner are outputted to the driver circuit 174 (not shown in the drawing).

In the manner as explained above, the PHM pulse signals or the PWM pulse signals are outputted to the driver circuit 174 from the control circuit 172 as modulated waves. In response to these modulated waves, drive signals are outputted to the respective IGBTs 328, 330 of the inverter circuit 140 from the driver circuit 174. Here, the detail of the pulse generator 434 shown in FIG. 13 is explained. The pulse generator 434 is, for example, as shown in FIG. 14, realized by a phase retriever 435 and a timer counter comparator 436. The phase retriever 435 retrieves phases at which switching pulses are to be outputted with respect to the respective upper and lower arms of a U phase, a V phase and a W phase from a table of prestored phase information of switching pulses based on rotational speed information obtained based on a voltage phase signal θv outputted from the voltage phase difference calculator 431, a modulation index signal a outputted from the modulation index calculator 432 and a magnetic pole position signal θ, and outputs information on a retrieval result to the timer counter comparator 436. The timer counter comparator 436, based on the retrieval result outputted from the phase retriever 435, generates respective PHM pulse signals as switching commands for the respective upper and lower arms of a U phase, a V phase and a W phase. Six kinds of PHM pulse signals for the respective upper and lower arms of the respective phases generated by the timer counter comparator 436 are outputted to the switcher 450 as described previously.

FIG. 15 shows a flowchart which explains steps of generating pulses by the phase retriever 435 and the timer counter comparator 436 shown in FIG. 14 in detail. The phase retriever 435 fetches a modulation index signal a as an input signal in step 801, and fetches a voltage phase signal θv as an input signal in step 802. In succeeding step 803, the phase retriever 435 calculates a range of a voltage phase corresponding to a next control cycle based on the inputted present voltage phase signal θv by taking a control delay time and a rotational speed into consideration. Thereafter, in step 804, the phase retriever 435 performs a ROM retrieval. In this ROM retrieval, the phase retriever 435 retrieves an ON phase and an OFF phase of switching using a table prestored in a ROM (not shown in the drawing) within a range of the voltage phase calculated in step 803 based on the inputted modulation index signal a.

The phase retriever 435 outputs information on the ON phase and the OFF phase of switching obtained by the ROM retrieval in step 804 to the timer counter comparator 436 in step 805. The timer counter comparator 436 converts this phase information into time information in step 806, and generates a PHM pulse signal using a compare match function with a timer counter. A process for converting the phase information into the time information may be performed by making use of information on a rotational speed signal. Alternatively, a PHM pulse may be generated from the information on the ON phase and the OFF phase of switching obtained by the ROM retrieval in step 804 using a compare match function with a phase counter in step 806.

The timer counter comparator 436 outputs a PHM pulse signal generated in step 806 to the switcher 450 in next step 807. By performing the processing in steps 801 to 807 explained above in the phase retriever 435 and the timer counter comparator 436, a PHM pulse signal is generated by the pulse generator 434.

Alternatively, in place of the flowchart shown in FIG. 15, a pulse may be generated by executing the processing shown in a flowchart in FIG. 16 in the pulse generator 434. This processing is a method where a switching phase is generated for every control cycle of the current controller (ACR) without using a table retrieval method where a switching phase is retrieved using a prestored table as shown in the flowchart in FIG. 15.

A modulation index signal a is inputted to the pulse generator 434 in step 801, and a voltage phase signal θv is inputted to the pulse generator 434 in step 802. In succeeding step 820, the pulse generator 434, based on the inputted modulation index signal a and the inputted voltage phase signal θv, decides an ON phase and an OFF phase of switching for every control cycle of the current controller (ACR) while taking a control delay time and a rotational speed into consideration. A flowchart in FIG. 17 shows the detail of processing of deciding switching phase in step 820. The pulse generator 434 designates the orders of harmonics to be removed based on a rotational speed in step 821. In accordance with the orders of the harmonics designated in this manner, the pulse generator 434 executes the processing such as the matrix calculation in succeeding step 822, and outputs a pulse reference angle in step 823.

The processing for generating the pulse ranging from steps 821 to 823 is calculated in accordance with determinants expressed by following formulae (5) to (8). Here, a case where a third-order harmonic component, a fifth-order harmonic component and a seventh-order harmonic component are removed is taken as an example. When the pulse generator 434 designates the third-order harmonic component, the fifth-order harmonic component and the seventh-order harmonic component as the orders of harmonics to be removed in step 821, the matrix calculation is performed in next step 822. Here, a row vector expressed by the formula (5) is formed with respect to the orders to be removed consisting of the third-order, the fifth-order and the seventh-order.

[Math 1]

[x₁ x₂ x₃]=π/2[k₁/3 k₂/5 k₃/7] (5)

Respective elements in a parenthesized right term of the formula (5) are k₁/3, k₂/5 and k₃/7. Desired odd number can be selected as k₁, k₂ and k₃. However, 3, 9, 15 and the like cannot be selected as k₁, 5, 15, 25 and the like cannot be selected as k₂, and 7, 21, 35 and the like cannot be selected as k₃. Under such a condition, the third-order harmonic component, the fifth-order harmonic component and the seventh-order harmonic component are completely removed. To express the above in the more general form, by setting a value of a denominator as the order of a harmonic to be removed and by setting a value of a numerator to an arbitrary odd number excluding a number which is odd times as large as the denominator, values of the respective elements in the formula 5 can be decided. Here, in the example expressed by the formula (5), the orders to be removed are three kinds (third-order, fifth-order, seventh-order) and hence, the number of elements in the row vector is set to three. In the same manner, the values of the respective elements can be decided by setting a row vector of the number of elements N with respect to N kinds of orders to be removed. In the formula (5), by setting the values of the denominators and the numerators of the respective elements to values other than the above-mentioned values, spectrums of harmonic components can be reshaped in place of the removal of the harmonic components. For this end, the values of the numerators and the denominators of the respective elements may be arbitrarily selected by mainly aiming at the reshaping of spectrums of harmonic elements without removing the harmonic components. In this case, it is not always necessary to set the values of the numerators and denominators to the integers, the numerator is prohibited from selecting a value which is odd times as large as the denominator. Further, it is not necessary to set the values of the numerator and the denominator to fixed numbers, and the values of the numerator and the denominator may be values which change with time.

When the number of elements whose values are decided by the combination of the denominator and the numerator is three, vectors of three rows can be set as expressed in the formula (5). In the same manner, it is possible to set a vector having the number of elements N whose values are decided by the combination of the denominators and the numerators, that is, the vector of N rows. Hereinafter, the vector of N rows is referred to as a harmonic conforming phase vector.

When the harmonic conforming phase vector is the vector of three rows as expressed by the formula (5), the calculation expressed by a formula (6) is performed by replacing the harmonic conforming phase vector. As a result, pulse reference angles ranging from S₁ to S₄ are obtained. The pulse reference angles S₁ to S₄ are parameters which express center positions of voltage pulses, and are compared with a triangular wave carrier described later. When the number of pulse reference angles is 4 (S₁ to S₄), in general, the number of pulses per 1 cycle of a line voltage becomes 16.

$$\begin{matrix}[ Math . 2 ] & \\ [ \begin{matrix}{s}_{1} \\ {s}_{2} \\ {s}_{3} \\ {s}_{4}\end{matrix} ] = \{ 2 [ \begin{matrix}1 & 0 & 0 \\ 1 & 0 & 1 \\ 1 & 1 & 0 \\ 1 & 1 & 1\end{matrix} ] - [ \begin{matrix}1 & 1 & 1 \\ 1 & 1 & 1 \\ 1 & 1 & 1 \\ 1 & 1 & 1\end{matrix} ] \} [ \begin{matrix}{x}_{1} \\ {x}_{2} \\ {x}_{3}\end{matrix} ] & ( 6 )\end{matrix}$$

Further, when the harmonic conforming phase vector is a vector of four rows as expressed by the formula (7) in place of the formula (5), a following matrix arithmetic expression (8) is applied.

$$\begin{matrix}[ Math . 3 ] & \\ [ \begin{matrix}{x}_{1} & {x}_{2} & {x}_{3} & {x}_{4}\end{matrix} ] = π / 2 [ \begin{matrix}{k}_{1} / 3 & {k}_{2} / 5 & {k}_{3} / 7 & {k}_{4} / 11\end{matrix} ] & ( 7 ) \\ [ Math . 4 ] & \\ [ \begin{matrix}{s}_{1} \\ {s}_{2} \\ {s}_{3} \\ {s}_{4} \\ {s}_{5} \\ {s}_{6} \\ {s}_{7} \\ {s}_{8}\end{matrix} ] = \{ 2 [ \begin{matrix}1 & 0 & 0 & 0 \\ 1 & 0 & 0 & 1 \\ 1 & 0 & 1 & 0 \\ 1 & 0 & 1 & 1 \\ 1 & 1 & 0 & 0 \\ 1 & 1 & 0 & 1 \\ 1 & 1 & 1 & 0 \\ 1 & 1 & 1 & 1\end{matrix} ] - [ \begin{matrix}1 & 1 & 1 & 1 \\ 1 & 1 & 1 & 1 \\ 1 & 1 & 1 & 1 \\ 1 & 1 & 1 & 1 \\ 1 & 1 & 1 & 1 \\ 1 & 1 & 1 & 1 \\ 1 & 1 & 1 & 1 \\ 1 & 1 & 1 & 1\end{matrix} ] \} [ \begin{matrix}{x}_{1} \\ {x}_{2} \\ {x}_{3} \\ {x}_{4}\end{matrix} ] . & ( 8 )\end{matrix}$$

As a result, pulse reference angle outputs ranging from S₁ to S₈ are obtained. Here, the number of pulses per one cycle of a line voltage becomes 32.

The relationship between the number of harmonic components to be removed and the number of pulses is as follows in general. That is, when the number of harmonic components to be removed is 2, the number of pulses per one cycle of a line voltage is 8 pulses. When the number of harmonic components to be removed is 3, the number of pulses per one cycle of a line voltage is 16 pulses. When the number of harmonic components to be removed is 4, the number of pulses per one cycle of a line voltage is 32 pulses. When the number of harmonic components to be removed is 5, the number of pulses per one cycle of a line voltage is 64 pulses. In the same manner, each time the number of harmonic components to be removed is increased by one, the number of pulses per one cycle of a line voltage is increased twice. However, when pulses are arranged such that a positive pulse and a negative pulse superpose each other on a line voltage, the number of pulses may differ from the number of pulses in the above-mentioned cases.

Pulse waveforms are formed with respect to three kinds of line voltages consisting of a UV line voltage, a VW line voltage and a WU line voltage respectively due to PHM pulse signals generated by the pulse generator 434 as described above. The pulse waveforms of these respective line voltages are the same pulse waveform having the phase difference of 2π/3 respectively. Accordingly, only the UV line voltage is explained hereinafter as a representative for the respective line voltages. Here, the relationship expressed by the formula (9) exists among a reference phase θᵤᵥ₁, a voltage phase signal θv, and a magnetic pole position θe of the UV line voltage.

θᵤᵥ₁=θv+π/6=θe+δ+7π/6 [rad] (9)

The waveform of the UV line voltage expressed by the formula (9) is in line symmetry with respect to a position of θᵤᵥ₁=π/2, 3π/2, and is in point symmetry with respect to a position of θᵤᵥ₁=0, π. Accordingly, the waveform of the UV line voltage pulse in one cycle (θᵤᵥ₁: 0 to 2π) can be expressed by arranging the pulse waveform between 0 to π/2 of θᵤᵥ₁ for every π/2 in left and right symmetry or in up and down symmetry by using the pulse waveform between 0 to π/2 of θᵤᵥ₁ as the basic waveform. One method for realizing such arrangement is an algorism where a center phase of the UV line voltage pulse within a range of 0≦θᵤᵥ₁≦π/2 is compared with a phase counter of four channels and, based on a comparison result, the UV line voltage pulse is generated with respect to one cycle, that is, a range of 0≦θᵤᵥ₁≦2π. FIG. 18 is a conceptual view of the method. FIG. 18 shows an example of a case where the line voltage pulses are four in the range of 0≦θᵤᵥ₁≦π/2. In FIG. 18, pulse reference angles S₁ to S₄ express center phases of four pulses. carr1 (θᵤᵥ₁) carr2 (θᵤᵥ₁), carr3 (θᵤᵥ₁), and carr4 (θᵤᵥ₁) express the respective phase counters of four channels. All these phase counters are formed of a triangular wave having a cycle of 2π rad with respect to the reference phase θᵤᵥ₁. Further, carr1 (θᵤᵥ₁) and carr2 (θᵤᵥ₁) have deviation of dθ in the amplitude direction, and the relationship between carr3 (θᵤᵥ₁) and carr4 (θᵤᵥ₁) is also set in the same manner. dθ expresses a width of the line voltage pulse. Amplitude of a fundamental wave changes linearly with respect to the pulse width dθ.

The line voltage pulses are formed at respective intersections between the respective phase counters carr1 (θᵤᵥ₁), carr2 (θᵤᵥ₁) carr3 (θᵤᵥ₁), carr4 (θᵤᵥ₁) and the pulse reference angles S₁ to S₄ expressing the center phases of the pulses within a range of 0≦θᵤᵥ₁≦π/2. Accordingly, pulse signals having a symmetrical pattern is formed for every 90 degrees.

To be more specific, at points where carr1 (θᵤᵥ₁), carr2 (θᵤᵥ₁) and S₁ to S₄ agree with each other respectively, a pulse of a width dθ having positive amplitude is generated. On the other hand, a pulse of a width dθ having negative amplitude is generated at points where carr3 (θᵤᵥ₁), carr4 (θᵤᵥ₁) and S₁ to S₄ agree with each other respectively.

FIG. 19 shows one example where a waveform of the line voltage generated using the method explained above is drawn for every modulation index. FIG. 19 shows an example of waveforms of the line voltage pulses when k₁=1, k₂=1, k₃=3 are selected as values of k₁, k₂, k₃ in the formula (5) and a modulation index is changed from 0 to 1.0. It is understood from FIG. 19 that the pulse width is increased substantially proportional to the increase of the modulation index. By increasing the pulse width in this manner, an effective value of a voltage can be increased. However, with respect to pulses in the vicinity of θᵤᵥ₁=0, π, 2π, the pulse width is not changed even when the modulation index is changed with the modulation index of 0.4 or more. Such a phenomenon occurs when a pulse having positive amplitude and a pulse having negative amplitude superpose each other.

As described above, in the above-mentioned embodiment, by transmitting drive signals to the respective semiconductor elements of the inverter circuit 140 from the driver circuit 174, a switching operation is performed based on phases of AC outputs, for example, AC voltages to be outputted. There is a tendency where the number of times of switching the semiconductor element during one cycle of AC power is increased as kinds of harmonics to be removed are increased. Here, in the case of outputting three-phase AC power which is supplied to a three-phase AC electric rotating machine, high-order harmonics where the order is a multiple of 3 cancel each other and hence, these harmonics may not be included in the harmonics to be removed.

Further, as viewed from another view point, there is a tendency where when a voltage of DC power to be supplied is lowered, a modulation index is increased so that a conduction period of each switching operation in a conductive state is prolonged. Further, in driving an electric rotating machine such as a motor, when a generation torque of the electric rotating machine is increased, a modulation index is increased and, as a result, a conduction period of each switching operation is prolonged, while when the generation torque of the electric rotating machine is decreased, the conduction period of each switching operation becomes short. When the conduction period is increased and the interruption time is shortened, that is, when switching intervals become short to some extent, there is a possibility that a semiconductor element cannot be safely interrupted. In such a case, a control is performed such that the semiconductor element is held in a conductive state without being interrupted, and the conduction period is connected with a succeeding conduction period.

As viewed from still another viewpoint, in a low frequency state where the influence of the distortion of AC output to be outputted is large, particularly, in a state where an electric rotating machine is stopped or in a state where a rotational speed is extremely low, the inverter circuit 140 is controlled by a PWM method which makes use of a carrier wave of a fixed cycle without using a control by a PHM method, and the inverter circuit 140 is controlled by switching the PWM method to the PHM method in a state where the rotational speed is increased. When the present invention is applied to a power conversion device for driving an automobile, in a stage where a vehicle starts from a stop state and is accelerated, it is desirable to decrease the influence of torque pulsation particularly because of the reason that the torque pulsation influences gorgeous feeling of the vehicle. Accordingly, the inverter circuit 140 is controlled by the PWM method at least in a state where the vehicle starts from a stop state, and the control is switched to the control by the PHM method after the vehicle is accelerated to some extent. By adopting such a control, the control with small torque pulsation can be realized at least at the time of starting the vehicle, and in a state where the vehicle is shifted to fixed speed traveling which is a normal operation, the control can be performed by the PHM method with small switching loss whereby the control with small loss can be realized while suppressing the influence of torque pulsation.

According to the PHM pulse signals used in the present invention, the technical feature lies in that when the modulation index is fixed as described above, the line voltage waveform formed of the row of pulses having the same pulse width is formed although there is an exceptional case. Such an exceptional case where a pulse width of the line voltage is not equal to a pulse width of other rows of pulses is a case where the pulse having the positive amplitude and the pulse having the negative amplitude superpose each other as described above. In such a case, when the pulse superposing portion is decomposed into the pulse having the positive amplitude and the pulse having the negative amplitude, the pulse width never fails to be equal over the whole region. That is, the modulation index is changed in accordance with the change of the pulse width.

Here, the exceptional case where the pulse width of the line voltage is not equal to the pulse width of other rows of pulses is further explained in detail in conjunction with FIG. 20. An upper part of FIG. 20 shows, out of the line voltage pulse waveform when the modulation index is 1.0 shown in FIG. 19, a portion of the line voltage pulse waveform within a range of π/2≦θᵤᵥ₁≦3π/2 in an enlarged manner. In the line voltage pulse waveform, two pulses in the vicinity of the center have a pulse width different from other pulses. A lower part of FIG. 20 shows the manner where the portion of the line voltage pulse waveform having the different pulse width from other portions of the line voltage pulse waveform is decomposed. From this drawing, it is understood that, in such a portion, the pulse having the positive amplitude and the pulse having the negative amplitude having the same pulse widths as other pulses overlap with each other, and the pulse having the pulse width different from other pulses is formed by synthesizing these pulses. That is, it is understood that by decomposing the superposition of the pulses, the pulse waveform of the line voltage which is formed corresponding to the PHM pulse signal is constituted of the pulse having the fixed pulse width.

Another example of the line voltage pulse waveform formed of PHM pulse signals generated by the present invention is shown in FIG. 21. FIG. 21 shows an example of a line voltage pulse waveform where k₁=1, k₂=1, k₃=5 are selected as values of k₁, k₂, k₃ in the formula (5) and a modulation index is changed from 0 to 1.27. In FIG. 21, when the modulation index becomes 1.17 or more, at positions of θᵤᵥ₁=π/2, 3π/2, a gap between two pulses which are arranged adjacent to each other and are in left and right symmetry is eliminated. Accordingly, it is understood that although targeted harmonic components can be removed when the modulation index is within a range of less than 1.17, the harmonic components cannot be effectively removed when the modulation index is higher than 1.17. When the modulation index is further increased, a gap between pulses which are arranged adjacent to each other at other positions is also eliminated and, eventually, the line voltage pulse waveform of a rectangular wave is formed at the modulation index of 1.27.

FIG. 22 shows an example where the line voltage pulse waveform shown in FIG. 21 is expressed by a corresponding phase voltage pulse waveform. In FIG. 22, in the same manner as FIG. 21, it is understood that a gap between two pulses which are arranged adjacent to each other is eliminated when the modulation index becomes 1.17 or more. The phase difference of π/6 is present between the phase voltage pulse waveform shown in FIG. 22 and the line voltage pulse waveform shown in FIG. 21.

Next, a method of converting a line voltage pulse into a phase voltage pulse is explained. FIG. 23 shows an example of a conversion table used for converting the line voltage pulse into the phase voltage pulse. Numbers are allocated to respective modes 1 to 6 described in a left end column in the table corresponding to switching states which can betaken. In the modes 1 to 6, the relationship between a line voltage and an output voltage is decided on a one to one basis. These respective modes correspond to active periods where the supply and reception of energy are performed between a DC side and a 3-phase AC side. The line voltages described in the table shown in FIG. 23 are arranged by normalizing patterns which can be taken as the potential differences of different phases with a battery voltage V_{dc}.

In FIG. 23, for example, while it is described that Vuv→1, Vvw→0 and Vu→−1 in the mode 1, this expresses a case where Vu−Vv=V_{dc}, Vv−Vw=0, and Vw−Vu=−V_{dc} are established by normalization. Here, the phase voltages, that is, the phase terminal voltages (proportional to gate voltages) become, according to the table shown in FIG. 23, Vu, Vv and Vw become such that Vu→1 (upper arm: ON, lower arm: OFF in U phase), Vv→0 (upper arm: OFF, lower arm: ON in V phase), and Vw→0 (upper arm: OFF, lower arm: ON in W phase). That is, the table shown in FIG. 23 indicates the case where Vu=V_{dc}, Vv=0, and Vw=0 by normalization. The modes 2 to 6 are also established based on the same understanding as the mode 1.

FIG. 24 shows an example where a line voltage pulse is converted into a phase voltage pulse in a mode where the inverter circuit 140 is controlled in a state of a rectangular wave using a conversion table shown in FIG. 23. In FIG. 24, an upper stage indicates a UV line voltage Vuv as a representative example of a line voltage, and a U-phase terminal voltage Vu, a V-phase terminal voltage Vv and a W-phase terminal voltage Vw are indicated below the UV line voltage Vuv. As shown in FIG. 24, in a rectangular wave control mode, the modes shown in the conversion table shown in FIG. 23 are changed in order from 1 to 6. A 3-phase short-circuiting period described later is not present in the rectangular wave control mode.

FIG. 25 shows the manner where a line voltage pulse waveform illustrated in FIG. 19 is converted into a phase voltage pulse in accordance with a conversion table shown in FIG. 23. In FIG. 25, an upper stage indicates a UV line voltage pulse as a representative example of a line voltage, and a U-phase terminal voltage Vu, a V-phase terminal voltage Vv and a W-phase terminal voltage Vw are indicated below the UV line voltage pulse.

In an upper part of FIG. 25, the numbers of modes (active periods where the supply and the reception of energy is performed between a DC side and a 3-phase AC side) and period during which 3-phase short-circuiting is performed are shown. In the 3-phase short-circuiting period, either one of a switching mode where all upper arms of three phases are turned on or a switching mode where all lower arms of three phases are turned on is taken. Either one of these switching modes may be selected in accordance with a switching loss or a state of conduction loss.

For example, when the UV line voltage Vuv is 1, the U phase terminal voltage Vu is 1, and the V phase terminal voltage Vv is 0 (modes 1, 6). When the UV line voltage Vuv is 0, the U phase terminal voltage Vu and the V phase terminal voltage Vv have the same value. That is, the U phase terminal voltage Vu is 1 and the V phase terminal voltage Vv is 1 (mode 2, 3-phase short-circuited) or the U phase terminal voltage Vu is 0 and the V phase terminal voltage Vv is 0 (mode 5, 3-phase short-circuited). When the UV line voltage Vuv is −1, the U phase terminal voltage Vu is 0 and the V phase terminal voltage Vv is 1 (modes 3, 4). Based on such relationships, the respective pulses (gate voltage pulses) of the phase voltages, that is, the phase terminal voltages are generated.

In FIG. 25, the pattern formed of the line voltage pulse and the phase terminal voltage pulses of the respective phases is semi-periodically repeated with respect to a phase θᵤᵥ₁ with π/3 as a minimum unit. That is, the pattern where 1 and 0 of the U phase terminal voltage are inverted during a period of 0≦θᵤᵥ₁≦π/3 is equal to the pattern of the W phase terminal voltage during a period of π/3≦θᵤᵥ₁≦2π/3. Further, the pattern where 1 and 0 of the V phase terminal voltage are inverted during a period of 0≦θᵤᵥ₁≦π/3 is equal to the pattern of the U phase terminal voltage during a period of π/3≦θᵤᵥ₁≦2π/3, and the pattern where 1 and 0 of the W phase terminal voltage are inverted during a period of 0≦θᵤᵥ₁≦π/3 is equal to the pattern of the V phase terminal voltage during a period of π/3≦θᵤᵥ₁≦2π/3. In a steady state where a rotational speed and an output of the motor are fixed, such technical features appear particularly apparently.

Here, the above-mentioned modes 1 to 6 are defined as a first period where the IGBT 328 for the upper arm and the IGBT 330 for the lower arm are respectively turned on in different phases so that an electric current is supplied to the motor generator 192 from the high voltage power source device 136 which is a DC power source. Further, the 3-phase short-circuiting period is defined as a second period where either one of the IGBT 328 for the upper arm and the IGBT 330 for the lower arm is respectively turned on in all phases so that a torque is maintained by energy stored in the motor generator 192. It is understood that, in the example shown in FIG. 25, the first period and the second period are alternately formed corresponding to an electrical angle.

Further, in FIG. 25, for example, during a period of 0≦θᵤᵥ₁≦π/3, the modes 6 and 5 which constitute the first period are alternately repeated with the 3-phase short-circuiting period which constitutes the second period sandwiched between the first periods. As can be understood from FIG. 23, in the mode 6, while the IGBT 330 for the lower arm is turned on in the V phase, the IGBT 328 for the upper arm is turned on a side opposite to the V phase in other phases, that is, the U phase and the W phase. On the other hand, in the mode 5, while the IGBT 328 for the upper arm is turned on in the W phase, the IGBT 330 for the lower arm is turned on a side opposite to the W phase in other phases, that is, the U phase and the V phase. That is, during the first period, any one phase out of the U phase, the V phase and the W phase (the V phase in the mode 6, the W phase in the mode 5) is selected, and the IGBT 328 for the upper arm or the IGBT 330 for the lower arm is turned on with respect to the selected one phase, and the IGBT 328 or 330 for the arm on a side opposite to the selected one phase is turned on with respect to other two phases (the U phase and the W phase in the mode 6, the U phase and the V phase in the mode 5). Further, one phase to be selected (V phase, W phase) for every first period is switched.

Also during the period other than 0≦θᵤᵥ₁≦π/3, in the same manner as above, any one of the modes 1 to 6 which constitutes the first period is repeated with the 3-phase short-circuiting period which constitutes the second period sandwiched between the first periods. That is, during a period of π/3≦θᵤᵥ₁≦2π/3, the mode 1 and the mode 6 are alternately repeated. During a period of 2π/3≦θᵤᵥ₁≦π, the mode 2 and the mode 1 are alternately repeated. During a period of π≦θᵤᵥ₁≦4π/3, the mode 3 and the mode 2 are alternately repeated. During a period of 4π/3≦θᵤᵥ₁≦5π, the mode 4 and the mode 3 are alternately repeated. During a period of 5π/3≦θᵤᵥ₁≦2π, the mode 5 and the mode 4 are alternately repeated. Accordingly, in the same manner as above, in the first period, any one phase is selected out of the U phase, the V phase and the W phase, the IGBT 328 for the upper arm or the IGBT 330 for the lower arm is turned on with respect to the selected one phase, and the IGBT 328 or 330 for the arm on a side different from the selected one phase is turned on with respect to other two phases. Further, the selected one phase is switched for every first period.

An electrical angle position which forms the above-mentioned first period, that is, the periods of modes 1 to 6 and a length of the period can be changed corresponding to a required command for the motor generator 192 such as a torque or a rotational speed. That is, as described previously, a specified electrical angle position which forms the first period is changed for changing the order of a harmonic to be removed along with a change of a rotational speed or a torque of the motor. Alternatively, a length of the first period, that is, a pulse width is changed corresponding to a change of a rotational speed or a torque of the motor thus changing a modulation index. Accordingly, a waveform of an AC current which flows in the motor, to be more specific, a harmonic component of the AC current is changed to a desired value, and power to be supplied to the motor generator 192 from the high voltage power source device 136 can be controlled based on this change. Either one of the specific electrical angle position and the length of the first period may be changed or both the specific electrical angle position and the length of the first period may be changed.

Here, the following relationship exists between a shape of a pulse and a voltage. A width of the pulse illustrated in the drawing has an effect of changing an effective value of the voltage, wherein when the pulse width of a line voltage is large, the effective value of the voltage is large, while when the pulse width of the line voltage is narrow, the effective value of the voltage is small. Further, when the number of harmonics to be removed is small, the effective value of the voltage is high and hence, an upper limit of a modulation index approximates a rectangular wave. This effect is advantageous when an electric rotating machine (motor generator 192) is rotated at a high speed, and the electric rotating machine can generate an output which exceeds an upper limit of the output which is generated when the electric rotating machine is controlled using a usual PWM. That is, by changing a length of the first period during which power is supplied to the motor generator 192 from the battery 136 which is a DC power source and a specific electrical angle position formed in the first period, an effective value of an AC voltage applied to the motor generator 192 can be changed so that an output corresponding to a rotational state of the motor generator 192 can be obtained.

Further, a drive signal shown in FIG. 25 has a pulse shape which is asymmetrical on the right and the left with respect to an arbitrary θᵤᵥ₁, that is, an electrical angle in a U phase, a V phase and a W phase respectively. Further, at least one of a pulse ON period or a pulse OFF period includes a period which continues over π/3 or more in terms of θᵤᵥ₁ (electrical angle). For example, the U phase includes an ON period of π/6 or more before and after the center which is in the vicinity of θᵤᵥ₁=π/2 and an OFF period of π/6 or more before and after the center which is in the vicinity of θᵤᵥ₁=3π/2. In the same manner, the V phase includes an OFF period of π/6 or more before and after the center which is in the vicinity of θᵤᵥ₁=π/6 and an ON period of π/6 or more before and after the center which is in the vicinity of θᵤᵥ₁=7π/6, and the W phase includes an OFF period of π/6 or more before and after the center which is in the vicinity of θᵤᵥ₁=5π/6 and an ON period of π/6 or more before and after the center which is in the vicinity of θᵤᵥ₁=11π/6. The drive signal is characterized by such a pulse shape.

As has been explained above, according to the power conversion device of this embodiment, when a PHM control mode is selected, the first period during which power is supplied to the motor from the DC power source and the second period during which the upper arms of all phases in a three-phase full bridge are turned on or the lower arms of all phases in a three-phase full bridge are turned on are alternately generated at specified timing corresponding to an electrical angle. Accordingly, compared to a case where a PWM control mode is selected, frequency of switching is decreased to 1/7 to 1/10 or less. Accordingly, a switching loss can be reduced. Further, EMC (electric magnetic noises) can be also reduced.

Next, the explanation is made with respect to the manner of removing harmonic components in a line voltage pulse waveform when a modulation index is changed as illustrated in FIG. 21. FIG. 26 is a view showing magnitudes of amplitudes of a fundamental wave and a harmonic component to be removed in a line voltage pulse when a modulation index is changed.

FIG. 26(a) shows an example of amplitudes of the fundamental wave and respective harmonics in the line voltage pulse where third-order and fifth-order harmonics are to be removed. According to the drawing, it is understood that the fifth-order harmonic cannot be completely removed and appears when the modulation index is within a range of 1.2 or more. FIG. 26(b) shows an example of amplitudes of the fundamental wave and respective harmonics in the line voltage pulse where third-order, fifth-order and seventh-order harmonics are to be removed. According to the drawing, it is understood that the fifth-order and the seventh-order harmonics cannot be completely removed and appear when the modulation index is within a range of 1.17 or more.

Examples of a line voltage pulse waveform and a phase voltage pulse waveform corresponding to FIG. 26(a) are shown in FIG. 27 and FIG. 28 respectively. That is, FIG. 27 and FIG. 28 show the examples of the line voltage pulse waveform and the phase voltage waveform when a row vector where the number of element is 2 is set, K₁=1, k₂=3 are respectively selected as values of K₁, k₂ in the respective elements (k₁/3, k₂/5), and a modulation index is changed from 0 to 1.27. Further, FIG. 26(b) corresponds to the line voltage pulse waveform and a phase voltage pulse waveform shown in FIG. 21 and FIG. 22 respectively.

From the above-mentioned explanation, it is understood that when a modulation index exceeds a certain fixed value, harmonics which are to be removed cannot be completely removed so that the harmonics start to appear. Further, it is understood that along with the increase of the kinds (number) of harmonics to be removed, the harmonics cannot be completely removed at a low modulation index.

Next, a method of generating a PWM pulse signal in the pulse modulator 440 for PWM control shown in FIG. 13 is explained in conjunction with FIG. 29. FIG. 29(a) shows waveforms of voltage command signals in respective phases consisting of a U phase, a V phase and a W phase, and a triangular wave carrier used for generating a PWM pulse. The voltage command signals of the respective phases are sinusoidal command signals which shift phases thereof by 2π/3 from each other, and amplitudes of the voltage command signals are changed corresponding to a modulation index. The voltage command signal and the triangular wave carrier signal are compared to each other with respect to the respective phases of U, V, and W, and an intersection between the voltage command signal and the triangular wave carrier signal is set as pulse ON-OFF timing so that voltage pulse waveforms for respective phases consisting of a U phase, a V phase and a W phase respectively shown in FIGS. 29(b), (c), (d) are generated. The number of pulses in all these pulse waveforms is equal to the number of triangular pulses in the triangular wave carrier.

FIG. 29(e) shows a waveform of a UV line voltage. The number of pulses is twice as large as the number of triangular pulses in the triangular wave carrier, that is, twice as large as the number of pulses in the above-mentioned voltage pulse waveform for each phase. The same goes for other line voltages, that is, a VW line voltage and a WU line voltage.

FIG. 30 shows one example where waveform of a line voltage formed based on a PWM pulse signal is drawn for every modulation index. Here, FIG. 30 shows examples of line voltage pulse waveforms when the modulation index is changed from 0 to 1.27. In FIG. 30, when the modulation index becomes 1.17 or more, a gap between two pulses arranged adjacent to each other is eliminated, and two pulses are formed into one pulse by joining. Such a pulse signal is referred to as overmodulated PWM pulse. Finally, the line voltage pulse waveform of a rectangular wave is formed at a modulation index of 1.27.

An example where the line voltage pulse waveforms shown in FIG. 30 are expressed by corresponding phase voltage pulse waveforms is shown in FIG. 31. Also in FIG. 31, in the same manner as FIG. 30, it is understood that when the modulation index becomes 1.17 or more, a gap between two pulses arranged adjacent to each other is eliminated. The phase difference of π/6 exists between the phase voltage pulse waveform shown in FIG. 31 and the line voltage pulse waveform shown in FIG. 30.

Here, the line voltage pulse waveform formed of PHM pulse signals and the line voltage pulse waveform formed of PWM pulse signals are compared to each other. FIG. 32(a) shows one example of the line voltage pulse waveform formed of PHM pulse signals. This example corresponds to the line voltage pulse waveform at a modulation index of 0.4 in FIG. 19. On the other hand, FIG. 32(b) shows one example of the line voltage pulse waveform formed of PWM pulse signals. This example corresponds to the line voltage pulse waveform at a modulation index of 0.4 in FIG. 30.

To compare the number of pulses in FIG. 32(a) and the number of pulses in FIG. 32(b) to each other, it is understood that the number of pulses in the line voltage pulse waveform formed of the PHM pulse signals shown in FIG. 32(a) is considerably smaller than the number of pulses in the line voltage pulse waveform formed of the PWM pulse signals shown in FIG. 32(b). Accordingly, when the PHM pulse signals are used, although the control responsiveness is lowered compared to the PWM signal since the number of line voltage pulses to be generated is small, the number of times of switching can be largely reduced compared to a case where PWM signals are used. As a result, a switching loss can be largely reduced.

FIG. 33 shows the manner when a PWM control mode and a PHM control mode are switched in response to a rotational speed of the motor generator by a switching operation of the switcher 450. Here, FIG. 33 shows an example of a line voltage pulse waveform when a control mode is switched to a PHM control mode from a PWM control mode by switching the selection destination of the switcher 450 to a PHM pulse signal from a PWM pulse signal when θᵤᵥ₁=π.

Next, the difference in pulse shape between a PWM control and a PHM control is explained in conjunction with FIG. 34. FIG. 34(a) shows a triangular wave carrier used for generating a PWM pulse signal, and a U phase voltage, a V phase voltage and a UV line voltage which are generated by the PWM pulse signals. FIG. 34(b) shows a U phase voltage, a V phase voltage and a UV line voltage generated by the PHM pulse signals. To compare these drawings from each other, it is understood that when the PWM pulse signals are used, pulse widths of the respective pulses of the UV line voltage are not fixed, while when the PHM pulse signals are used, pulse widths of the respective pulses of the UV line voltage are fixed. Although there may be a case where the pulse widths are not fixed as described previously, this is caused by the superposition of a pulse having positive amplitude and a pulse having negative amplitude so that all pulses have the same pulse width when the superposition of the pulses is decomposed. Further, it is understood that when the PWM pulse signals are used, the triangular wave carrier is fixed irrelevant to a change of a rotational speed of the motor generator and hence, intervals of respective pulses of the UV line voltage are fixed irrelevant to the rotational speed of the motor generator, while when the PHM pulse signals are used, intervals of the respective pulses of the UV line voltage are changed corresponding to the rotational speed of the motor generator.

FIG. 35 shows the relationship between a rotational speed of the motor generator and a line voltage pulse waveform formed of PHM pulse signals. FIG. 35(a) shows one example of a line voltage pulse waveform formed of PHM pulse signals at predetermined rotational speed of the motor generator. This line voltage pulse waveform corresponds to the line voltage pulse waveform at a modulation index of 0.4 in FIG. 19, and the line voltage pulse waveform has 16 pulses per an electrical angle (reference phase θᵤᵥ₁ of UV line voltage) of 2π.

FIG. 35(b) shows one example of a line voltage pulse waveform formed of PHM pulse signals when the rotational speed of the motor generator in FIG. 35(a) is set to a value twice as large as the rotational speed in FIG. 35(a). A length of an axis of abscissas in FIG. 35(b) is set equivalent to a length of an axis of abscissas in FIG. 35(a) with respect to a time axis. To compare FIG. 35(a) and FIG. 35(b) from each other, it is understood that although the number of pulses per an electrical angle of 2π is 16 pulses so that the number of pulses is not different between FIG. 35(a) and FIG. 35(b), the number of pulses within the same time in FIG. 35(b) is twice as large as the number of pulses in the same time in FIG. 35(a). FIG. 35(c) shows one example of a line voltage pulse waveform formed of PHM pulse signals when the rotational speed of the motor generator in FIG. 35(a) is set to a value which is ½ times as large as the rotational speed in FIG. 35(a). A length of an axis of abscissas in FIG. 35(c) is also set equivalent to a length of the axis of abscissas in FIG. 35(a) with respect to a time axis in the same manner as FIG. 35(b). To compare FIG. 35(a) and FIG. 35(c) from each other, it is understood that the number of pulses per an electrical angle of π is 8 pulses in FIG. 35(c) and hence, the number of pulses per an electrical angle of 2π is 16 pulses so that the number of pulses is not different between FIG. 35(a) and FIG. 35(c), while the number of pulses within the same time in FIG. 35(c) is set to a value ½ times as large as the number of pulses in the same time in FIG. 35(a).

As explained above, when PHM pulse signals are used, the number of pulses per unit time of line voltage pulses is changed proportional to a rotational speed of the motor generator. That is, to consider the number of pulses per an electrical angle of 2π, the number of pulses is fixed irrelevant to a rotational speed of the motor generator. On the other hand, when the PWM pulse signals are used, as shown in FIG. 34, the number of pulses of the line voltage pulses is fixed irrelevant to a rotational speed of the motor generator. That is, to consider the number of pulses per an electrical angle of 2π, the number of pulses is reduced as a rotational speed of the motor generator is increased.

FIG. 36 shows the relationship between the number of line voltage pulses per an electrical angle of 2π (that is, per one cycle of line voltage) which are generated in a PHM control and a PWM control respectively and a rotational speed of the motor generator. FIG. 36 shows an example where using a 8 pole motor (the number of pole pairs: 4), harmonic components to be removed in the PHM control are set to three harmonic components consisting of a third-order harmonic component, a fifth-order harmonic component and a seventh-order harmonic component, and a frequency of a triangular wave carrier used in sinusoidal PWM control is set to 10 kHz. In this manner, it is understood that the number of line voltage pulses per an electrical angle of 2π is decreased along with the increase of a rotational speed of the motor generator in the case of the PWM control, while the number of line voltage pulses per an electrical angle of 2π is fixed irrelevant to a rotational speed of the motor generator in the case of the PHM control. The number of line voltage pulses in the PWM control can be obtained by a formula (10).

(number of line voltage pulses)=(frequency of triangular wave carrier)/{(number of pole pairs)×(rotational speed)/60}×2 (10).

FIG. 36 shows that when the number of harmonic components to be removed in the PHM control is set to 3, the number of line voltage pulses per one cycle of line voltage is 16. However, this value is changed as described previously corresponding to the number of harmonic components to be removed. That is, when the number of harmonic components to be removed is 2, the number of line voltage pulses becomes 8. When the number of harmonic components to be removed is 4, the number of line voltage pulses becomes 32. When the number of harmonic components to be removed is 5, the number of line voltage pulses becomes 64. In this manner, the number of pulses per one cycle of line voltage is increased twice each time the number of harmonic components to be removed is increased by 1.

FIG. 37 shows a flowchart of a motor control performed by the control circuit 172 according to the first embodiment explained above. In step 901, the control circuit 172 acquires rotational speed information on the motor. This rotational speed information is acquired based on a magnetic pole position signal θ outputted from the rotating magnetic pole sensor 193.

In step 902, the control circuit 172 determines whether or not a rotational speed of the motor generator is a predetermined switching rotational speed or more based on the rotational speed information acquired in step 901. When the control circuit 172 determines that the rotational speed of the motor generator is the switching rotational speed or more, the processing advances to step 904, while when the rotational speed of the motor generator is less than the switching rotational speed, the processing advances to step 903.

In step 904, the control circuit 172 decides the orders of harmonics to be removed in the PHM control. In this step, as described previously, harmonics such as a third-order harmonic, a fifth-order harmonic and a seventh-order harmonic can be decided as the harmonics to be removed. The number of harmonics to be removed may be changed corresponding to a rotational speed of the motor generator. For example, when the rotational speed of the motor generator is relatively low, the third-order harmonic, the fifth-order harmonic and the seventh-order harmonic are decided as the harmonics to be removed, while when the rotational speed of the motor generator is relatively high, the third-order harmonic and the fifth-order harmonic are decided as the harmonics to be removed. In this manner, by decreasing the number of harmonics to be removed along with the increase of the rotational speed of the motor generator, it is possible to reduce the number of pulses of PHM pulse signals in a high speed rotation region where the driving of the motor generator is hardly influenced by torque pulsation caused by the harmonics thus reducing a switching loss more effectively.

In step 905, the control circuit 172 performs a PHM control where the harmonics of the orders which are decided in step 904 are set as harmonics to be removed. Here, PHM pulse signals corresponding to the orders of harmonics to be removed are generated by the pulse modulator 430 in accordance with the above-mentioned generation method, and the PHM pulse signals are selected by the switcher 450, and the selected PHM pulse signals are outputted to the driver circuit 174 from the control circuit 172. After executing the processing in step 905, the control circuit 172 returns to step 901, and repeats the above-mentioned processing.

In step 906, the control circuit 172 performs a rectangular wave control. The rectangular wave control may be considered as one mode of the PHM control as described above, that is, the mode where a modulation index is set maximum in the PHM control or the mode where there is no order of harmonics to be removed. Although harmonics cannot be removed in the rectangular wave control, the number of times of switching can be minimized. Further, pulse signals used in the rectangular wave control can be generated by the pulse modulator 430 in the same manner as the PHM control. The pulse signals are selected by the switcher 450, and are outputted to the driver circuit 174 from the control circuit 172. When the processing in step 906 is executed, the control circuit 172 returns to step 901, and repeats the above-mentioned processing.

In step 903, the control circuit 172 performs a PWM control. Here, based on a comparison result between a predetermined triangular wave carrier and a voltage command signal, using the above-mentioned generation method, PWM pulse signals are generated by the pulse converter 440, the PWM pulse signals are selected by the switcher 450, and the selected PWM pulse signals are outputted to the driver circuit 174 from the control circuit 172. When the processing in step 903 is executed, the control circuit 172 returns to step 901, and repeats the above-mentioned processing.

According to the first embodiment explained heretofore, in addition to the acquisition of the above-mentioned manner of operation and advantageous effects, the following manner of operation and advantageous effects can be also acquired.

(1) The power conversion device 200 includes a 3-phase full-bridge-type inverter circuit 140 having the IGBTs 328, 330 for the upper arm and the lower arm, and the control part 170 which outputs drive signals to the IGBTs 328, 330 in each phase, wherein a voltage supplied from the high voltage power source device 136 is converted into an output voltage shifted for every 2π/3rad at an electrical angle by a switching operation of the IGBTs 328, 330 in response to drive signals, and the output voltage is supplied to the motor generator 192. The power conversion device 200 switches a PHM control mode and a sinusoidal PWM control mode based on predetermined conditions. In the PHM control mode, a first period where the IGBT 328 for the upper arm and the IGBT 330 for the lower arm are respectively turned on in different phases so that an electric current is supplied to the motor generator 192 from the high voltage power source device 136 and a second period where either one of the IGBT 328 for the upper arm and the IGBT 330 for the lower arm is turned on in all phases so that a torque is maintained by energy stored in the motor generator 192 are alternately formed corresponding to an electrical angle. In the sinusoidal PWM control mode, the IGBTs 328, 330 are turned on corresponding to a pulse width decided based on a comparison result between a sinusoidal command signal and a carrier wave thus supplying an electric current to the motor generator 192 from the high voltage power source device 136. Due to such an operation, a proper control corresponding to a state of the motor generator 192 can be performed while reducing torque pulsation and a switching loss.

(2) The power conversion device 200 can switch the PHM control mode and the sinusoidal PWM control mode based on a rotational speed of the motor generator 192 (steps 902, 903, 905, 906 in FIG. 37). Due to such an operation, a control mode can be switched to a proper control mode corresponding to a rotational speed of the motor generator 192.

(3) The PHM control mode further includes a rectangular wave control mode where the IGBTs 328, 330 of each phase are turned on or off one time respectively for every 1 rotation of the motor generator 192. Due to such an operation, when the motor generator 192 is in a high rotation state where the influence of torque pulsation is small or the like, a switching loss can be minimized. Although the rectangular wave control mode is a control mode which is used in a region where a rotational speed is the highest as shown in FIG. 10, the rectangular wave control mode is also used in a high output region where a high modulation index is required. In this embodiment, by increasing a modulation index, the number of times of switching per half cycle is gradually decreased so that a control mode can be smoothly shifted to the above-mentioned rectangular wave control mode.

(4) In the PHM control mode, a harmonic component of an AC current which flows in the motor generator 192 is changed to a desired value by changing at least one of an electrical angle position which forms the first period and a length of the first period. Due to such a change of the harmonic component, the operation mode is shifted to the rectangular wave control mode from the PHM control mode. To be more specific, the length of the first period is changed corresponding to a modulation index, and the rectangular wave control is performed when the modulation index is maximum. Due to such an operation, the shift of the control mode from the PHM control mode to the rectangular wave control mode can be easily realized.

### Second Embodiment

A control system of a motor generator using a control circuit 172 according to the second embodiment of the present invention is shown in FIG. 38. This control system of the motor generator further includes a transient current compensator 460 compared to the control system of the motor generator according to the first embodiment shown in FIG. 13.

The transient current compensator 460, when a control mode is switched from a PWM control to a PHM control or from the PHM control to the PWM control, generates a compensation current for compensating a transient current generated in a phase current which flows in the motor generator 192. The generation of the compensation current is performed in such a manner that a phase voltage at the time of switching the control mode is detected, and a pulse-like modulated wave for generating a compensation pulse which cancels the detected phase voltage is outputted to a driver circuit 174 from the transient current compensator 460. By outputting a drive signal based on the modulated wave outputted from the transient current compensator 460 to respective IGBTs 328, 330 of an inverter circuit 140 from the driver circuit 174, a compensation pulse is generated so that the compensation current is generated.

The generation of a compensation current by the above-mentioned transient current compensator 460 is explained in conjunction with FIG. 39. In FIG. 39, in order from the top, respective examples of a line voltage waveform and a phase voltage waveform formed of PWM pulse signals, a phase current waveform at the time of switching a control mode, a compensation pulse waveform, and a line voltage waveform and a phase voltage waveform formed of PHM pulse signals after switching the control mode are respectively shown. In FIG. 39, except for the line voltage waveform and the phase voltage waveform formed of the PWM pulse signals, the example of the waveform where the switching of the control mode from the PWM control mode to the PHM control mode is performed at an electrical angle (reference phase) it in the drawing is shown. In performing the switching of the control mode, a phase current is detected as shown in the drawing. A pulse width of the compensation pulse is decided based on a detection result of the phase current, and a compensation pulse of amplitude V_{dc}/2 having a symbol opposite to a symbol of the phase voltage (negative here) is outputted. Accordingly, as shown in the drawing, a compensation current which cancels a transient current generated immediately after switching of the control mode flows in the phase current. After outputting of the compensation pulse is finished, PHM pulse signals are outputted.

FIG. 40 shows a portion of the phase current waveform and a portion of the compensation pulse waveform shown in FIG. 39 in an enlarged manner using a switching point of time of the control mode as a starting point. As shown in FIG. 40, during a period where a compensation pulse Vun_p of a transient current is outputted, a compensation current Iup is increased to a negative side. When magnitude of a transient current Iut and magnitude of the compensation current Iup agree with each other at a point of time t0, outputting of the compensation pulse Vun_p is finished in conformity with this timing. Thereafter, the transient current Iut and the compensation current Iup are converged into 0 respectively with similar inclinations. Accordingly, it is possible to converge a phase current Iua which is a product of the transient current Iut and the compensation current Iup at a point of time t0 or after.

As described above, by deciding a pulse width of the compensation pulse Vun_p in conformity with timing at which magnitudes of the transient current Iut and the compensation current Iup agree with each other, that is, timing at which the transient current Iut is completely canceled by the compensation current Iup and hence, the phase current Iua can be speedily converged to 0. Such a pulse width can be decided based on a detection result of the phase current Iua at the time of switching the control mode by taking into account a time constant of the circuit.

Although the explanation has been made with respect to timing of switching the control mode from the PWM control mode to the PHM control mode in FIG. 39 and FIG. 40, also at the time of switching the control mode from the PHM control mode to the PWM control mode to the contrary, in the same manner as the above-mentioned method, a compensation pulse is outputted from the transient current compensator 460, and a compensation current which cancels a transient current can be generated in a phase current.

FIG. 41 shows a flowchart of a motor control performed by the control circuit 172 according to the second embodiment explained above. In steps 901 to 907, the control circuit 172 performs the processing substantially equal to the processing in the first embodiment shown in the flowchart in FIG. 37.

In step 908, the control circuit 172 determines whether or not a control mode is switched. When the control mode is switched from a PWM control to a PHM control or from the PHM control to the PWM control, the control circuit 172 advances to step 909. On the other hand, when switching of the control mode is not performed, the control circuit 172 returns to step 901 and repeats the processing. A determination result of step 908 is transmitted to the transient current compensator 460 by outputting a compensator interruption signal to the transient current compensator 460 from a pulse modulator 430 for PHM control or a pulse modulator 440 for PWM control. In step 909, the control circuit 172 generates a compensation current by generating a compensation pulse by the above-mentioned method, and performs the compensation of a transient current generated on a phase current in the transient current compensator 460. After executing the processing in step 909, the control circuit 172 returns to step 901 and repeats the processing. Here, the transient current compensation in step 909 is further explained in detail in conjunction with a flowchart shown in FIG. 42. firstly, the transient current compensator 460 detects transient currents of respective phases consisting of a U phase, a V phase and a W phase immediately before switching control mode in step 987. The detection of the transient current is performed using a current sensor 180. Next, the transient current compensator 460 calculates a phase voltage applying time t0 with respect to the respective phases in step 988 using a preset circuit time constant τ such that a compensation current flows in the direction so as to cancel the detected transient current.

The calculation of the phase voltage applying time t0 is performed based on a circuit model shown in FIG. 43. That is, the circuit time constant τ(=L/r) is calculated based on circuit inductance L and circuit resistance r which are preliminarily set, and based on the circuit time constant τ and a predetermined induction voltage Eu, a phase voltage applying time t0 is decided as a pulse width of a U-phase voltage pulse Vu so as to cancel a U-phase voltage Iua detected as a transient current. Here, when it is desirable to completely cancel the transient current, the phase voltage applying time to may be maintained until the compensation current and the transient current balance each other. Although a circuit model of the U phase is illustrated as an example in FIG. 43, the same goes for the V phase and the W phase.

Next, the transient current compensator 460 starts applying of a phase voltage in respective phases in step 989 in accordance with the calculated phase voltage applying time t0. Here, a phase voltage having amplitude V_{dc}/2 is applied in the direction to cancel the transient current only for the phase voltage applying time t0. When time after starting the applying of the phase voltage reaches the target applying time (phase voltage applying time) t0, the transient current compensator 460 stops the applying of the phase voltage in step 990. After the applying of the phase voltage by the transient current compensator 460 is finished, as indicated in step 991, the transient current compensator 460 attenuates the transient current in accordance with the time constant ti such that the compensation current gradually cancels the transient current. The transient current compensation is performed in step 990 as described above.

According to the second embodiment explained heretofore, at the time of switching the PHM control mode and the PWM control mode, using the transient current compensator 460, a compensation pulse for compensating a transient current generated in an AC current which flows in the motor generator 192 is outputted from a power conversion device 200. Accordingly, the rotation of the motor generator 192 can be speedily stabilized at the time of switching the control mode.

A transient current may be compensated by outputting a compensation pulse at timings besides the above-mentioned switching timing of the control mode. For example, a transient current can be compensated by outputting a compensation pulse using the transient current compensator 460 also at the time of transition of state where a transient current is likely to be generated such as a case where the order of a harmonic to be removed is changed or a case where a modulation index or a rotational speed of the motor generator is rapidly changed in a PHM control mode. Alternatively, whether or not a compensation pulse is to be outputted may be decided by determining the presence or the non-presence of a transient current based on a detection result of a phase current. Outputting of such a compensation pulse may be performed in addition to the switching of the control mode or may be performed in place of the switching of a control mode.

### Third Embodiment

A control system of a motor generator using a control circuit 172 according to the third embodiment of the present invention is shown in FIG. 44. This control system of the motor generator further includes, compared to the control system of the motor generator according to the second embodiment shown in FIG. 38, a current controller (ACR) 422, a chopper cycle generator 470, a pulse modulator 480 for a 1 phase chopper control.

The current controller (ACR) 422, in the same manner as the current controllers (ACR) 420, 421, calculates a d axis voltage command signal Vd* and a q axis voltage command signal Vq* respectively based on a d axis current command signal Id* and a q axis current command signal Iq* outputted from a torque command/current command converter 410 and a phase current detection signals Iu, Iv, Iw of the motor generator 192 detected by a current sensor 180. The d axis voltage command signal Vd* and the q axis voltage command signal Vq* obtained by the current controller (ACR) 422 are outputted to the pulse modulator 430 for a 1 phase chopper control.

The chopper cycle generator 472 outputs a chopper cycle signal which is repeated at a predetermined cycle to the pulse modulator 480. The cycle of the chopper cycle signal is preliminarily set by taking into account the inductance of the motor generator 192. The pulse modulator 480 generates a pulse signal for a 1 phase chopper control based on the chopper cycle signal from the chopper cycle generator 470, and outputs the pulse signal to a switcher 450. That is, the cycle of the pulse signal for the 1 phase chopper control which the pulse modulator 480 outputs is decided corresponding to the inductance of the motor generator 192.

When it is determined that the motor generator 192 is in a stop state or in an extremely low speed rotation state, the switcher 450 selects a pulse signal for a 1 phase chopper control outputted from the pulse modulator 480, and outputs the pulse signal to the driver circuit 174 (not shown in the drawing). Accordingly, a 1 phase chopper control is performed in the power conversion device 200.

The pulse signal for a 1 phase chopper control which the pulse modulator 480 outputs is a signal for increasing a rotational speed of the motor generator 192 until a proper motor control becomes possible when the motor generator 192 is in a stop state or in an extremely low speed rotation state so that a proper motor control cannot not be performed. When the motor generator 192 is in a stop state or in an extremely low speed rotation state, a magnetic pole position signal θ which expresses such a rotation state cannot be accurately obtained from a rotating magnetic pole sensor 193 and hence, a proper motor control cannot be performed. The cycle of the pulse signal for a 1 phase chopper control is decided corresponding to a chopper cycle signal from the chopper cycle generator 470.

When a PHM control is performed in a state where the motor generator 192 is in a stop state or in an extreme low speed rotation state as described above, the motor generator 192 is maintained in either one of the above-mentioned first period and the second period for a long time. The first period is an energization period where an IGBT 328 for an upper arm or an IGBT 330 for a lower arm is turned on individually in each phase and an electric current is supplied to the motor generator 192 from a high voltage power source device 136, wherein the arm which is turned on in any one of phases and the arms which are turned on in other two phases differ from each other. The second period is a 3-phase short circuiting period where the IGBT 328 for the upper arm or the IGBT 330 for the lower arm is turned on in common in all phases so that a torque is maintained by energy stored in the motor generator 192.

When the first period is maintained for a long time, a locking current (DC current) continues to flow in the IGBT 328 or the IGBT 330 which is turned on during the first period and hence, the abnormal heat generation or the rupture is induced in the IGBT 328 or 330. On the other hand, when the second period is maintained for a long time, power is not supplied to the motor generator 192 and hence, the motor generator 192 cannot be started. In this embodiment, to avoid the motor generator 192 from falling into such a state, when it is determined that the motor generator 192 is in a stop state or in an extremely low speed rotation state so that a PWM control is not performed, a 1 phase chopper control mode is adopted so that a pulse signal for a 1 phase chopper control is outputted to the driver circuit 174 from the control circuit 172 as a modulated wave. In accordance with this modulated wave, drive signals are outputted to the respective IGBTs 328, 330 of the inverter circuit 140 from the driver circuit 174.

FIG. 45 shows one example of a 1 phase chopper control using pulse signals outputted from a pulse modulator 430. FIG. 45 shows an example of respective phase voltage waveforms when a 1 phase chopper control is performed in order of a U phase, a V phase and a W phase. Firstly, a V phase voltage and a W phase voltage are set to −V_{dc}/2 while changing a U phase voltage in a pulse shape between V_{dc}/2 and −V_{dc}/2. Here, a pulse width is decided corresponding to a chopper cycle signal which the chopper cycle generator 470 outputs. Due to such an operation, during a period where the U phase voltage is V_{dc}/2, the upper arm of the U phase is turned on and the lower arms of the V phase and the W phase are also turned on respectively and hence, a U phase energization period during which an electric current flows in a U phase is formed. Further, during a period where the U phase voltage is −V_{dc}/2, the lower arms of the U phase, the V phase and the W phase are turned on respectively and hence, a 3-phase short circuiting period is formed.

Next, in the same manner as above, voltages of the V phase and the W phase are set to V_{dc}/2 while changing the U phase voltage in a pulse shape between V_{dc}/2 and −V_{dc}/2. Here, during a period where the U phase voltage is −V_{dc}/2, the lower arm of the U phase is turned on and the upper arms of the V phase and the W phase are also respectively turned on and hence, a U phase energization period where an electric current flows in the U phase is formed. Further, the upper arms of the U phase, the V phase and the W phase are respectively turned on during a period where the U phase voltage is V_{ac}/2 and hence, a 3-phase short circuiting period is formed.

Hereinafter, also with respect to the V phase and the W phase, in the same manner as the U phase, voltages of the U phase and the W phase are firstly set to −V_{dc}/2 and is secondly set to V_{dc}/2 while changing the V phase voltage in a pulse shape between V_{dc}/2 and −V_{dc}/2. Further, the voltages of U phase and the V phase are firstly set to −V_{dc}/2 and are secondly set to V_{dc}/2 while changing the W phase voltage in a pulse shape between V_{dc}/2 and −V_{dc}/2. By repeatedly performing such a 1 phase chopper control, the energization period and the 3-phase short circuiting period can be alternately formed irrelevant to an electrical angle with respect to the respective phases consisting of the U phase, the V phase and the W phase. Accordingly, even when the motor generator 192 is in a stop state or in an extremely low speed rotation state, a rotational speed of the motor generator 192 can be increased from such a state.

When a rotational speed of the motor generator 192 is increased so that the motor generator 192 is escaped from a stop state or an extremely low speed rotation state by performing a 1 phase chopper control as described above, the control of the motor generator 192 is switched from the 1 phase chopper control to another control, that is, a PWM control or a PHM control. Thereafter, the motor control is performed using the substantially same method as explained in conjunction with the above-mentioned second embodiment.

FIG. 46 shows a flowchart of the motor control performed by the control circuit 172 according to the third embodiment explained above. In steps 901 to 909, the control circuit 172 performs the processing substantially equal to the processing performed in the second embodiment shown in the flowchart in FIG. 41. In step 910, the control circuit 172 determines whether or not the motor generator 192 is in a stop state or in an extremely low speed rotation state based on rotational speed information acquired in step 901. When the rotational speed of the motor generator 192 is less than a predetermined rotational speed so that it is determined that the motor generator 192 is in a stop state or in an extremely low speed rotation state, that is, in a state where it is determined that a magnetic pole position signal θ cannot be accurately obtained from a rotating magnetic pole sensor 193 so that a rotation state of the motor generator 192 cannot be detected, the processing advances to step 911. If not so, the processing advances to step 906, and a PWM control substantially equal to the previously mentioned PWM control is performed.

In step 911, the control circuit 172 performs a 1 phase chopper control in the control of a region where the rotational speed is lowest in FIG. 10. Here, based on a chopper cycle signal from the chopper cycle generator 470, a pulse signal for a 1 phase chopper control is generated by the pulse modulator 430 by the above-mentioned generation method, and a pulse signal is selected by a switcher 450, and is outputted to the driver circuit 174 from the control circuit 172. When the processing in step 911 is executed, the control circuit 172 advances the processing to step 908.

In the third embodiment explained heretofore, the explanation is made by taking, as an example, the control system of the motor generator which further includes the respective constitutions of the current controller (ACR) 422, the chopper cycle generator 470 and the pulse modulator 430 for a 1 phase chopper control based on the control system of the motor generator according to the second embodiment shown in FIG. 38. However, it may be possible to adopt a control system of the motor generator which further includes these respective constitutions based on the control system of the motor generator according to the first embodiment shown in FIG. 13.

According to the third embodiment explained heretofore, it is determined whether or not a rotational state of the motor generator 192 is detectable and whether or not the PWM control is to be performed (step 910 in FIG. 46) and, based on the determination result, a predetermined 1 phase chopper control pulse signal for alternately forming the first period and the second period in respective phases irrelevant to an electrical angle is outputted from the pulse modulator 430 for a 1 phase chopper control (step 911). Due to such an operation, when the motor generator 192 is in a stop state or in an extremely low speed rotation state so that a proper motor control cannot be performed, it is possible to increase a rotational speed of the motor generator 192 until the proper motor control can be performed.

### Modification

The above-explained respective embodiments can be modified as follows.

(1) In the above-explained respective embodiments, the switching of the control mode is performed by the power conversion device 200 in such a manner that a PHM control including a rectangular wave control is performed when a rotational speed of the motor generator is higher than a predetermined switching rotational speed, and a PWM control is performed when the rotational speed of the motor generator is lower than the switching rotational speed. However, such switching of the control mode is not limited to patterns explained in conjunction with the respective embodiments, and is applicable based on an arbitrary rotational speed of the motor generator. For example, assuming that a rotational speed of the motor generator falls within a range from 0 to 10,000 r/min, a PWM control can be performed when the rotational speed falls within a range from 0 to 1,500 r/min, a PHM control can be performed when the rotational speed falls within a range from 1,500 to 4,000 r/min, a PWM control can be performed when the rotational speed falls within a range from 4,000 to 6,000 r/min, and a PHM control can be performed when the rotational speed falls within a range from 6,000 to 10,000 r/min, respectively. Due to such an operation, it is possible to realize a finer motor control using an optimum control mode corresponding to a rotational speed of the motor generator.

(2) In the above-explained respective embodiments, a PWM control is performed when a rotational speed of the motor generator is less than a predetermined switching rotational speed. However, to consider a case where the present invention is applied to a hybrid automobile or the like, for the purpose of giving a pedestrian or the like a warning, when a rotational speed of the motor generator is low, a PHM control may be performed in place of a PWM control. If a PHM control is performed when a rotational speed of the motor generator is low, harmonic components cannot be removed so that the distortion of an electric current is generated whereby the current distortion causes motor operation sounds. Accordingly, by intentionally making the vehicle generate such motor operation sounds, it is possible to give a pedestrian or the like a warning that the vehicle is around him. Such generation of motor operation sounds using the PHM control may be made valid or invalid by the manipulation of a switch or the like by a driver of the vehicle. Alternatively, a vehicle may detect a pedestrian or the like around the vehicle and may automatically perform a PHM control thus generating motor operation sounds. In this case, the detection of a pedestrian may be performed by various known methods such as an infrared ray sensor or an image determination, for example. Further, it is determined whether or not a present position of a vehicle is in an urban area based on prestored map information or the like, and motor operation sounds may be generated by applying a PHM control when the present position of the vehicle is the urban area.

The operation principle of the above-mentioned pulse modulator 430 for PHM control shown in FIG. 13 has been explained in conjunction with FIG. 11 to FIG. 13, and the case where the pulse modulator 430 is realized by using a microprocessor has been explained in conjunction with FIG. 15. Although the operation principle and the method of realizing the pulse modulator 430 have been already explained sufficiently in conjunction with FIG. 11 to FIG. 15, the operation principle and the method of realizing the pulse modulator 430 are explained hereinafter again.

Assume a rectangular wave corresponding to a waveform of an AC power, for example, an AC voltage to be outputted. The rectangular wave includes various harmonics, and the rectangular wave can be decomposed into the respective harmonic components as expressed by the formula (1) by using the Fourier expansion.

The above-mentioned harmonics to be removed are decided depending on an object to be used or the situation and switching pulses are generated. In other words, the number of times of switching is reduced by allowing the rectangular wave to include harmonic components which are unnecessary to be removed.

FIG. 45 is a view showing, as one example, generation processes and characteristics of patterns of line voltages of a U phase and a V phase where a third order harmonic, a fifth order harmonic and a seventh order harmonic are removed. Here, the line voltage means the potential difference between terminals of respective phases, and assuming a phase voltage of a U phase as Vu and a phase voltage of a V phase as Vv, a line voltage Vuv is indicated by a formula Vuv=Vu−Vv. The same goes for the line voltage between the V phase and a W phase and between the W phase and the U phase and hence, hereinafter, the explanation is made with respect to the generation of pattern of the line voltage between the U phase and the V phase as a representative example.

In FIG. 45, a fundamental wave of the line voltage between the U phase and the V phase is taken on an, axis of abscissas as the reference, and is named as a UV line voltage reference phase θᵤᵥ₁ in an abbreviated manner hereinafter. Here, a zone of π≦θᵤᵥ₁≦2π has a symmetrical shape with a zone of 0≦θᵤᵥ₁≦π showing in the drawing in such a manner that symbols of waveforms of the row of voltage pulses are inverted and hence, the zone of π≦θᵤᵥ₁≦2π is omitted here. As shown in FIG. 45, a fundamental wave formed of the voltage pulses is a sinusoidal voltage using θᵤᵥ₁ as the reference. The generated pulses are respectively arranged at positions illustrated in the drawing with respect to the θᵤᵥ₁ in accordance with steps shown in the drawing with π/2 of the fundamental wave set at the center. Here, θᵤᵥ₁ corresponds to an electrical angle as described above and hence, the arrangement positions of the pulses in FIG. 45 can be expressed by an electrical angle. Accordingly, hereinafter, the arrangement positions of the pulses are defined as specified electrical angle positions. Accordingly, a pulse row of S₁ to S₄, S_{1′} to S_{2′} is formed. The row of pulses has the spectrum distribution which does not include a third-order harmonic, a fifth-order harmonic, and a seventh-order harmonic with respect to the fundamental wave. This pulse row is, in other words, a waveform formed by removing the third-order harmonic, the fifth-order harmonic and the seventh-order harmonic from a rectangular wave which has a definition region of 0≦θᵤᵥ₁≦2π. The orders of a harmonics to be removed may be also the orders other than the third order, the fifth order and the seventh order. With respect to the harmonics to be removed, when the frequency of the fundamental wave is small, the harmonics including the higher-order harmonics are removed, while when the frequency of the fundamental wave is large, only the low-order harmonics may be removed. For example, when a rotational speed is low, a fifth-order harmonic, a seventh-order harmonic and an eleventh-order harmonic are removed. Then, the removal of harmonics is changed to the removal of the fifth-order harmonic and the seventh-order harmonic with the increase of the rotational speed. When the rotational speed is further increased, only the fifth-order harmonic is removed. The orders of harmonics to be removed can be changed in this manner. This is because, in a high rotation region, the winding impedance of the motor is increased so that current pulsation becomes small.

In the same manner, there may be a case where the orders of harmonics to be removed are changed corresponding to magnitude of a torque. For example, when a torque is increased under a condition where a rotational speed is set to a fixed value, the orders of the harmonics to be removed are changed such that a pattern where a fifth-order harmonic, a seventh-order harmonic and an eleventh-order harmonic are removed when the torque is small is selected, the fifth-order harmonic and the seventh-order harmonic are removed along with the increase of the torque, and only the fifth-order harmonic is removed when the torque is further increased.

Further, not only the orders of harmonics to be removed are simply decreased along with the increase of a torque or a rotational speed as described above, there may be a case where the orders of harmonics to be removed are increased to the contrary or the orders of harmonics to be removed are not changed even when a torque or a rotational speed is increased or decreased. The orders of harmonics are to be decided by taking into account magnitude of an index such as torque ripples of a motor, noises and EMC and hence, it is not always the case that the orders of harmonics are changed monotonously with respect to a rotational speed or a torque.

In the above-mentioned embodiments, harmonics of the orders to be removed can be selected by taking into account the influence of distortion on an object to be controlled. As described previously, the more the kinds of orders of harmonics to be removed, the more the number of times of switching the IGBTs 328 and 330 of the inverter circuit 140 is increased. In the above-mentioned embodiment, harmonics of the orders to be removed can be selected by taking into account the influence of distortion on an object to be controlled and hence, it is possible to prevent many kinds of harmonics from being removed more than necessary whereby the number of times of switching the above-mentioned IGBTs 328 and 330 can be properly reduced by taking into account the influence of distortion on an object to be controlled.

As explained in the above-mentioned embodiments, in the control of a line voltage, the control is performed such that switching timing from a phase 0 (rad) to π (rad) which is a half cycle of an AC output to be outputted and switching timing from a phase π (rad) to 2π (rad) becomes equal and hence, the control can be simplified and the controllability is enhanced. Further, also in a period from a phase 0 (rad) to π (rad) or in a period from a phase π (rad) to 2π (rad), the control is performed at the same switching timing with the phase π/2 or the phase 3π/2 set as the center of the period and hence, the control can be simplified and the controllability is enhanced.

In the explanation made using FIG. 1 to FIG. 5 described above, due to the reason explained previously, the power conversion device 84 and the braking motor 63 are suitable for the control by a PWM method rather than the control by a PHM method. The control by the PWM method is basically equal to an operation of the pulse modulator 440 for PWM control described in FIG. 13. The basic operation is exactly the operation explained using FIG. 29. Further, the power conversion device 84 and the braking motor 63 can be controlled by a chopper control, and the chopper control is exactly the control explained using FIG. 45.

Further, the control content of the control circuit 172 and the manner of operation of the driver circuit 174 and the inverter circuit 140 in the above-mentioned regeneration braking are basically equal to the control in the motor operation of the motor generator 192. That is, pulses may be generated such that an AC waveform is inverted with respect to a magnetic pole position of the rotor of the motor generator 192 and hence, the control is basically similar to the control in the motor operation of the motor generator. Accordingly, the control content of the control circuit 172 and the manner of operation of the driver circuit 174 and the inverter circuit 140 can be used in the same manner as the PWM control explained basically in accordance with the operation of the motor. The control by the control circuit 172 in regeneration braking is omitted since the control in the motor operation of the motor generator 192 is explained in detail. That is, by inverting a phase of an AC waveform generated with respect to a magnetic pole position of the rotor of the motor generator 192 depending on whether a command from the host control device 42 is a command for a motor operation mode or a command for a regeneration braking operation mode, it is possible to cope with the regeneration braking and the motor operation of the motor generator 192. In the case of the regeneration braking, the processing substantially equal to the processing for generating an AC output explained previously is performed. In this case, a generated voltage corresponds to regeneration energy.

### Reference Signs List

136: high voltage power source device
138: DC terminal
140: inverter circuit
200: power conversion device
159: AC terminal
166: low voltage supply line
172: control circuit
174: driver circuit
180: current sensor
188: AC connector
192: motor generator
328, 330: IGBT
410: torque command/current command converter
420, 421, 422: current controller (ACR)
430: pulse modulator
431: voltage phase difference calculator
432: modulation index calculator
434: pulse generator
435: phase retriever
436: timer counter or phase counter comparator
440: pulse modulator for PWM control
450: switcher
460: transient current compensator
470: chopper cycle generator
480: pulse modulator for 1 phase chopper control
500: smoothing capacitor

1. A vehicle which mounts: a motor generator for generating a torque for moving the vehicle or generates a regeneration braking force against traveling of the vehicle; an acceleration pedal for accelerating the vehicle; a brake pedal for decelerating the vehicle; a first control circuit and a first inverter circuit for controlling the motor generator based on a manipulation variable of the acceleration pedal and a manipulation variable of the brake pedal; a low voltage battery; and a high voltage power source device thereon, wherein
the first inverter circuit includes an AC terminal and a DC terminal, the DC terminal of the first inverter circuit is electrically connected with the high voltage power source device, the AC terminal of the first inverter circuit is electrically connected with the motor generator, the first control circuit is operated based on DC power supplied from the low voltage battery, the first inverter circuit includes a plurality of semiconductor elements, and the first inverter circuit performs the conduction and the interruption of the semiconductor element thus generating AC power based on DC power or generating DC power based on AC power, and
the first control circuit controls timing at which the first inverter circuit performs the conduction or the interruption of the semiconductor element based on a phase of an AC output for driving or braking the motor generator, and controls a conduction width of the semiconductor element based on a manipulation variable of the acceleration pedal or the brake pedal.

2. The vehicle according to claim 1, wherein the vehicle includes a steering system which assists a steering force based on DC power supplied from the low voltage battery,
the steering system includes: a detector which detects a steering operation; a steering inverter device which assists a steering force; a steering motor which is driven by the steering inverter device; and a steering control circuit which controls a torque of the steering motor based on a detection value of the steering detector which detects the steering manipulation variable,
the steering control circuit controls the steering inverter device using a PWM control method where operation timing of conduction or interruption of the steering inverter device is controlled using a carrier wave of a fixed frequency, and
the first inverter circuit which operates the motor generator makes the semiconductor element of the first inverter circuit conductive in accordance with a phase angle of an AC output which falls within a range from 0 to π or within a range from π to 2π, and the first inverter circuit controls the conduction width based on a manipulation variable of the acceleration pedal or the brake pedal.

3. The vehicle according to claim 1, wherein when the acceleration pedal is manipulated, in a first operation region where a rotational speed of the motor generator is low, the first control circuit which drives the motor generator controls the first inverter using a PWM control method where an operation timing of conduction or interruption of the semiconductor element of the first inverter circuit is controlled using a carrier wave of a fixed frequency, and
in a second operation region where the rotational speed of the motor generator is higher than the rotational speed of the motor generator in the first operation region, the first control circuit makes the semiconductor element of the first inverter circuit conductive at a plurality of respective phase angles of AC output which fall within a range from 0 to π or within a range from π to 2π, and controls a conduction width of the semiconductor element based on a manipulation variable of the acceleration pedal or a manipulation variable of the brake pedal.

4. The vehicle according to claim 1, wherein a phase angle of the AC output at which the first inverter circuit is made conductive is preliminarily set within a range from 0 to π or within a range from π to 2π, and the conduction width is increased along with the increase of a manipulation variable of the acceleration pedal or a manipulation variable of the brake pedal.

5. The vehicle according to claim 1, wherein a phase angle of AC output at which the first inverter circuit is made conductive within a range from 0 to π or within a range from π to 2π is a preliminarily set angle, the conduction width is increased along with the increase of a manipulation variable of the acceleration pedal or a manipulation variable of the brake pedal, and under a condition where an interruption region between the conduction region and a neighboring conduction region arranged adjacent to the conduction region is narrower than a preset width, the conduction region and the neighboring conduction region are formed continuously with each other.

6. The vehicle according to claim 1, wherein a terminal of the low voltage battery has one side thereof connected with a vehicle body, and
the motor generator includes: a metal housing which is electrically connected with the vehicle body; a stator core which is electrically connected with the metal housing; a stator winding which is wound around the stator core in an insulating manner and is connected with an AC terminal of the first inverter circuit; and a rotor which is rotatably mounted inside the stator core.

7. The vehicle according to claim 1, wherein the vehicle includes a cooling medium circulation device which includes: a cooling water passage for cooling the first inverter; a cooling pump provided with a cooling motor for circulating water in the cooling water passage; and a cooling inverter for operating the cooling motor, and
the cooling inverter is repeatedly made conductive at a preliminarily determined phase angle which falls within a range from 0 to π or within a range from π to 2 m in accordance with a phase angle of AC output for driving the cooling motor.

8. The vehicle according to claim 7, wherein the cooling medium circulation device includes a temperature sensor, and a conduction width of the cooling inverter is controlled based on an output of the temperature sensor.
